(19) United States
(12) Patent Application Publication
(10) Pub. No.: US 2025/0375086 A1
(43) Pub. Date: Dec. 11, 2025

(54) PAN CLEANING SYSTEM AND IMPROVED CLEANING STATIONS UTILIZNG MODULAR SWING ARM CLEANING SECTIONS

(71) Applicant: Norman G Schmidt, Burnaby (CA)

(72) Inventor: Norman G Schmidt, Burnaby (CA)

(73) Assignee: Food Machinery Engineering LMTD, Surrey, BC (CA)

(21) Appl. No.: 19/206,005

(22) Filed: May 12, 2025

Related U.S. Application Data
(62) Division of application No. 17/389,316, filed on Jul. 29, 2021, now Pat. No. 12,295,535.
Application No. 17/389,316 is a continuation of application No. 17/009,203, filed on Sep. 1, 2020, now Pat. No. 12,102,277.
Application No. 17/389,316 is a continuation of application No. 17/009,566, filed on Sep. 1, 2020, now Pat. No. 12,357,145.
(60) Provisional application No. 62/894,923, filed on Sep. 2, 2019.
(60) Provisional application No. 62/894,915, filed on Sep. 2, 2019.
(60) Provisional application No. 63/033,826, filed on Jun. 2, 2020.
(60) Provisional application No. 63/033,826, filed on Jun. 2, 2020.

(51) Int. Cl. A47L 15/00; A21B 3/16; A46B 9/02; A46B 13/02; A47L 15/24; A47L 15/39; A47L 15/42; A47L 15/46; B08B 1/34; B65G 17/12

(52) U.S. Cl. CPC A47L 15/0092; A21B 3/16; A47L 15/0076; A47L 15/241; A47L 15/39; A47L 15/4295; B08B 1/34; A46B 9/026; A46B 13/02; A46B 2200/3013; A47L 15/4282; A47L 15/46; A47L 2401/04; A47L 2401/17; A47L 2501/20; A47L 2501/24; B65G 17/12

(57) ABSTRACT

A commercial baking dry pan cleaning system is provided having a support frame with one or more modular swing arms mounted thereto. One or more controllers is provided to control the one or more modular swing arms. One or more unclean pan conveyors provides a stream of unclean baking pans to the system. The controller engages one or more actuators to operate the one or more modular swing arms which swing around one or more pivot points to swing a cleaning subsystem or module into contact with the unclean stream of pans. A position limiter is coupled to each of the swing arms to set an initial operating position. The limiter communicates with the controllers. The cleaning subsystem is swung into position on the modular swing arm to engage the unclean pan. The controllers are adapted to sense and control a pressure exerted by the cleaning subsystems on the pan and maintain pressure within a pressure range. The controller whilst sensing the pressure exerted on the pan can also sense certain error conditions thereby disengage the pan if the sense pressures are outside of ranges.

### CROSS-REFERENCE TO RELATED APPLICATIONS

This application is a divisional application of U.S. utility patent application Ser. No. 17/389,316. filed Jul. 20, 2021 which is a continuation of both U.S. utility patent application Ser. No. 17/009,203, filed Sep. 2, 2020, which claims priority to U.S. provisional patent applications 62/894,923, filed Sep. 2, 20219 and U.S. provisional application 63/033,826 filed Jul. 2, 2020; and further is a continuation of Ser. No. 17/009,566, filed Sep. 1, 2020 which in turn claims priority of U.S. provisional patent application 62/894,915, filed Sep. 2, 2019, all of which are incorporated herein by reference.

### FIELD OF THE INVENTION

The invention relates to an improved system, device and method for improved, high volume cleaning of pans, related brush modules and methods of operating and processing the same.

### BACKGROUND OF THE INVENTION

In the commercial production of baked goods, dough portions are typically deposited by being portioned and placed on trays or pans for proofing the dough and baking off the product. The dough portion is placed on the pan surface. It is often the case that the dough may receive treatments prior to or following baking operations. For instance, toppings such as but not limited to seeds that can be applied to the dough portions prior to the baking process or a glaze, such as an egg wash as a further non-limiting example, can be applied after the baking process. When these topping mediums are applied they are applied in a manner such that they bond to the dough portion. However, the application also causes an issue where excess medium can go onto and adhere to the pan surface.

This “over spray” or over application of the toppings has a number of negative aspects for the baking operation. For instance, if in the case of the seed that bonds to the pan surface rather than the product these over applied seeds go through several bake cycles it will darken the seeds. If these seeds then dislodge and a proofed dough portion bonds to it, the resulting product will be deemed unsatisfactory in appearance to customers and/or contaminated. This can have a more significant impact if the seed, which is considered as an allergen, gets into product that should be seed free. This allergen contamination can cause serious issues for people that have strong reactions to such materials. In the case of the application of glaze onto baked rolls, the glaze that is sprayed in excess and goes onto the pan surface after several bake cycles will tend to peel off and if a flake of the over baked glaze goes into a bun it is also deemed as undesirable to unacceptable for finished production. It is critical that the pans in the commercial baking production system are thoroughly cleaned.

Additionally, as noted. there are often products such as hamburger buns that are baked in pans that will, for appeal and flavor enhancement purposes, often receive application of things like, but certainly not limited to, seeds that can include but are certainly not limited to sesame seeds, sunflower seeds, cracked grains and the like to the top surface of the bun. Often a glaze will be sprayed on or in addition to the seeds or materials previously listed to aid with adherence to the final product. This can create issues where, for example, the sesame seeds can bond to the upper surface of the pan or at the transition point where the top surface transitions to the pockets of the pan, the pocket being where the bun dough portion gets placed for proofing and baking. When this happens and on the first baking the seeds will go to a golden color and generally be harmless to the finished product. However, if these seeds are not removed and the pan goes thru the oven a second or third time with the original seeds. the original seeds will become dark brown if not black and become a potential contaminant. If these seeds are not removed before subsequent proofings, the dough portion would be dropped to proof over the blackened seeds. The seeds can then become bonded to the dough and after baking and depanning the seeds can be bonded to the final product, the baked bun. To a consumer this burnt black piece can be very undesirable. The blackened seeds are then contaminants and create serious issues in appearance in addition to causing allergen issues if accidentally ingested in the final product potentially for some users.

There are a wide range of methods for cleaning pans in commercial settings, such as wet cleaning with mechanical washers that use hot water and possibly cleaning solutions so as to remove the adhering mediums. But this method is not common in commercial baking as it is a slower process and affects other elements necessary for efficient production such as the maintenance of the durability of adhesion lowering coatings on pans. For instance, modern mass production bakeries will have a production rate of up to sixteen hundred buns per minute which works out to forty-five pans per minute throughput rate. Water bath washing would slow this rate of production as the washing or bathing action would require further drying and similar steps. Additionally, as noted, the release coatings that are typically applied to the pans frequently degrade when subjected to water based washing. The higher volume production that occurs in most commercial baking operations drastically compounds the effect of this problem, as the number and frequency of the overspray situations is significantly increased as is the demand for and use of the pans.

Existing pan cleaners are typically very unsophisticated affairs, generally providing too much agitation, prematurely wearing the pans non-stick coatings, or inadequately reaching the entirety of the pan. These conventional or prior art pan cleaners can be very limited as to where or what surfaces they can clean. It would be desirable to reach all the corners and surfaces of the pan. something the commercially available conventional machines do not do well. It is often difficult for these devices to reach certain locations. Specifically, for example, it is necessary that mechanical cleaning include the upper inner perimeter of the pan which gives the pan rigidity as well as provides a means for it to nest one into another when it is to be stacked but is often missed with existing cleaners. Effective cleaning would prevent the aforementioned adhesion of contaminant seeds and/or overspray of the associated adhesion materials. Additionally, providing the ability to apply the proper pressure on the pans whilst cleaning and the ability to detect jams and similar operating issues would be desirable.

The typical cleaning method used in a modern commercial baking setting is a dry cycle where mechanical apparatus, such as round cylindrical brushes, rotate over the top surface of the pan to remove over sprayed glazes, toppings, and other deposits from the pan surface. However, these typical, simple round cylindrical brush setup mounted on rotating horizontal shafts are often limited in their ability to clean all surfaces of the pan. The typical baking pan for buns and the like has a complex geometry. These pans have a raised perimeter and often pockets or depressions in the pan where formed portions of dough will drop into and proof outwards to the extents of this perimeter and also proof upwards so that they gain the shape of but not limited to hamburger and hot dog buns and the like. These prior art driven brushes are often challenged to reach all of these surfaces and the rotation of the brush will also often constrain the ability of the brush to act on inside corners and edges of the pan. In particular, the brush bristles are often unable to fully reach into the bottoms of the pockets and not become damaged from bending when going over the raised perimeter of the pans.

Further, baking pans can take various forms depending upon the product being produced. Some baking pans are flat. others have a raised lip or walls around the edges, other baking pans have recessed areas for receiving discrete dough or batter portions that are formed in the shape of the recessed area, and bread loaf and cake pans can have taller side walls than other pans. Consequently, the cleaning mechanism designed for a flat baking pan may not be ideal for cleaning a baking pan that has recessed areas, or taller side walls. A bakery that employs a variety of baking pan forms may have more than one pan cleaning machine, each one specialized for a different form of baking pan as they cannot be easily adjusted or changed over to accommodate other pan types.

Essentially. the limitations in the most common operations of the brushes in such cleaning processes comes from, but is certainly not limited to, the physical limitations in positioning the brushes on the pan, the angle of attack relative to the pan, the angle at which the bristles engage the pan or fail to engage the pan to remove adhered material. and physical limitations in running the brushes over the pans complex geometry. These all act to limit the effectiveness of these prior art cleaning processes and the limited simple mechanical brush sets.

In addition to the limitations associated with this approach and movement of the brushes, the inclination of the pan during cleaning is also an influencing aspect of the effectiveness of any system in cleaning the pan. If the pan is horizontal or flat, as it is typically used throughout the baking process, then cleaning may be negatively influenced. As an example of these limitations from a given inclination or lack of inclination, when a pan is moved by a cleaning machine with the baking surface of the pan sitting substantially upwards, when the pan is then brushed the dislodged materials will typically stay on the top surface of the pan. To clean the pan properly the loose deposited materials must be removed which is typically done through compressed air being blow across the pan.

Often this blowing operation will blow a significant portion of the debris from the pan surface but because of the turbulent effect of the air and effect of the pockets in the pan surface disrupting the air flow the debris will often circulate in the machine and may not be blown from the surface of the pan. This results in the need to have several rows or locations for blowing off the pan surface so as to try to remove all of the debris in multiple passes.

More generally speaking to the deficiencies of the prior art, in addition to the issues with individual cleaning stations or process, even though most current designs address only one or possibly two of the heretofore mentioned cleaning stations, these designs are fixed in the nature of and order of the cleaning stations. That is once the machine is created, the elements forming the cleaning station are fixed and often difficult to maintain. That is the brushes at a brush station, for instance, are difficult to access or alternatively require full disassembly of the frame and subcomponents to access and change. Similarly, commercially available blowers are difficult to optimize for the purposes of cleaning pans which can have differing geometries.

In an attempt to compensate for these shortcomings, it is often the case that the existing pan cleaners use longer running cleaning lines or make multiple passes to ensure the cleaning operations will properly clean the pans. However, this requires larger and more costly machines and space to house the machines. It also does not resolve the issues with deferred maintenance experienced due to the inaccessibility of elements that require regular change out, like brush heads, or cleaning, like blowers. The result is that it is often the case that multiple cleaning machines to address multiple pan types and large volumes must be provided and these take up significant floor space and add operational costs and overhead and that even when several machines are available, it is often difficult to service these prior art machines effectively.

There are also limitations to where or what surfaces conventional or prior art pan cleaners can clean. It would be desirable to reach all corners and surfaces of the pan. This would prevent the aforementioned adhesion of contaminant seeds and/or overspray of the associated adhesion materials. Additional examples of locations that need mechanical cleaning include, but are not limited to, the upper inner perimeter of the pan which gives the pan rigidity as well as provides a means for it to nest one into another when it is to be stacked.

If there is sprayed on glaze and/or the pan has seeds adhering to this overglazed surface, it can be the case that the pans can then be taken away from where the product gets baked for stacking/unstacking operations. But during the stacking and/or the unstacking operation and/or the movement of the pans when stacked it is possible that the inner lip of the pan will contact or may contact the outer perimeter lip of the pan that is above and nested into the lower pan in a stacking operation. When this happens materials that are bonded to the inner and outer pan perimeter can be dislodged thru the impact imparted by nesting or stacking operations and/or when the pans in stacks are moved around. Dislodging of these materials can present a hazard in that the dislodged material can go into a bun pocket or onto an upper pan surface where the dough can fall and/or proof. The resulting bun would then proof onto the dislodged contaminant resulting in the same issue of the contaminant appearing on the final bun. The retention of these contaminants is an issue and a concern, and a need exists to alleviate these possible sources of product contamination through more efficient and improved brushing processes and devices. There exists a need for a stronger means of cleaning pans, including but not limited to bun pans.

There exists a need for a machine to more effectively clean materials from pans that overcomes the limitations of the existing mechanical methods. Such a device would provide a system for improved orientation of the pans in the cleaning process while simultaneously providing for redundancy in passes and adjustment of the angle of attack of any mechanical agitation of the pan as well as providing for improved contact specifically with contoured, oscillating brushes with the ability to adjust and accommodate the complex geometry of the pan so as to reach substantially all the surfaces on the pan as it is passed through the improved orientation for cleaning. Such a system should provide a modular, easily accessible and easily cleaned and maintained system with the flexibility to provide customization through interchangeable or expandable cleaning stations that can be easily programmed to accommodate various pan styles on one continuous line. The system should have a system controller capable of detecting and adjusting the cleaning operations for the variety of modular components and variables for the system. Finally, this system should employ uniquely improved cleaning stations for cleaning the pans.

### SUMMARY OF THE INVENTION

An aspect of the instant invention is to provide a system for cleaning pans with an easily customizable and interchangeable system of cleaning subsystems mounted on an open frame, modular swing arm operable system providing quicker change out of component subsystems and easier access to those subsystems for maintenance and upkeep.

A further aspect of the instant invention is to provide a novel track operation for moving a pan through a complex geometry to an improved positioning for cleaning.

A still further aspect of the instant invention is to provide a carriage and track system that can turn a pan at least substantially perpendicular or at a greater angle to the horizontal for better effective cleaning.

Yet another aspect of the invention is to provide a pan sorting system to detect debris on a pan after it has passed a cleaning station and determine if the cleaning was effective.

Still another aspect of the invention is to provide a pan sorting station on a pan cleaning machine that can detect the state of the pan or pan coatings and reject and segregate pans determined to be out of specification.

An aspect of the instant invention is to provide a pan cleaning system that can input pans in a myriad of directions and selectively discharge the pans in an upright or face down fashion for later processing.

A still further aspect of the invention is to provide a system that can completely rotate a pan providing a first half of the rotation ahead of a cleaning subsystem and the second half of the rotation after cleaning to a stacking system.

An aspect of the invention is to provide a wide range and freedom of movement in a track system that can come in high or low and exit high or low and similarly can flip or rotate orientation to suit cleaning stations optimum orientation, for example flipping for one station above on a frame and reversing for another below.

Another aspect of the invention is to provide a cleaning system having multiple stations for cleaning and self-changing sections where one or more of the same brush type can be cycled into operation and a used or previously cycled set can be moved to a position to be replaced.

Yet another aspect of the invention is to provide additional devices or multiples of the cleaning device subsystems. this duplication permits continuous operation of the system such that one subsystem could be idled and rotated to an easily accessible position for upkeep while the other engages the pans.

An aspect of the invention is to provide a machine that can more effectively clean materials from pans that overcomes the limitations of the existing mechanical methods, provide for a system for optimizing the orientation of the pans in the cleaning process while simultaneously affording redundancy in passes and adjustment of the angle of attack of any mechanical dislodging or agitation of the pan as well as providing for improved contact specifically with contoured, oscillating brushes with the ability to adjust and accommodate the complex geometry of the pan so as to reach substantially all the surfaces on the pan as it is passed through the improved orientation for cleaning.

A further aspect of the invention is to provide a system that is modular, customizable and easily cleaned and maintained with the flexibility to expand and program the cleaning system.

Yet another aspect of the invention is to provide customization through interchangeable or expandable cleaning stations that can easily be programmed to accommodate various pan styles on one line.

An aspect of the invention is a system employing uniquely improved cleaning stations for cleaning pans.

An still further aspect of the invention is an improved pan cleaning machine uses carriages guided by tracks to carry pans in a continuous and fully automated flow through a cleaning section for higher throughput compared to batch cleaning systems with carriages rolling on tracks with the spacing between carriages automatically indexing the feed of pans carried on carriages in spaced relationship so that the edges of pans in consecutive carriages do not interfere with one another.

Yet another aspect of the invention is to provide a customizable rotation of the pans in the plane of the pan so as to orient the pan upwards, sideways, helically, or in a combination of these motions so as to rotate the pan at least ninety degrees to assist with cleaning

A still further aspect of the invention is to provide a brush cleaning station wherein the brush will be moving so as to oscillate or move in a planar orbital motion of varying degree that will act upon differing areas of the pan surface in a way so as to provide a more complete cleaning of the pan surface.

An aspect of the invention is a travelling magnetic pan support sections run in a supported track mechanism where wheels attached to the travelling pan support section engage track tubes that provide the desired position and route of the travelling pan support section.

A still further aspect of the invention is to provide a quick change brush coupling whereby brushes can be removed and replaced in a manner of seconds to minutes rather than hours.

An aspect of the invention is to provide a controller which is activated for automated removal or opening of the brush coupling for rapid change out of used brushes due to wear or contamination.

Another aspect of the invention is to provide a system with multiple redundant subsystems such that the systems can be operating in alternating fashion and when one is in operation the other can be moved out and maintained while on a swing arm of the machine.

Another aspect of the invention is the use of a quick change brush coupling that also allows for consistent positioning of a brush shaft to provide a consistent indexing position as well as provide for rotational transmission of torque or rotational energy and information to a controller.

An aspect of the invention is the use of a “plate brush” or planar brush that it is substantially flat or made of a base or frame that is substantially flat but where bristles with multiple bristle lengths and orientations extend to clean the pan edges.

A further aspect is a novel brushing system where a substantially flat plane brush with a set of shorter bristles at the front is provided which are angled against the direction of travel of the pan so as to optimally engage the pan as it approaches the substantially flat plane brush, the shorter bristles of the substantially flat plane brush being longer than the depth of the top pan perimeter edge so as to be able to bend in the clastic deformation range of the bristle material while bending sufficiently without deforming and programming the height of engagement of the brush.

An aspect of the invention is to provide better, more improved cleaning of multiple surfaces on pans, in continuous production where pans are in good condition and a light cleaning is required on each pass thru the baking process.

A further aspect of the invention is to provide for cleaning of protein glaze that is not hard bonded or seeds that are slightly adhered to the pan where a consistent minor or light to medium cleaning is sufficient and the brushes can be mild so that wear imparted to the release non-stick coating glaze in the cleaning process is not significant.

A further aspect is to provide perimeter cleaning such that when pans start to get a build up occurring or where a pan perimeter cleaning is required then an additional or alternate brush can be used which will clean these surfaces and the brush action will be more significant so as to do a stronger cleaning operation.

A still further aspect of the invention is to provide a modular system and with easily maintained and detached brush heads to address allergen concerns where brushes used with allergens cannot be used on non-allergen pans. This includes providing extra brushes or alternate brushes and/or extra brushes mounted to additional cleaning modules that can be activated to come in or be removed from the cleaning operation so as to use the corresponding cleaning devices to the required allergen or non-allergen products.

Yet another aspect of the invention is to provide the aforementioned brush change options via a controller having stored recipes so that no human intervention is required and the alternating or selective use of given modules can be engaged via the controller without human intervention or further change outs.

An aspect of the invention is to provide for continuous pass thru of pans to be cleaned such that as pans come in they will be cleaned regardless of spacing or location on an infeed conveyor belt which removes the issue of indexing of pans to required locations.

Yet another aspect of the invention is to provide a sensor to sort the pans requiring cleaning from those not requiring cleaning and if the pans do not require any cleaning the cleaning heads of the instant invention can be activated to lift off of the path of pans and the pans just pass thru without any brush contact. This may also be the case where pans that do not get seeds and/or glaze applied may just run thru the pan cleaner but the cleaning modules may be raised and operation to the modules may turned off so as to not provide any cleaning.

A still further aspect of the instant invention is to provide at least one swing arm configured on an at least one frame whereby the swing arm can extend in a controlled fashion to the level needed to proceed.

Another aspect of the invention is the provision of a customer customizable number of cleaning stations to be used or required for specified operation.

Yet a further aspect of the invention is the settable height of the arms, which allows setting of lowest allowable workable position for the arm but does not make it a fixed setting where jams of the pans can wedge in one or more pans, but rather a minimum height and the head mounted on the arm can float higher to allow for pass over of pan perimeter edge or as previously indicated typical pan wedge situations.

An aspect of the invention is a controller that controls the aforementioned arms, so that the arms can be adjusted and thereby adjust the downward force of the brush to the pan by electronic means so as to allow for recipe driven, minimal settings and or operation.

A still further aspect of the invention is easy fast change out of brushes with quick change connectors which allow operations to change out brushes at a settable count level so that as an example brushes may be changed out at regular pan cleaning cycles to allow for cleaning of brushes so that the brushes are actually cleaning the pans and not allowing the brushes to get saturated to where they are spreading debris from prior pans onto subsequent pans cleaning cycles.

Yet a further aspect of the invention reverses operation of the brushes, such that when the horizontal axis cylindrical brushes are used they will tend to bend the bristles and it may be that the bristles will deform or bend to a degree of bend or curvature that reduces the cleaning action from brushing to stroking the pan surface. Optimally, these brushes can be reversed so as to always utilize bristles that are forward inclined to brush the pan surface. For example if a bristle gets bent back during operation and so when re-installed after cleaning or when programmed to be reversed on an operational count basis then when it is installed in the reverse manner it will actually be where the bristles are forward inclined and push brush the pan surface rather than drag over the pan surface. This procedure or available program option will also provide better brush utilization, operation, and life span.

A further aspect of the invention is to provide for cleaning of protein glaze that is not hard bonded or seeds that are slightly adhered to the pan where a consistent minor or light to medium cleaning is sufficient and the brushes can be mild so that wear imparted to the release non-stick coating in the cleaning process is not significant.

A further aspect is to provide perimeter cleaning such that when pans start to get a build up occurring or where a pan perimeter cleaning is required then an additional or alternate brush can be used which will clean these surfaces and the brush action will be more significant to do a stronger cleaning operation.

A still further aspect of the invention is to provide a modular system and with easily maintained and detached brush heads to address allergen concerns where brushes used with allergens cannot be used on non-allergen pans. This includes providing extra brushes or alternate brushes and/or extra brushes mounted to additional cleaning modules that can be activated to come in or be removed from the cleaning operation so as to use the corresponding cleaning devices only with the corresponding allergen or non-allergen products.

Yet another aspect of the invention is to provide the aforementioned brush change options via a controller having stored recipes so that no human intervention is required and the alternating or selective use of given modules can be engaged via the controller without human intervention or further change outs.

An aspect of the invention is to provide for continuous pass thru of pans to be cleaned such that as pans come in, they will be cleaned regardless of spacing or location on an infeed conveyor belt which removes the issue of indexing of pans to required locations.

Yet another aspect of the invention is to provide a sensor to sort the pans requiring cleaning from those not requiring cleaning and if the pans do not require any cleaning the cleaning heads of the instant invention can be activated to lift off from the path of pans and the pans just pass thru without any brush contact. This may also be the case where pans that do not get seeds and/or glaze applied may just run thru the pan cleaner, but the cleaning modules may be raised and operation to the modules may turned off so as to not provide any cleaning.

A still further aspect of the instant invention is to provide at least one swing arm configured on an at least one frame whereby the swing arm can extend in a controlled fashion to the level needed to proceed with operations.

Another aspect of the invention is the provision of a customer customizable number of cleaning stations to be used or required for specified operation.

Yet a further aspect of the invention is the settable height of the arms, which allows setting of lowest allowable workable position for the arm but does not make it a fixed setting where jams of the pans can wedge in one or more pans, but rather a minimum height and the head mounted on the arm can float higher to allow for pass over of pan perimeter edge or in the as previously indicated typical pan wedge situations.

An aspect of the invention is a controller that controls the aforementioned arms, so that the arms can be adjusted and thereby adjust the downward force of the brush to the pan by electronic means so as to allow for recipe driven, minimal settings and or operation.

A still further aspect of the invention is easy fast change out of brushes with quick change connectors which allow operations to change out brushes at a settable count level so that as an example brushes may be changed out at regular pan cleaning cycles to allow for cleaning of brushes so that the brushes are actually cleaning the pans and not allowing the brushes to get saturated to where they are spreading debris from prior pans onto subsequent pans cleaning cycles.

Yet a further aspect of the invention reverses operation of the brushes, such that when the horizontal axis cylindrical brushes are used. they will tend to bend the bristles and it may be that the bristles will deform or bend to a degree of bend or curvature that reduces the cleaning action from brushing to stroking the pan surface. Optimally, these brushes can be reversed so as to always utilize bristles that are forward inclined to brush the pan surface. For example, if a bristle gets bent back during operation and so when re-installed after cleaning or when programmed to be reversed on an operational count basis then when it is installed in the reverse manner it will be where the bristles are forward inclined and push brush the pan surface rather than drag over the pan surface which is what happens. This procedure or available program option will also provide better brush utilization, operation, and life span.

The apparatus of the invention includes a modular swing arm for cleaning an at least one pan having an at least one swing arm mounting point with the modular swing arm coupled thereto such that the swing arm rotates freely about a pivot element. The modular swing arm being moved by an at least one swing arm actuator with an at least one swing arm limiter limiting the movement and an at least one controller controlling the movement. Where the at least one modular swing arm is positioned by the at least one controller by activating the at least one swing arm actuator to position to engage the at least one pan at a pressure range exerted by the at least one swing arm actuator and limited by the at least one swing arm limiter such that the at least one pan is cleaned.

The at least one controller can be further adapted to sense pressure on the at least one modular swing arm. The pressure is sensed through the at least one swing arm limiter. Whereas part of the sensed pressure. both a down force and up force relative to the at least one swing arms extension are measured by the at least one controller. The controller is further adapted to extend the swing arm about its pivot clement to apply the downward force and sense a jam condition wherein the upward force exceeds a pre-set limit in the at least one controller and the at least one controller retracts when the present limit is exceeded as an indicator of a jammed pan stuck under the swing arm.

The apparatus of the invention also includes a rotary brush module in a pan cleaning machine. The mounting plate is coupled to a drive system with at least two brushes coupled to the mounting plate and spaced thereon so as to provide overlap in a line of travel for each of the at least two brushes with respect to the other brushes over a pan within the pan cleaning machine. With at least one shaft extending from each of the at least two brushes through the mounting plate and coupling to the drive system such that the at least one shaft on each brush of the at least two brushes is driven and spins the at least two brushes. An at least one brush clement extends from the at least one brush shaft, the at least one brush element having a plurality of bristles that deform on contact with a pan including the inner perimeter of a pan and clean the pan along the path of movement of the at least two brushes such that the overlap in the spacing of the at lest two brushes on the path compensates for the deformation of the plurality of bristles in cleaning the pan and maximizes the probability of contact of the bristles with the pan along the path of movement of each of the at least two brushes.

The rotary brush module can further have an overlap path that covers the deformation to leave no gap of uncleaned area on the pan. The at least two brushes can further comprise a first of the at least two brushes and a second of the at least two brushes. The spacing of the at least two brushes can be staggered in at least two rows, a first row of the at least two rows having the first of the at least two brushes and a second row of the at least two rows having the second of the at least two brushes. the respective brushes and rows forming the staggered overlap width. The staggered overlap width can be between about one hundred and two hundred percent based on one half of the center on center shaft distance of the brush body. The staggered overlap can be about two hundred percent of the width of the first of the at least two brushes. The staggered overlap width for the spacing can be one-half of the center to center distance of the brush shafts.

The first of the at least two brushes can rotate clockwise and the second of the at least two brushes can rotate opposite the first or counter clockwise. The plurality of bristles further comprises an at least one inner bristle and an at least one outer bristle relative to the at least one shaft each bristle extending at an inner bristle angle and an outer bristle angle respectively from the brush body. The inner bristle angle can be between about 15 to about 45 degrees relative to a perpendicular plane extending from the brush body.

The inner bristle angle can be 15 degrees. The outer bristle angle can between about 15 to about 45 degrees relative to a perpendicular plane extending from the brush body. The inner bristle angle can be 25 degrees.

The at least two brushes each can further comprise a brush mounting plate, an upper cartridge coupled to the mounting plate drive system through a pulley member and having the at least one shaft being rotatably passed therein, a lower cartridge, a cartridge fastener coupling the lower cartridge to the at least one spindle, a brush body having at least one bristle extending therefrom, and a detachable coupling button detachably coupling the brush body to the lower cartridge.

The apparatus of the invention further includes a control system controlling a pan cleaning machine, including a pan cleaning controller with an at least one sensor coupled to the pan cleaning machine and communicating with the controller and an at least one actuator. Where the at least one actuator is activated by the pan cleaning controller based on input received by the at least one sensor from an at least on sensor on the pan cleaning machine and which controls the position of an at least one modular swing arm in the pan cleaning machine and bring an at least one cleaning module mounted thereto into contact with a pan in the pan cleaning machine to clean the pan.

The at least one sensor can sense the relative position of the at least one modular swing arm in relation to the pan being cleaned. The position of the at least one module swing arm can be set in the pan cleaning controller to a position for applying a pre-programmed downward force at a starting position and the at least one sensor senses both the applied downward force and feedback returned from the contact of the at least one cleaning module coupled to the at least one modular swing arm as it is being applied to the pan during cleaning. The controller can be adapted to read the downward force and the corresponding feedback returned from the contact of the at least one cleaning module so as to sense a condition on the at least one cleaning module corresponding to a jammed condition whereby the pan is jammed under the module and the controller is further adapted upon sensing such a condition to raise the at least one cleaning module.

The at least one actuator can further comprise an at least one pneumatic cylinder and an at least one stroke limit control element which are each coupled to a machine frame. The at least one stroke control limit clement can be coupled to the at least one swing arm through an at least one a pin traveling in a slot in a guide plate and the at least one stroke limit control element is adapted to limit the movement of the at least one swing arm by stopping the movement of the at least one swing arm when the pin reaches the end of the slot in the guide plate and an at least one sensor is coupled to and senses the location of the pin and thereby control the position of the at least one swing arm.

The at least one senor can be at least one of an optical sensor, a magnetic, a mechanical, and a strain-type sensor. The at least one sensor can further comprise at least one sensor detecting the height of the pan. The controller can be adapted to adjust the distance of the at least one cleaning module from the pan at a specific vertical height spacing sensed by the at least one sensor detecting the height of the pan. The at least one sensor can further comprise at least one sensor detecting the style of pan and the controller is adapted based on the detected pan style a pre-programmed cleaning routine. The pans can be coded and the at least one sensor further comprises a code reader. The at least one sensor detecting the style of the pan can be an at least one optical scanner.

The controller through the at least one sensor can be adapted to measuring at least one variable in the cleaning system. The at least one variable includes at least one of the pan height, a pressure on the cleaning module, and the weight of the pan. The controller based on the at least one variable can be adapted to adjust the at least one cleaning module to a pre-programmed cleaning routine on the controller and the module swing arm moved according to the pre-programmed cleaning routine.

Moreover, the above aspects and advantages of the invention are illustrative, and not exhaustive, of those which can be achieved by the invention. Thus, these and other aspects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 shows an isometric view of an exemplary embodiment the instant invention.

FIG. 2 shows a side cutaway view of a support carriage of the exemplary embodiment of the invention shown in FIG. 1.

FIG. 3A shows an isometric view of an exemplary embodiment of a magnetic carriage of the exemplary embodiment of FIG. 1.

FIG. 3B shows an isometric close up view of the carriage of FIG. 3A without the track supports.

FIG. 3C shows a further isometric view of the carriage of FIG. 3B from below.

FIG. 4 shows an isometric view of the track as the support begins the rotation of the pan in an exemplary embodiment of the instant invention.

FIG. 5A shows isometric view of an exemplary embodiment of the cleaning section of an exemplary embodiment of the instant invention.

FIG. 5B shows a side view from the back of the exemplary embodiment of the instant invention.

FIG. 6A shows an isometric view of an exemplary embodiment of the rotating cylindrical brush subsystem of FIG. 5A.

FIG. 6B is a close up of the cylindrical brush of FIG. 6A with a cutout showing an exemplary embodiment of a quick change drive coupling.

FIG. 6C showing the opposed end of the cylindrical brush of FIG. 6B in a closed position.

FIG. 6D showing the opposed end of the cylindrical brush of FIG. 6B in an open position.

FIG. 7A shows exploded view of an exemplary embodiment of a planar brush subsystem in the exemplary embodiment of FIG. 5A.

FIG. 7B shows the cut away of the quick release attachment points of the plane brush sub-component of FIG. 7A.

FIGS. 8A and 8B shows a typical perpendicular brush assembly of a planar brush.

FIGS. 8C and 8D shows a cross section of a row of the improved bristles of an exemplary embodiment of the improved bristle brush of the planar brush subsystem of FIG. 7A.

FIG. 8E shows the top down view of the planar brush of FIG. 7A in its scrubbing motion.

FIG. 8F shows the cross section of the planar brush passing relative to the brush in FIG. 8E.

FIGS. 9A and 9B show an exemplary embodiment of an airknife used in the cleaning system of FIG. 5A.

FIG. 9C shows an end view of the airknife with adjusting devices for opening and closing gap of the airknife opening shown in FIGS. 9A and 9B.

FIG. 9D shows the exit of clean pans from the airknife subsystem in an exemplary embodiment of the instant invention.

FIG. 10 shows the exemplary embodiment of the cleaning system with a discharging station for clean pans.

FIGS. 10A and 10B show a side view of a further exemplary discharging and sorting station for clean pans.

FIG. 11 shows a side view that illustrates the main structure of an exemplary embodiment of the instant invention mounting modules one through five within the direction of pan feed.

FIG. 12 shows a side view of module one of the exemplary embodiment of FIG. 11.

FIG. 13 shows a side view of module two of the exemplary embodiment of FIG. 11.

FIG. 14 shows a side view of module three of the exemplary embodiment of FIG. 11.

FIG. 15 shows a rear view of the exemplary embodiment of brush module three showing the dense configuration of plurality of brushes with overlap in the first and second rows of brushes.

FIG. 16 shows a side view of the exemplary embodiment of brush module three shown in FIG. 15.

FIG. 17 shows a top view of module three of the exemplary embodiment of FIG. 11, showing the drive motor and power transmission unit.

FIG. 18 shows a bottom view of the exemplary embodiment of brush module three shown in FIG. 17.

FIG. 19 shows an isometric front view of the exemplary embodiment of brush module three shown in FIG. 17.

FIG. 20 shows a top-down view of the embodiment of brush module three shown in FIG. 17 with grey hatching representing the areas of coverage for the brush heads as the tray passes the brush heads.

FIG. 21 shows compression of the bristles of a single brush head due to the height of the lip of the tray.

FIG. 22 shows an isometric assembly view of an exemplary embodiment of the brush head.

FIG. 23 shows a bottom view of the exemplary embodiment of the brush head of FIGS. 22.

FIG. 24 shows an exploded view of an exemplary embodiment of the brush head, plate and pulley assembly of FIG. 22.

FIG. 25 shows a cross sectional view of an exemplary embodiment of the brush head, plate and pulley assembly from FIG. 24.

FIGS. 26a-26c shows top, side, and isometric views of the brush heads and the turn installation method of the brush heads on the spindle in an exemplary embodiment of the brush head assembly.

FIGS. 27 and 28 show an additional side sweeping brush of an alternate exemplary embodiment.

FIG. 29 shows a side view of module four of the exemplary embodiment of FIG. 11.

FIG. 30 shows a side view of module five of the exemplary embodiment of FIG. 11.

FIG. 31 shows views of an exemplary embodiment of the conveyor system of FIG. 11.

### DETAILED DESCRIPTION OF THE EXEMPLARY EMBODIMENTS OF THE FIGURES

There are often products baked in pans that will for appeal and flavor enhancement often receive application of toppings like glazes and seeds, as previously noted. This can create issues where, for example, the seeds bond to the pan and are retained through baking cycles. As noted above, the resulting blackened seeds are then contaminants and create serious issues in appearance in addition to causing issues if accidentally ingested in the final product potentially for some users. Moreover, as discussed, existing pan cleaner systems are generally very unsophisticated affairs, often providing too much agitation, prematurely wearing the pans non-stick coatings, or inadequately reaching the entirety of the pan. These conventional or prior art pan cleaners can be very limited as to where or what surfaces they can clean and lack the ability to apply the proper pressure on the pans whilst cleaning and fail to detect jams and similar operating issues creating production delays and problems. The instant invention relates to an improved system, device and method for improved, high volume cleaning of pans, related brush modules and methods of operating and processing the same.

One non-limiting example being a machine and process for cleaning bun pans as referenced throughout herein which are used in the production of hamburger and other dough type buns,. these being non-limiting examples of the types of products that can be produced. The pan cleaning system is required to brush the surface of said pans so as to clear the top and/or pocket surfaces of the pans of debris deposited in the production of the buns and/or in the application of toppings. The toppings can include but are not limited to seeds, for instance but not limited to sesame or sunflower seeds, or grain mediums, such as but not limited to cracked and or whole grains, and top coatings, such as but not limited to glazes such as in the use of protein washes or sprayed on glazes. Though references herein are made in relation to such a machine. method and pan/bun product, the instant invention can likewise be adapted for many bakery applications and can include as non-limiting examples buns, pastries, breads, bread-like products and the like without departing from the spirit of the invention. The exemplary embodiment regarding buns herein described as buns or hamburger buns is intended as a non-limiting exemplary embodiment for illustration of the invention.

When producing such products there is an element of risk that some or all of these materials may bond to the top surface 4 of the pan 3 and or into the pocket 5 of pan 3. If these materials, then get bonded to any of the surfaces or subsequent product made or baked in such a pan 3 then it may have significant adverse effects such as but not limited to allergen reactions to toppings like seed products to visual abnormalities that can result in rejection of the baked bun due to adhesion of burnt seeds that have gone thru repeated baking cycles.

To clean the pan surfaces, typically brushing is used. In large scale bakery installations, the pans can typically run up in size. for instance but are certainly not limited to. about forty-eight inches by forty-eight inches in size. The pans 3 are typically coming out of the oven at rates as high as forty pans per minute or more. So. at these operating speeds. there is only around one and a half seconds to clean a pan 3 and therefore mechanical, commercial scale brushing is the most rapid and economical cleaning process that can be applied. Water washing, even if in an automated application, takes too long and most glazes used in this process are silicon based which is resistant to water. Additionally, the use of water on the silicon non-stick coating of the pans decreases the number of cycles in the useful life of the non-stick coating of the pans. To get the pans 3 clean from the specified contaminants in the allotted time the brushes must have the cleaning action required and be able to contact and clean all of the areas required to be cleaned on the pan 3 in a very short period of time. The instant invention is improved to provide the efficient cleaning and adjustable and/or selective contact with the pan 3 to accomplish this cleaning. Additionally, the instant invention provides for quicker change outs when needed, reduced maintenance down time, and greater adaptability for use in customer production lines.

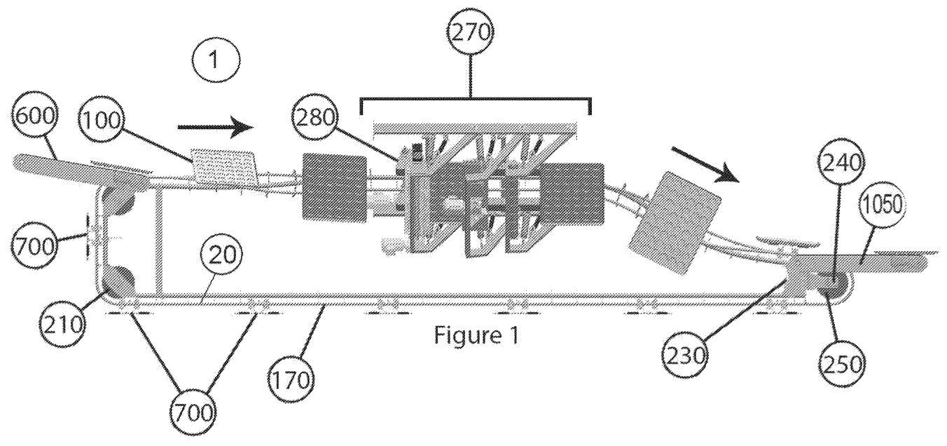

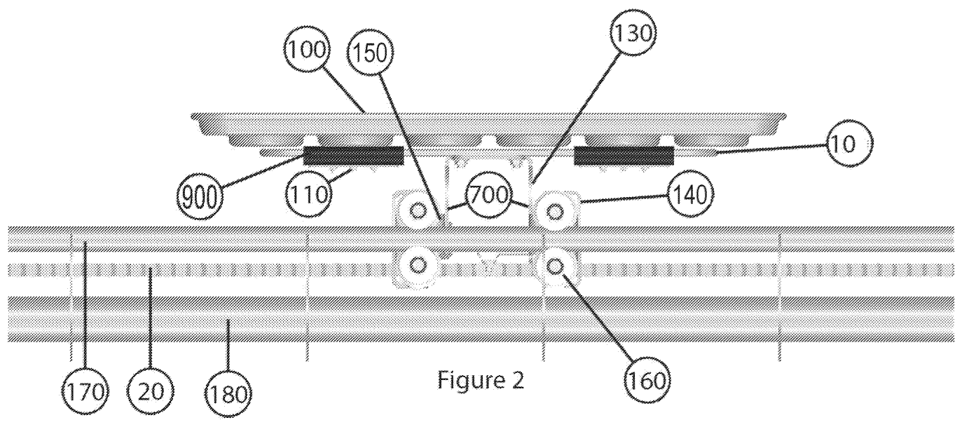

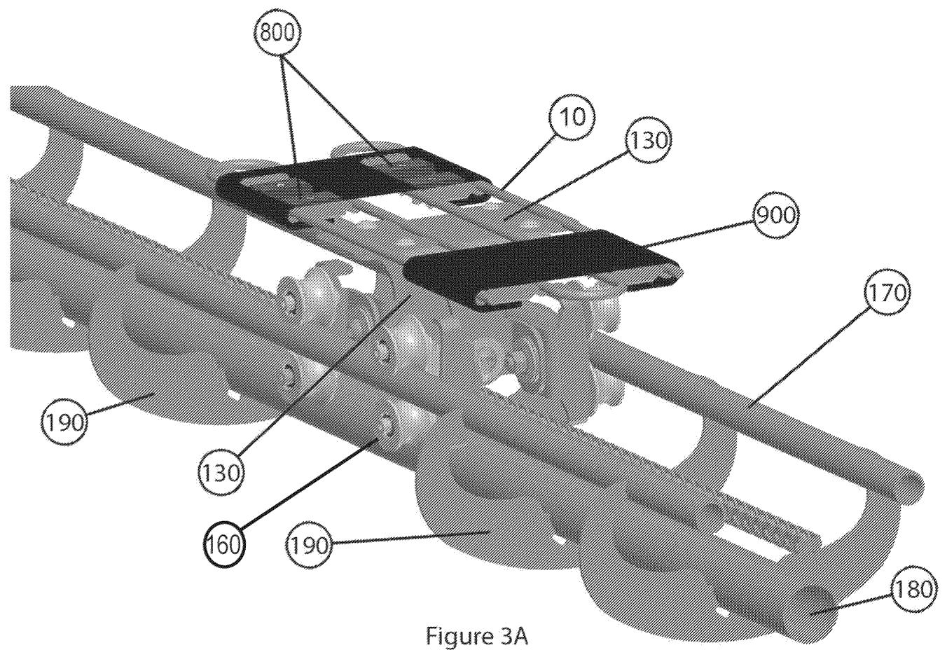

FIG. 1 shows an isometric view of the instant invention. Pans 100 come to the invention from an infeed conveyor (not shown) onto the indexing conveyor 600 so that all pans 100 can be properly spaced so as to be centered onto the magnetic support carriage 700 which will carry and transport the pan 100 through the various aspects of an exemplary embodiment of the invention in an exemplary order of cleaning subsystems so as to have the pans substantially inverted, brushed through one or more stages and/or types of cleaning brushes, then using compressed air in an airknife blown off to remove any remaining clinging debris and then either returned to upright or fully inverted to suit the next portion of the operation. Power transmission to the pan cleaning system 1 is accomplished, by, but certainly not limited, to a prime mover motor device 230, such as an electric motor coupled through a gear reduction unit in a self-contained motor gear unit, which in turn provides rotational energy to a drive shaft 240 on which is coupled to and drives a drive sprocket 250. A mechanical pulling or possibly pushing means herein indicated as a cleaning system drive element or driven element 20, which can be for instance but is certainly not limited to a side bending chain drive and is more clearly shown in FIG. 2, which allows for a pulling force to be transmitted along its length and coupled to each magnetic support carriage 700. As can be appreciated by one of ordinary skill in the art, other power transmission elements, such as but not limited to timing belts, cabling with attachments, additional chains, and the like can perform a similar function without departing from the novelty of the invention.

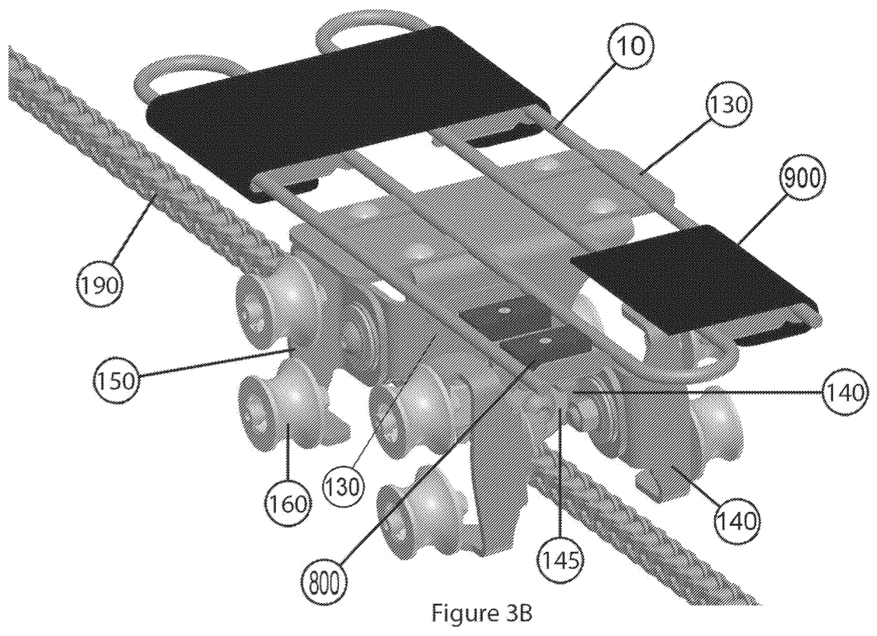

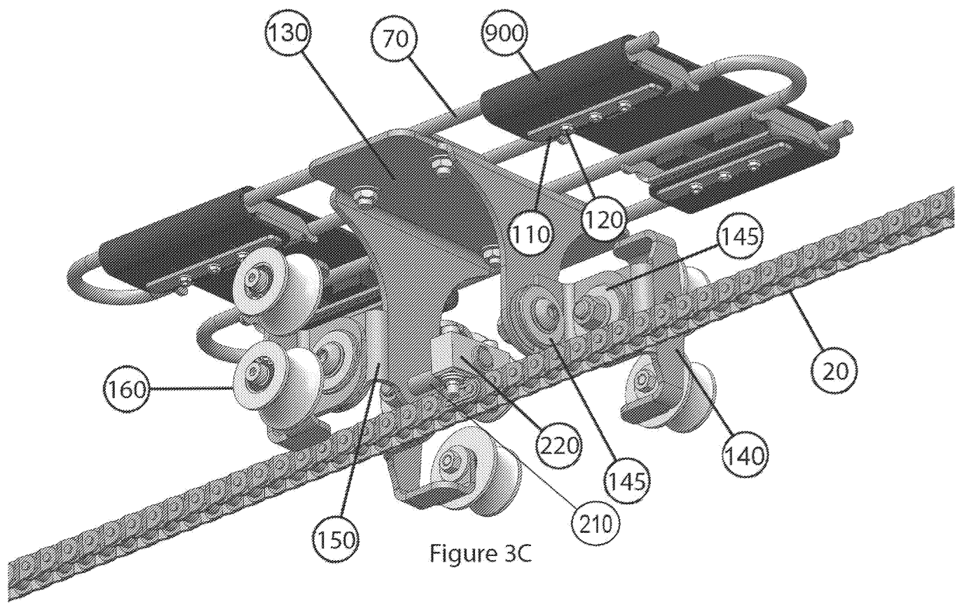

Drive sprocket 250 is attached and takes the rotational energy of the gear motor 230 and produces the needed tension forces in the cleaning system drive element 20 so as to pull or push the magnetic support carriages 700 with pans 100 through the instant invention. The movement is transmitted through the coupling of the cleaning drive system element 20 to the magnetic support carriage 700, as further described in relation to FIG. 3C below. Furthermore, though reference is made to an exemplary embodiment utilizing magnetic support carriages and conveyors, the invention can utilize non-magnetic, mechanical, suction, electro-magnetic, and similar fixative methods and devices to retain the pan 100 in the invention.

As pans are removed from the baking operations to be provided to the pan cleaning system 1, the pans 100 are fed to the pan cleaning system 1. The pans are supplied and their entry into the pan cleaning system 1 is governed by index conveyor 600. The index conveyor 600 is magnetic and retains the pan 100 in place awaiting indexing. The index conveyor 600 holds the pans 100 so as to be able to move or travel and thereby inject pans 100 so they are placed and centered on magnetic carriages 700. Magnetic support carriage 700 carrying the pan 100 is subject to both forward movement from conveyor drive element 20 which is driven by prime mover motor device 230 on drive shaft 240 at the operational speed set for the machine as well as rotational movement as shown in the figure and further shown in FIGS. 2 through 10B whereby the pan 100 is rotated as it follows conveyor track members 170. The indexing conveyor 600 is synchronized to center the pans 100 received with the magnetic support carriages 700 movement. The magnetic support carriage 700 circulates the pans 100 through the pan cleaning system 1. The magnetic support carriages 700 are continuously moved within the pan cleaning system 1 and spaced to correctly sequence each pan 100 in the cleaning section 270 for interaction with the cleaning subsystems therein.

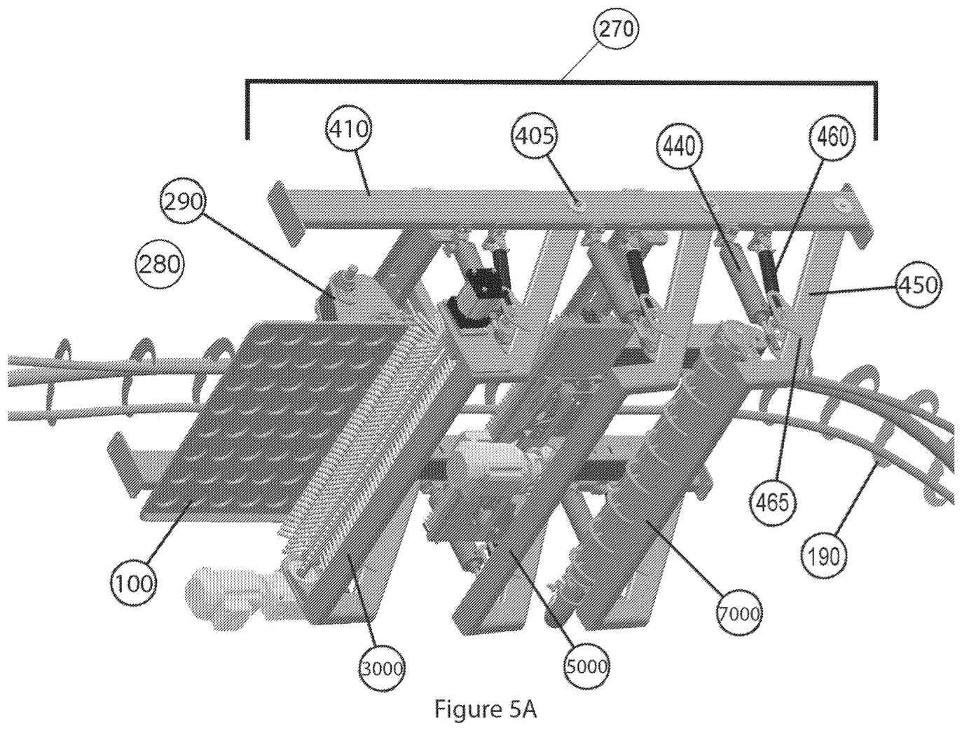

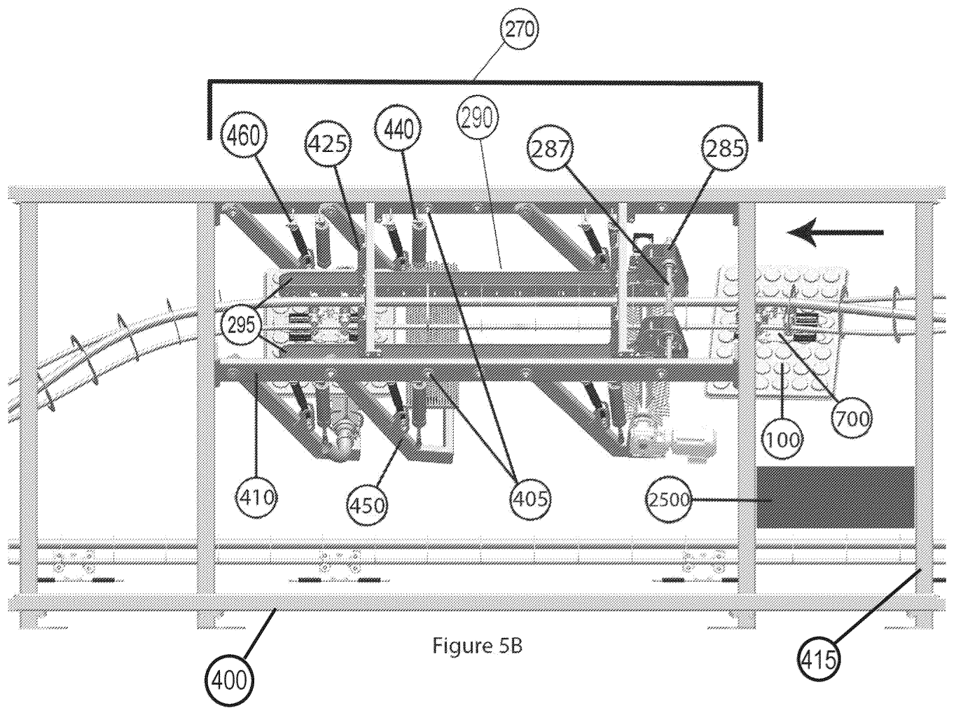

The cleaning section 270 has an entrance 280 and a number of cleaning subsystems 3000, 5000, 7000 therein as further enumerated herein in FIGS. 5A-10C. As the magnetic support carriage 700 with pan 100 magnetically coupled approaches the cleaning section 270 the first of an at least one partial rotation of the pan 100 is conducted as shown. In this non-limiting exemplary embodiment the magnetic support carriage 700 and the pan 100 attached thereto executes a first rotation about the minor axis of the pan 100 as the major axis of the pan remains perpendicular to the track locally, e.g. relatively flat, effectively providing a rotation or partial rotation relative to the vertical of the machine up to a minimum of making the pan incline to be perpendicular relative to the machine vertical to achieve a more advantageous cleaning orientation that uses gravity to assist in removal of debris. The track members 170 and magnetic support carriage 700 then reverse the travel about the axes of pan 100 to return to its orientation at entrance.

Though a second rotation is shown, this can be omitted or additional full or partial rotations may be executed by the carriage without departing from the spirit of the invention. Specifically, if the operation following the pan cleaning system I requires the orientation to be reversed. in for instance but certainly not limited, a pan stacking operation, the pan 100 may simply be left in the original orientation and no further rotation provided. Similarly, though the pan 100 in the exemplary embodiment is rotated so that it is inverted in the exemplary embodiment shown, it should be understood that the system can rotate to any angle such that the rotation is complimentary to the cleaning process. That is an angle that is less than substantially inverted, as a further non-limiting example, a rotation to one hundred and thirty five degrees from the starting orientation for instance, can afford similar beneficial effects for using gravity to aid in removal of debris.

Moreover, the disclosure of the instant invention having modular cleaning stations is illustrative in that the invention specifically contemplates the modular nature of these elements and the customization of the use, order and operation of the cleaning system can therefore be changed without diminishment of the unique nature of the overall system as compared with the existing fixed device prior art systems. The modular aspects may be varied without departing from the invention and those subsystems 3000, 5000, 7000 shown are illustrative, non-limiting examples. Additional, commercially available subsystems can be utilized alone or together with the invention on the swing arms as provided without detracting from the novelty of the overall pan cleaning system in and of itself. Similarly the pan may be rotated or moved about the track to fit the particular configuration of a cleaning subsystem or the particular dimensions or geometry of the pans. For example in further non-limiting exemplary embodiments sections may be hung high on the frame of the invention and a further section low and oriented opposite one another and the magnetic carriage support 700 can travel a complicated path to face each section in turn. Likewise, the invention has the flexibility of permitting the pan to come into the frame near the frame top and discharge near its bottom or conversely enter near the bottom and discharge near the top or combinations in between. The structure and complexity of the track members is only limited by the constraints of the overall size of the pan cleaning machine 1.

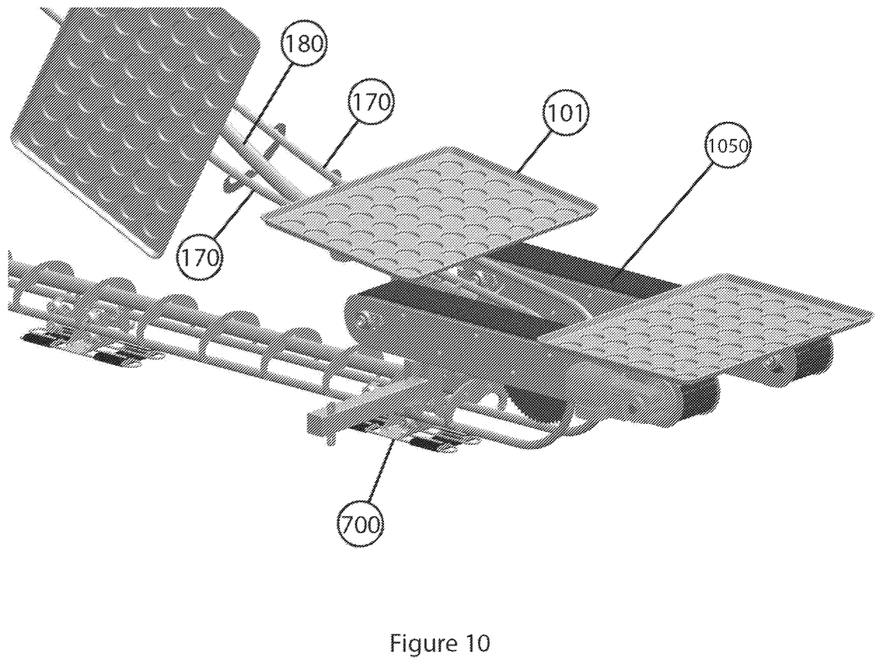

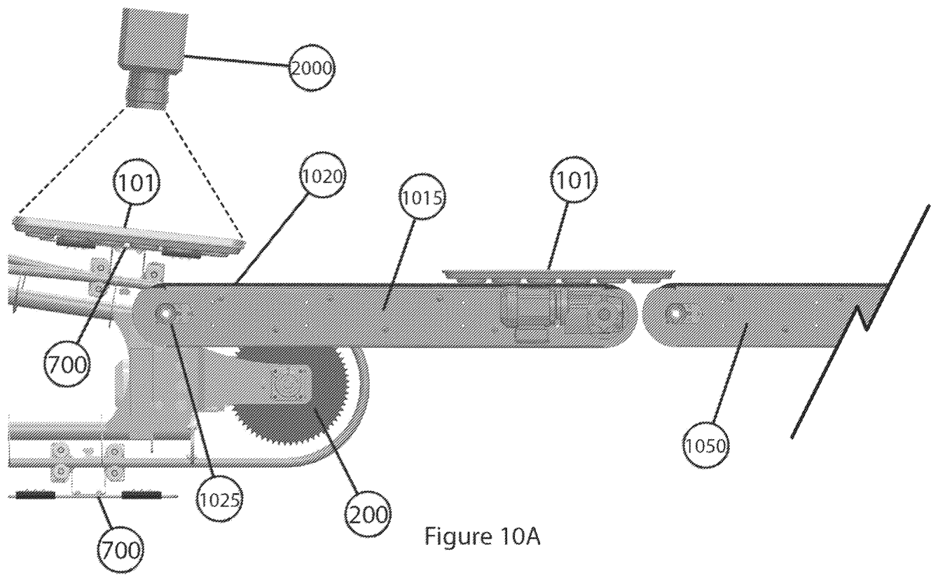

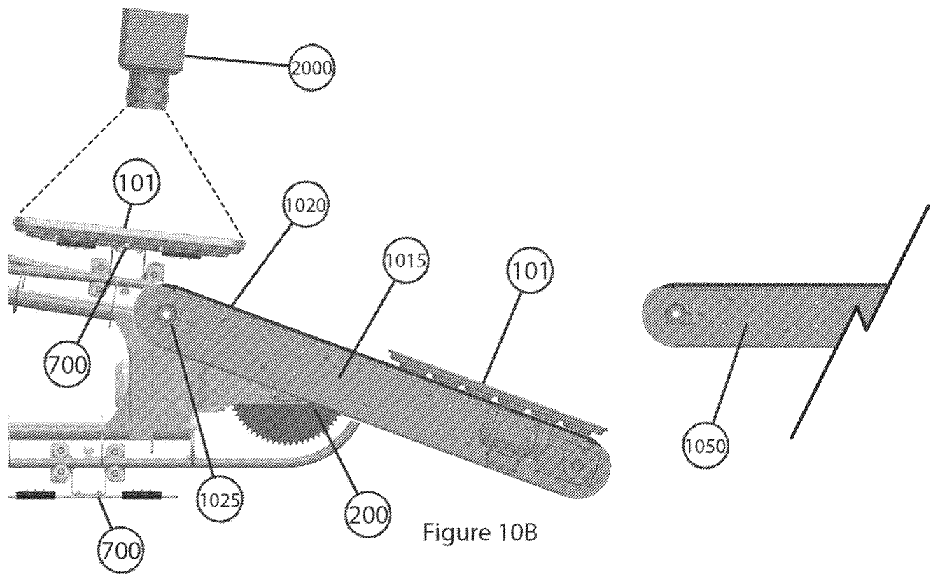

Returning to the exemplary embodiment shown, the pan 100 separates from the magnetic support carriage 700 as the magnet releases it onto a takeoff conveyor 1050. The magnetic support carriage 700 is re-circulated by the prime mover drive 230 in a continuous loop. The driven element 20 is looped around conveyor sprocket 210. The drive sprocket aids in returning the magnetic support carriage 700 to its starting point at the indexing conveyor 600 to again receive a pan 100 from the indexing conveyor 600. In a further embodiment shown in FIGS. 10A and 10B, a further sorting station may be utilized at the end of the line in conjunction with takeoff conveyor 1050. Again, though reference is made throughout to the exemplary embodiments and specific changes in orientation and motions, it should be understood that elements can be adjusted to suit specific variables associated with the processes ahead of and following the cleaning operation in the instant invention without departing from the spirit of the invention.

FIG. 2 shows a side cutaway view of a support carriage of the exemplary embodiment of the invention of FIG. 1. A set of mounted magnets 800, shown more clearly in the cutaway of gription pad 900 in FIGS. 3A and 3B, are attached to the magnetic support carriage 700 and will attract the ferrous composition of pan 100 to the magnets 800. The magnetic support carriage 700 is made up of several components which allow for magnetic adherence of pan 100 to magnetic support carriage 700. Through the use of the carriage magnets 800 which when placed in proximity to pan 100 provide a magnetic attraction of ferrous metals in pan 100 to magnets 800 and thereby magnetically couple the pan 100 to the support carriage 700. The gription pads 900 are connected to the support grid 10 by gription pad clamp plates 110 and gription pad bolts 120 as shown in greater detail in FIG. 3C.

FIG. 2 provides a side view of the magnetic support carriage 700 at or near the initial pickup by the magnetic support carriage 700 of the pan 100, though a single carriage is shown, as seen in FIG. 1 several carriages operate in the system. The magnetic support carriages 700 are mounted to the driven clement 20 on an at least one principal frame member 180, here a tube rail. An additional at least one conveyor track members 170 is provided to guide the magnetic support carriage 700 and upon which it rides. In the case of the exemplary embodiment shown, a non-limiting example of the at least one conveyor track member is shown as an opposed pair of track members 170 are provided. Though the exemplary embodiment utilizes a single main support member and two guide track members, greater or lesser numbers of each can be utilized. More specifically a system utilizing a single guide and support track is contemplated as an alternative embodiment of the instant invention.

A bogie support frame 130 is provided with bogie wheels 160. The frame 130 is coupled to the bogie wheels 160 in such a way as it provides the ability to rotate and twist through a fixed or semi rigidly fixed range of constrained motion as associated with the path of the conveyor track members 170. The nature of the construction of elements of the magnetic support carriage 700 are such that an inherent spring force is provided by the sheet metal construction of the pivot plate 150, bogie support frame 130, bogie twist plate 140 and other components with bends in the construction as well as. That is in part due to the sheet metal construction having a subtle flexion or spring force in it to accommodate deviations on track width or position that are encountered by the magnetic support carriage 700, whereby the bogie wheels 160 bolted to these structure would transmit the forces from the imperfections and the material forces would flex sufficiently so as to take up the forces from such minute deviations and imperfections in track width, track surface, and similar aspects of the invention.

Thus the bogie wheels 160 are allowed to flex so as to maintain the tension of wheels 160 to the track tubes 170 as the magnetic support carriage 700 goes through the set track path. There is also gross relative motion provided for during the larger twisting motions through use of the articulating parts coupled by swiveling connectors to the bogie support frame 130. Bogie twist plate 140 is so coupled and this allows for the rotational or angular rotation of the front of the magnetic support carriage 700, as an example, during the travel of the magnetic support carriage 700 along the curving path of the track members 170. A rear pivot wheel plate 150, which allows the bogie wheels 160 to pivot, is attached to the bogie support 130 as is the bogie twist plate 140 through friction swivel members as described herein below. Bogie wheels 160 are coupled to the rear pivot wheel plate 150. The bogie support frame 130 mounts to the track members 170 through the attached bogie wheels 160 as connected by these components. This provides the means of allowing the magnetic support carriage 700 to smoothly follow the pathway of the conveyor track members 170 through the various twists and angular changes made in the system.

Between the pan 100 and the magnetic support carriage 700 is mounted an at least one gription pad 900. The gription pad 900 provides a mechanism to accommodate surface and shape imperfections in the pan 100. The gription pad 900 provides a high coefficient of friction to prevent slippage, is non-interfering with the magnetic coupling between the pan and the magnets 800, and is compressible to accommodate imperfections in the pan 100 and the bottom surface to which it is attracted. This allows for imperfections such as but not limited to the pan being warped, bent, dented, or similarly mis-configured along its bottom surface which do not have perfectly uniform flat bottom surfaces can be more securely retained. It allows the pan 100 to float on the magnetic support carriage 700 removing the need for direct contact between the pan 100 and magnetic support carriage 700 as well as increasing magnetic adhesion with the pan 100 across a larger surface area. It also allows the pans 100 to better center on the magnetic support carriage 700. By centering the pans 100 to the magnetic support carriage 700 the pans 100 will be spaced so as to have the correct separation distance. This prevents the corners of pans 100 from colliding when the twist rotation occurs as they travel along the conveyor track members 170 as seen in FIG. 1.

FIG. 3A shows an isometric view of a magnetic carriage of the exemplary embodiment of FIG. 1. Main conveyor frame members 180 and track ribs 190 are more clearly shown. The boogie wheels 160 are shown mounted on the track members 170 in an upper and lower configuration, which are sets of wheels above and below the track members. The driven element 20 is shown and it is more clearly shown that it is operating in line with the frame support member 180 in this exemplary embodiment. Gription pads 900 are also clearly shown with cutaway sections showing magnets 800.

FIG. 3B shows an isometric close up view of the carriage without the track supports. In this isometric view greater detail is provided showing the bogie twist plate 140 which is bolted with a friction swivel member 145 so as to allow restricted rotational movement about the friction swivel member 145 as between the bogie twist plate 140 and the bogie support 130. This allows for a rotational change between the bogie support frame 130, the bogie twist plate 140, and the rear pivot wheel plate 150. Magnets 800 are more clearly shown herein through a partial cutaway of gription pad 900. The gription pads 900 are shown on a support grid 10 which is coupled to the bogie support frame 130. The magnets 800 which attract the pan 100 are also more clearly shown. The magnetic support carriage 700 is coupled to the driven element 20 as better seen in FIG. 3C.

FIG. 3C shows a further isometric view of the carriage of FIG. 3B from below. Again, clearly shown are the bogie frame 140, pivot wheel plate 150, bogie wheels 160, gription pad 900, and support grid 10 as previously described. More clearly shown are the gription pad fasteners 120 and gription pad clamp plates 110 which couple the gription pad 900 to the support grid 10. The friction swivel members 145, shown as bolts with washers and fasteners, are also more clearly shown due to the removal of one set of the bogie wheels 160 in the figure.

FIG. 3C also shows the coupling for the magnetic support carriage 700 to the cleaning system driven clement 20. As noted above, the cleaning system driven clement 20 allows for a movement of the magnetic support carriage 700 driven by a motor gear unit 230 through sprocket 250. The cleaning system drive clement 20 is attached to a lug 220 through lug swivel 210 which couples or transmits the motion imparted from the cleaning system drive clement 20 through to the bogie support frame 130. Power transmission to the cleaning system drive clement 20 is as described above is accomplished by a self-contained motor gear unit 230 which in turn provides rotational energy to a drive shaft 240 on which is coupled to and which in turn drives a drive sprocket 250 which is attached and takes the rotational energy of the gear motor 230 and produces the needed tension forces so as to pull the magnetic support carriages 700 with pans 100 through the invention with the drive clement 20.

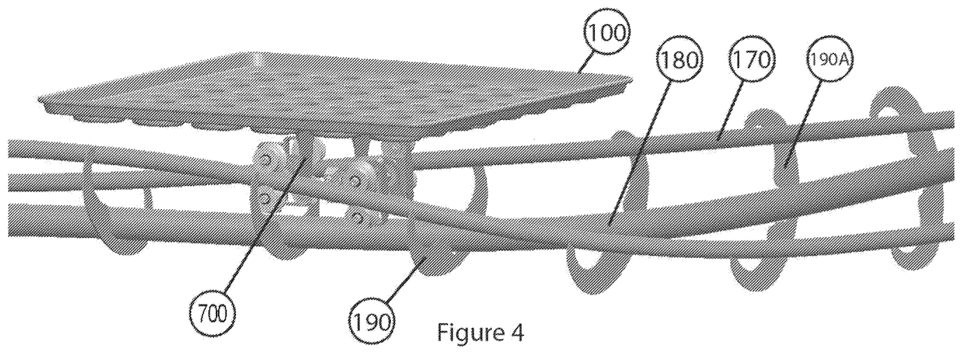

FIG. 4 shows an isometric view of the track as the support carriage begins the rotation of the pan. The section of travel on the system I where the pans 100 with magnetic support carriage 700 on the track members 170, frame member 180 and track ribs 190 begin a curved track path where the track 170 is going to rotate the pan 100 to a significantly inverted or rotated orientation. As seen in FIG. 4. the track ribs 190 are slowly reoriented via the rotated track ribs 190A which begin to provide a smooth twist of the track members 170. The magnetic support carriage 700 with the pan 100 magnetically attached will follow the track members 170 through the twist. The bogie twist plate 140 and pivot wheel plate 150 allowing the swiveling motion of the magnetic support carriage 700 relative to the bogie wheels 160 to maintain a relatively flat orientation of the pan 100 throughout the twisting return path of the track members 170 as the bogie frame 130 and the magnetic support carriage 700 swivel to compensate.

FIG. 5A shows an isometric view of an exemplary embodiment of the cleaning section. The pan 100 is shown entering the cleaning section entry 280 toward the exemplary combination of cleaning subsystems on the exemplary embodiment of the pan cleaning system 1. The exemplary embodiment of the cleaning section 270 includes horizontal cylindrical brush subsystem 3000. flat or planar brush system 5000, and an airknife subsystem 7000 coupled to a sub-frame section 410 and mounted below a secondary magnetic conveyor 290 and track members 170. As the magnetic support carriage 700 completes its rotation with the pan 100 attached as seen in the figure, the pan 100 enters the cleaning section 270 as shown.

Once in the cleaning section 270 the magnetic adhesion of the pan 100 to the magnetic support carriage 700 is complimented or added to by the introduction of a secondary magnetic conveyor 290. Secondary magnetic conveyor 290 works together with the magnetic support carriage 700 to substantially increase the mechanical hold that the pan cleaning system 1 has on the pan 100. This allows the pan 100 to maintain its connection with the magnetic support carriage 700 while being exposed to significant dislodging forces through cleaning operations. These cleaning operations can include but are certainly not limited to brushing, impinging air blasting, scraping, particle impact, and the like. The pan cleaning subsystems 3000, 5000, 7000 shown are for illustrative purposes only and further sub-components and subsystems are herein described all of which in conjunction with other existing cleaning devices can be mounted to the pan cleaning machine 1 and its swing arms 450 in accordance with the instant invention.

Each of the pan cleaning subsystems 3000, 5000, 7000 is coupled to the swing arms 450 with an actuator 440 with a swing arm position limiter 460. In this exemplary embodiment, the swing arm actuator 440 is an air cylinder which when pressurized will move and locate operating positions of the cleaning subsystems 3000, 5000, 7000 as noted herein. Using an air cylinder as the swing arm actuator 440 also allows for an adjustable degree of pressure to be exerted on the pans 100 and if there is an instance where the pans 100 are badly bent then the actuator 440 will allow for an overload condition to first exert increased pressure in the actuator to accommodate or float over the variations if they are minor and if a threshold is passed to report the condition to a controller 2500, as shown in FIG. 5B, and remove the pan from contact with the pan cleaning subsystems 3000, 5000, 7000 and pass it out as enumerated herein in a default condition.

The position limiter 460 is coupled to the swing arm 450 to set the height of the subsystem attached to the swing arm 450 above the secondary conveyor 290. One end of the position limiter 460 is fixed to the frame 410 the other is coupled to and rides in a slot in position limiter coupling 465 which is coupled to the swing arm 450. The position limiter coupling 465 allows for adjustment of the travel of the end of the position limiter 160. The position limiter coupling 465 thereby sets the minimum height of operation for the particular swing arm 450. This being the minimum height the swing arm can close to for the given cleaning subsystem.

The pan cleaning subsystems 3000, 5000, 7000 are also coupled to and communicate with a controller 2500, as better shown in FIG. 5B. As detailed herein below, the swing arms 450 hold each subsystem at an operating distance as set by the position limiter 460 and data is communicated from the controller 2500 to the actuator 450 and the position limiter 460 to adjust for the particular subsystem and operation, e.g. pan size, pan shape, and similar variables. A Hall Effect encoder (not shown) or similar sensor is provided on the position limiter 460 and is used to provide feedback information to the controller 2500 on the position limiter 460. This information is provided to the controller 2500 indicating the location of position limiter 460. The pressure on each swing arm 450 is monitored by the controller 2500 through sensors (not shown) in communication with the swing arm actuator 440. In the exemplary embodiment, in a non-limiting example, the swing arm actuator 440 is an air cylinder, as noted above, and pressure management is provided through and monitored by an electronically controlled regulator (not shown) in communication with the controller 2500. In this fashion, in the exemplary embodiment, the controller 2500 communicates with and controls air pressure in each of the swing arm actuators 440 and thereby the movement of the swing arm 450. Similar sensors can be provided to suit the type of actuator 440 that is utilized. which can include for instance servo motors, hydraulic cylinders, or similar actuators and appropriate sensors to control the pressures exerted by on the pans 100 and the movement of the swing arm 450.

The controller 2500 and the reported pressures allow operation of the device in a programmed range of pressures. as noted above. If, while monitoring such pressures, the pressure exceeds the range, the nature of the excess pressure or overload condition can be an indicator of a jammed pan or of a misconfigured/bent pan. The controller 2500 can act to first exert increased pressure in the actuator to accommodate or float over the variations if they are minor, as noted above. Additionally, if a threshold is passed it can stop the line and report the condition to the controller 2500 and remove the pan from contact with the pan cleaning subsystems 3000, 5000, 7000 and pass it out as enumerated herein in a default condition. Alternatively, if can pass the individual pan and continue operation and notify and operator. Similarly. it can move the swing arms to an open position raised away from the secondary conveyor for maintenance in a similar fashion and shut the line down as noted above.

This information together with sensors on or as components of the cleaning subsystems 3000, 5000, 7000 monitor operations and the height of the subsystem above the secondary conveyor 290 as set. The position limiter 460 and these sensors work in conjunction with controller 2500 and the pan cleaning subsystems 3000, 5000, 7000 to operate and clean the pan 100. Additional sensors, for instance an accelerometer (not shown) on the planar brush system 7000 feed additional data to the controller during operations. If a default condition is sensed such that too high a pressure is seen in the swing arm 450 or other abnormal conditions in the subsystems sensors 3000, 5000, 7000 are detected and the pan 100 is in jeopardy of being wedged or stuck or otherwise threatening to overload the pan cleaning system 1, the controller 2500 can be alerted and a default condition to remove the pan from cleaning subsystems 3000, 5000, 7000 to their maximum height and allow the problem causing pan to pass through the pan cleaning system 1 untouched. If a pan sorting system like that shown in FIGS. 10A and 10B is coupled to the controller, the problem pan can be diverted out of service.

FIG. 5B shows a side view from the back of the exemplary embodiment of the instant invention. As seen in the Figure, the pan 100 is traveling from the right side of the figure to the left, as indicated by the directional arrow, as it is a rear view of the pan cleaning system 1. The secondary magnetic conveyor 290 is mounted via a secondary conveyor frame or a cleaning section sub-frame 410 which is coupled to the principal cleaning section frame 400. It being understood as a modular construction that additional principal and secondary frames can be added to expand the length of the system. The secondary magnetic conveyor 290 has at least one secondary magnetic conveyor element 295, which in the case of the exemplary embodiment shown comprises two such elements. The secondary magnetic conveyor further comprises, but is not limited to, a motor with gear reducer contained in a single unit 285, is provided and which drives the at least one secondary magnetic conveyor elements 295 through a secondary conveyor drive shaft 287.

The secondary conveyor drive shaft is coupled to a pulley (not shown) which has a positive drive profile to suit the use of typical timing belt. The timing belt is synchronized either through gross motion or surface speed with the magnetic support carriage 700 so as to assist in travel and adherence of pans 100 for the duration of the travel of the pan 100 through the cleaning section 270. Alternatively, in another exemplary embodiment it is contemplated that the secondary magnetic conveyor 290 can be mounted by an adjustable mechanism or swing arms of its own (not shown) to additionally adjust the location of the secondary magnetic conveyor element 295 relative to the pan cleaning subsystems 3000, 5000, 7000.

The cleaning section 270 has its own cleaning section sub-frame 410 from which all of the cleaning elements are attached via swing arms 450. All cleaning devices are affixed and operate from an at least one set of swing arms 450, as noted above, that are affixed to the cleaning section sub-frame 410 in a rotatable fashion with swing arm actuator 440 pivoting the swing arm 450 and a position limiter 460 in communication with controller 2500. Each swing arm 450 is coupled at a swing arm pivot point 405 with an at least one swing arm actuator 440 such that it will be activated by the controller 2500 so that it will extend so as to open the swing arm 450 about its swing arm pivot 405 so that it moves toward or away from the secondary magnetic conveyor 290 with pan conveyor tracks 295. The swing arms 450 provide a means for attachment of all cleaning subsystems to be used for cleaning of the pans 100 in the exemplary embodiment of the pan cleaning machine 1 and are expandable as well as open via the open frame architecture for easy maintenance and cleaning. This includes attachment at the swing arm by releasable connectors so as to more easily release the cleaning subsystems for replacement tor maintenance.

For instance, when the invention is programmed at the controller or locally in a cleaning subsystem to change a brush or when an operator wants to open up the cleaning device, the swing arm actuator 440 will be activated so that it will extend or retract so as to open the swing arm 450 about its swing arm pivot 405 so that it moves away from the secondary conveyor 290, pan conveyor tracks 170, and conveyor frame 180 to provide access. The closed frame embodiments of prior art devices do not permit such case of access. In the case of an overload condition, it signals for retraction of the swing arm 450 via the controller 2500 until the badly bent pan has exited or is removed. In this way a fault arises, for example in any of the subsystems 3000, 5000, 7000 as well as sensed at the more global level, the instant invention can respond and clear itself through the operation of the swing arms 450.

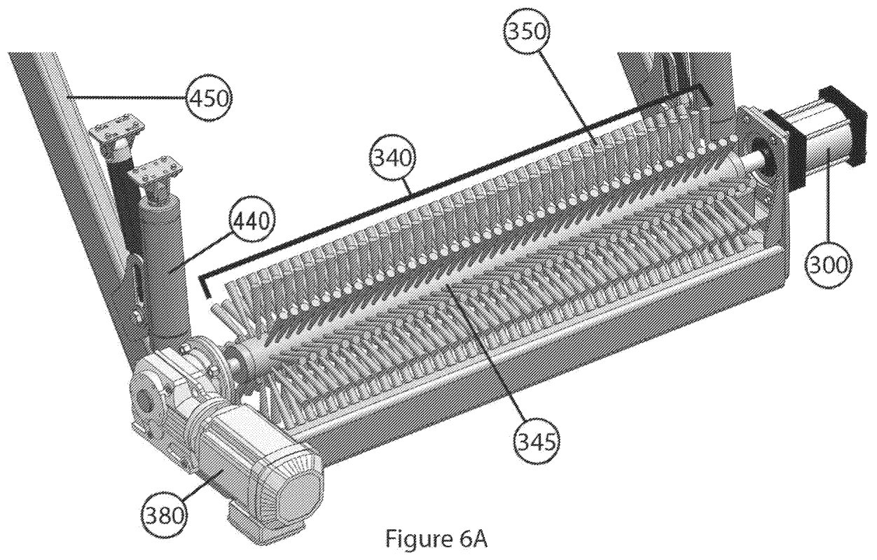

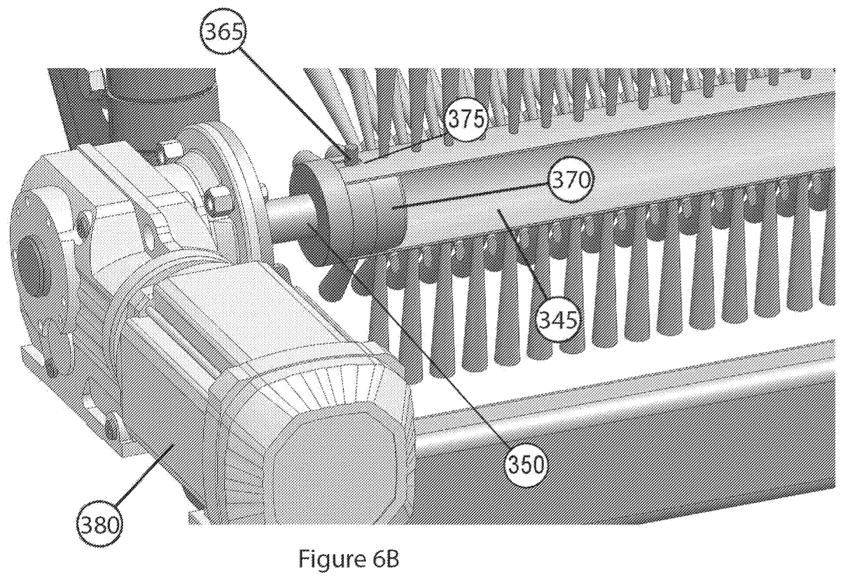

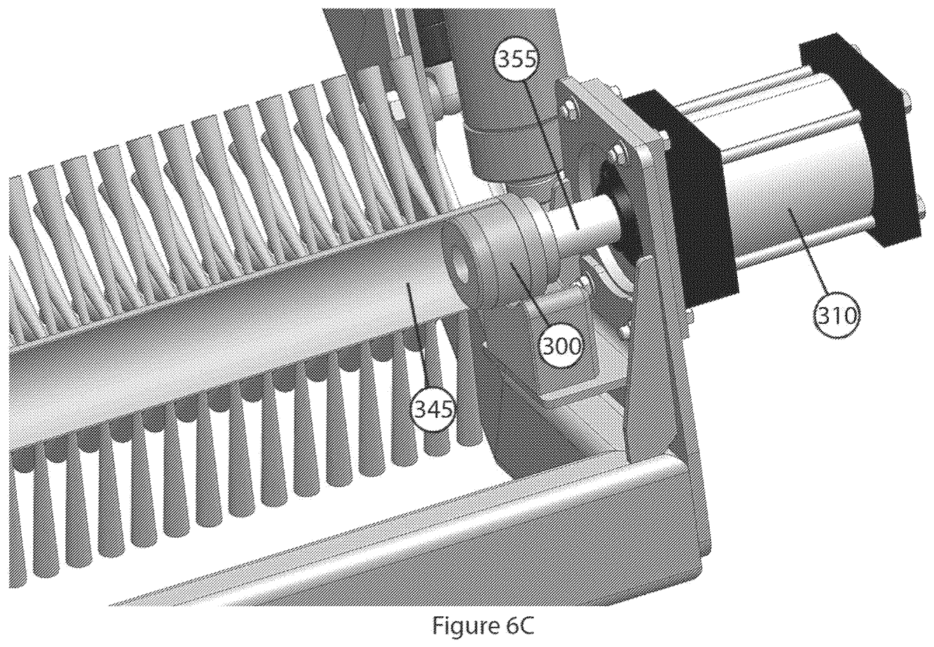

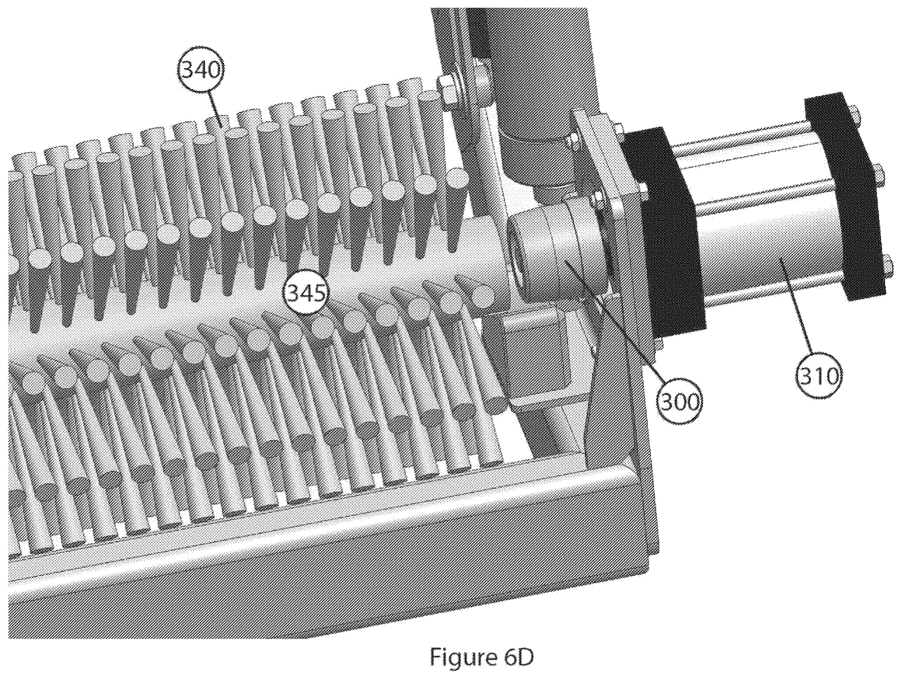

The movement of swing arm 450 allows the pan cleaning subsystems 3000, 5000, 7000 to be retracted from and extended to a preset or adjustable distance from the secondary conveyor 290 as controlled by controller 2500. When swung away for maintenance the cleaning pan cleaning subsystems 3000, 5000, 7000 will be accessible for service such as but not limited to changing of brush elements. cleaning the airknife and other associated maintenance processes. This swing arm system 450 is common to all cleaning subsystems located on this invention where presently can be seen three examples but this is not a limitation on the number of cleaning devices that can be used and the additional swing arm pivots 405 are indicative of this modularity, flexibility and expandability in design. As previously stated this can include the addition of additional cleaning subsystems or devices or multiples of the cleaning devices shown such that duplication would permit continuous operation of the system. For instance one subsystem could be idled and rotated to an easily accessible position for upkeep or maintenance while the other engages the pans in a further exemplary embodiment of the invention. Similarly, a rotating carousel or paddle wheel sub-frame or device can be used to provide multiple brush heads that can be similarly swapped out by rotation in between the swing arms as described in FIG. 6B, As noted, each of the swing arms can releasably couple the respective subsystem to the swing arm through a releasable connector such that the subsystem can be removed or in the example of the carousel subsystem elements can be replaced as needed.

Controller 2500 is shown as a specialized controller which can include but is certainly not limited to multiple programmable logic controllers on a bus or board with memory storage devices and active or operational memory to execute control algorithms on numerous subsystems as well as receive output from sensors on those systems or send input to those systems as part of a control program to effectuate operation of the pan cleaning system 1 as described. This can include but is not limited to operating a pan sorting station in conjunction with a machine vision device as described herein in relation to FIGS. 10A and 10B, operating the cleaning subsystems 3000, 5000, 7000, as substantially shown and described herein. providing a hierarchical programming structure or operating code to add additional devices and operate these devices either as a part of its software or through additional hardware. and to provide user input to the pan cleaning system 1. This can include a user input device, such as but certainly not limited to a touch screen or similar input.

The pan cleaning machine 1 of the instant invention also allows for easier removal, addition, or substitution of cleaning subsystems. The swing arm 450 allows for swinging out of the cleaning subsystems 3000, 5000, 7000 so as to allow for exchange/replacement of brushes, air knives, or addition or removal of any other devices or complete subsystems to be utilized on the pan cleaning machine 1. If adding subsystems. additional swing arms 450 can be provided on additional pivot points 405 as shown. The modular pivot points also permit spacing adjustment to accommodate a wider variety of devices than the prior art.

Similarly, as noted above, additional frame components may be attached to the principal frame 400 similar to sub-frame 410 to further expand the system. Likewise, the principal frame 400 can be produced at a larger scale to accommodate longer or higher combinations of subsystems, the pan cleaning system of the instant invention is modular and flexible. This modular nature of this setup of the cleaning section 270 within the frames 400, 415 of the system affords the instant invention great advantages over the existing prior art pan cleaners and is heretofore unknown in the industry. That is by mounting with more easily accessible connectors the cleaning subsystems, swing arm pivots and the swing arms in the cleaning section 270 can be more easily customized to suit the needs of the customer for particular pans being sent for cleaning and the cleaning section 270 itself can be made to provide for additional cleaning devices and customization of the devices.

Additionally with these replaceable elements in this open frame modular architecture permit rapid changes of the type and nature and action of the brushes and other cleaning devices. These changes can be made and adjusted to suit the specifications of the operator and the cleaning operation allowing for unparalleled customizability and flexibility in operations without hampering performance or efficiency of the machine or production of the baking operation. Additionally, several improvements accompany this disclosure as to the pan cleaning subsystems 3000, 5000, 7000 and reference is made herein below to these exemplary embodiments of the subsystems.

FIG. 6A shows an isometric view of a straight, spinning, brush cleaning sub-component in the exemplary embodiment of FIG. 5A. In the exemplary embodiment shown in FIG. 5A, the first stage of the cleaning section for the pans 100 comprises a rotating horizontal cylindrical brush subsystem 3000 having a rotating cylindrical brush 340 which has radially extending bristles 350. The horizontal rotating cylindrical brush 340 is horizontal relative to the plane of the pan 100 as conveyed. An exemplary embodiment of the sub-component cylindrical brush 340 is held on a center hollow brush shaft 345 coupled to the drive motor 380. In this exemplary embodiment, this setup is provided so that when a pan 100 comes into the cleaning section 270 removal of any large items such as but not limited to loosely adhering product or improperly or not depanned, e.g., stuck products or toppings. These large items should be removed before detailed cleaning is to take place so this stage employs the rotating cylindrical brush 340 to knock the adhering product loose. This embodiment of the cylindrical brush 340 however allows for rapid replacement of the brush head as enumerated herein below.

FIG. 6B is a close up of the cylindrical brush of FIG. 6A with a cutout showing an exemplary embodiment of a quick change drive coupling. The Figure shows the cylindrical brush 340 supported by and mounted to the drive coupling 370. The brush 340 has a hollow shaft 345 either partially hollow or hollow throughout the length of the shaft. A brush drive 380 is provided for turning the brush 340. The brush drive 380 is coupled to and drives a drive shaft 350 which is further coupled to the drive coupling 370. The drive coupling has a support portion and an end cap section. The drive coupling 370 extends into the hollow interior hollow shaft 345 of the brush 340.

A drive addendum 365 extends from the support portion and is indexed with and is releasably coupled into a drive dedendum 375 herein shown as being in the wall of hollow shaft 345. It should be noted that the male and female addendum and dedendum can be mirrored or multiple such elements provided and such designs are explicitly contemplated but for the sake of brevity are not shown. To further facilitate the modular nature of the instant invention. a novel way to allow these cylindrical brushes to be removed and installed is provided. This release system no longer requires the use of threaded fasteners. The lack of threaded connectors allows for a significant time reduction in the time required to change existing brush configurations. Additionally, though not show, a swing out body or carousel may be provided which allows multiple brush heads 340 to be placed on the subsystem and in a carousel frame indexed so that one may be moved out of service and be accessed for replacement for instance. Turning back to the exemplary embodiment shown, by having the cylindrical brush 340 on a drive end coupling 370 and the idler end coupling 300 on a retractable mechanical drive 310, as further highlighted in FIG. 6D, moving the system into an open position allows the cylindrical brush to be removed and replaced in seconds rather than hours and without the need for tools.

FIG. 6C showing the opposed end of the cylindrical brush of FIG. 6B in a closed position. The opposed end of the brush 340 is shown closed, that is the hollow shaft 345 of the brush 340 has the idler coupling 300 inserted therein. The brush support shaft 355 is mounted to an idler coupling 300 which supports the brush 340.

The idler coupling 300 is further coupled to a locating actuator 310 which allows for the idler coupling 300 to be inserted and removed from the hollow portion 345 of the brush 340. In an exemplary embodiment the actuator 310 can be for instance be, but is certainly not limited to, an actuating air cylinder. This actuator 310, here an air cylinder, is used as a means of actuation but it can be understood that other means of movement and or actuation can be utilized without departing from the intent of the invention. The idler coupling 300 supports the brush 340 by extending into the hollow shaft 345. The idler coupling 300 rotates freely and allows for the free rotation of the brush 340. Simultaneously, when the idler coupling 300 is moved into the open position, the brush becomes free of the mounts and is easily removed.

FIG. 6D shows the opposed end of the cylindrical brush of FIG. 6B in an open position. The cylindrical brush 340 in the open position. In this position the actuator 310 is retracted and the idler coupling 300 is disengaged from the brush 340 and outside the hollow shaft 345. When clamped in position as shown in FIG. 5C. the idler coupling 300 is pushed into the hollow shaft. When the brush 340 needs to be removed the clamping force is removed by the actuator 310 by its movement along the actuator shaft 355 shown here as being retracted into the actuator 310. This frees the brush shaft 345 on the idler 300 end and permits the addendum 365 to be disengaged from the dedendum 375. Thus by activating actuator 310 this subsystem allows for greatly enhanced change over speed for replacing the brush unit 340 where changeover or removal and replacement goes from several hours for prior art designs to less than one minute for the improved version of the exemplary embodiment of the instant invention.

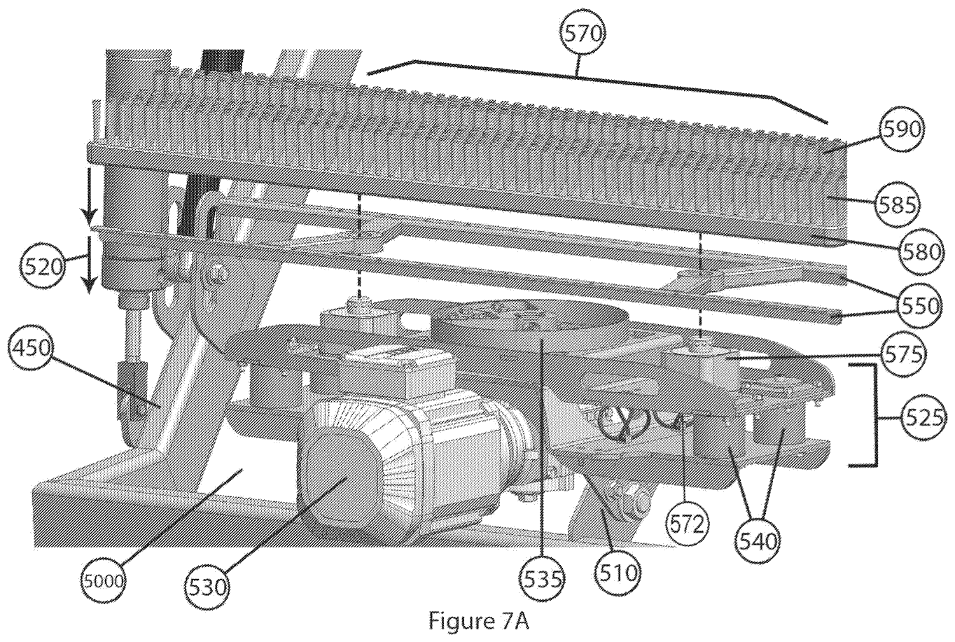

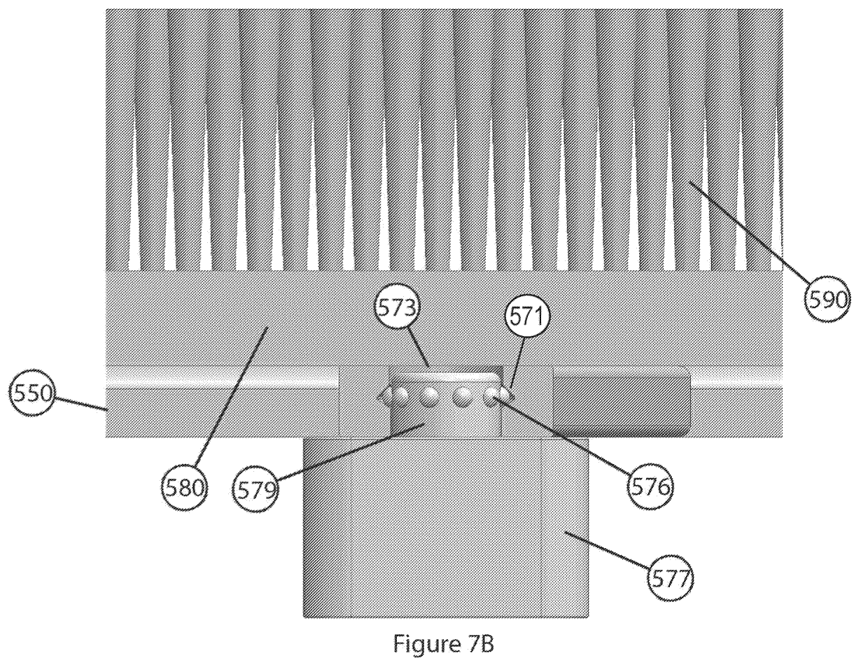

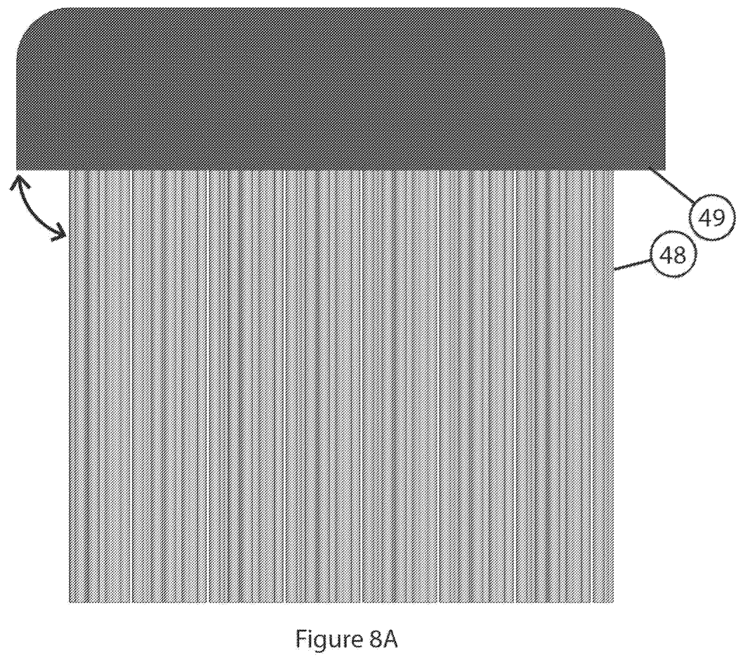

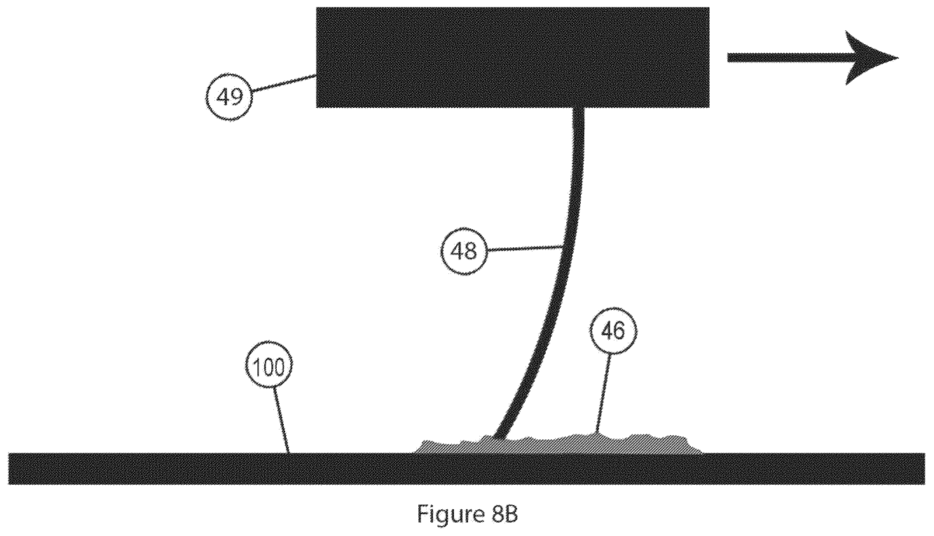

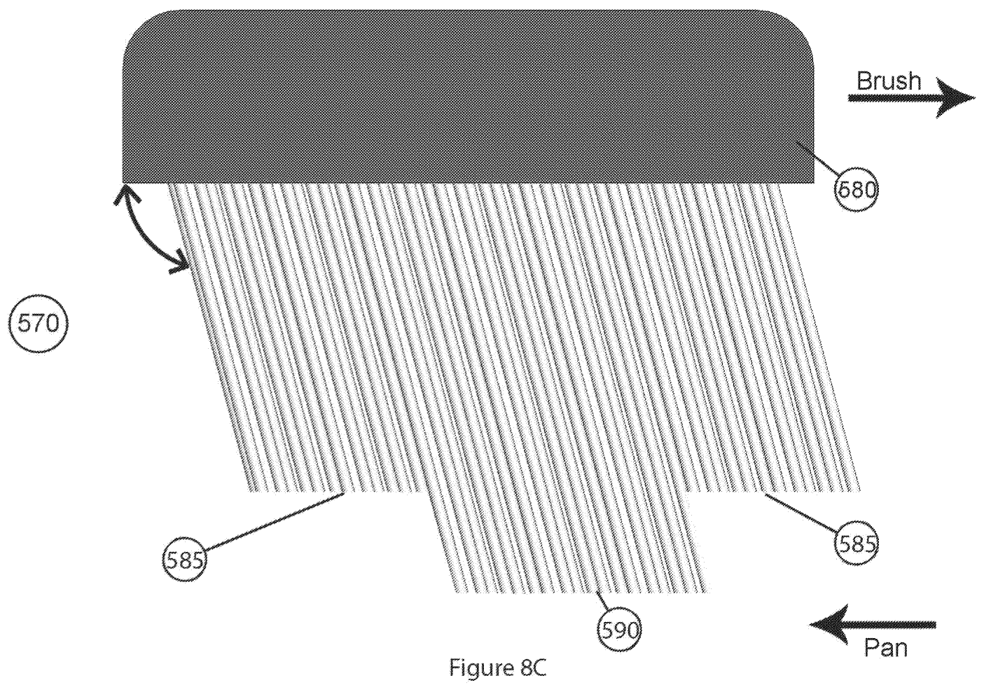

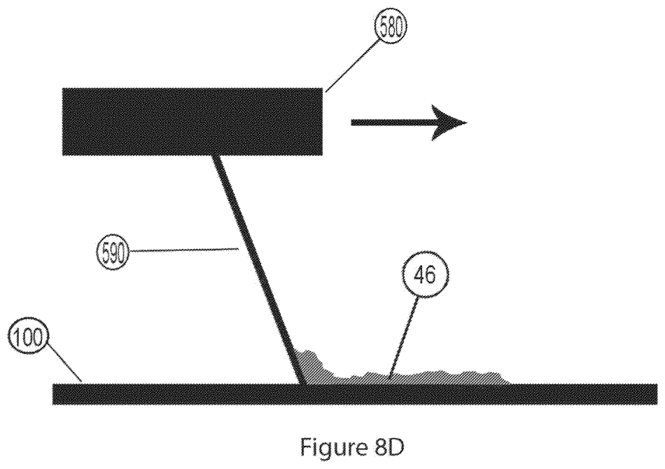

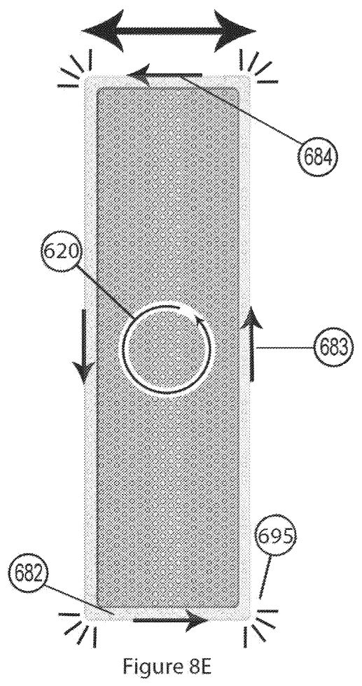

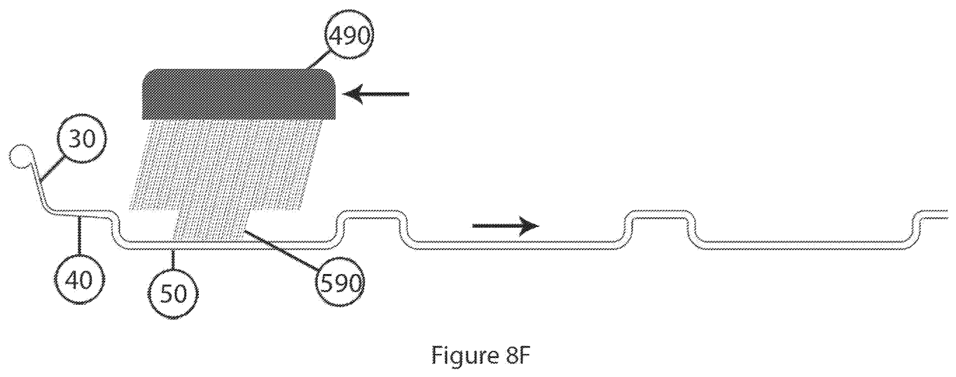

FIG. 7A shows exploded view of an exemplary embodiment of a planar brush subsystem in the exemplary embodiment of FIG. 5A. As seen in FIG. 5A, pans 100 move from the rotating horizontal cylindrical brush subsystem 3000, in an exemplary configuration as shown in an exemplary embodiment of the invention, to an orbital, or oscillating, or orbital and oscillating flat or planar brush cleaning subsystem 5000 with a flat brush assembly 570 that has bristles 585, 590 arranged and entered into a slab of brush base 580. The planar brush subsystem 5000 subjects the pan 100 to additional cleaning using higher, longer, taller bristles to scrub the pan 100 surface with sufficient contact pressure and a compound elliptical scrubbing motion. A further exemplary embodiment of the brush subcomponent of this subsystem pictured in FIG. 7A with specifically angled bristles relative to this motion is further substantially disclosed in FIGS. 8A-8C herein below. FIG. 7A shows an exploded view of the planar brush subsystem 5000 whereby the brush base 580 with bristles 585, 590 is shown detached from brush mounting frame 550.

The planar brush subsystem 5000 is mounted to the swing arm 450 at coupling 510 and is further coupled to an oscillating assembly 525 through attachment at quick attachment posts 575. The oscillating assembly 525 includes an oscillating drive motor 530 driving a rotary element 535 which is driven in an orbiting fashion in the plane of the planar brush 570. As better shown in FIG. 8E, the combination of the motion of pan 100 and the orbital motion of the brush 570 imparted by the rotary element 535 that provides a compound elliptical scrubbing motion that is both orbital and oscillating across the surface of the pan 100. The oscillating assembly 525 further includes dampening and counterweight members 540 to dampen any vibratory motions from the rotary element 535.

As indicated generally at 520 the planar brush subsystem 5000 of the invention can be raised and lowered from the frame 410. As previously described, control inputs communicated from controller 2500 work with the swing arm 450 and swing arm actuator 440 to position the planar brush subsystem 5000 during operation. That is the actuator 440 is used to move the swing arm according to the programmed values or inputs from a user interface at the controller 2500 for each subsystem 3000, 5000, 7000 attached to the swing arm 450 and working on the pan 100 being conveyed on the secondary conveyor 290. This view also shows how the brush 570 may be disassembled or removed for cleaning and service with quick release mechanism 575.

A more defined or specific cleaning process and action can be achieved with the instant invention using the planar brush subsystem 5000 shown and the orientation of the pan 100 in the at least partially inverted orientation and with the height adjustment afforded by the swing arms 450 through the motion indicated at 520. The plane brush 570 has a flat plane of a width sufficient to clean the approaching cross axis length of the pan 100 so that as the pan 100 passes over brush bristles 580 the brush will provide coverage over the entire pan surface. By using a flat plane brush 520 with a width sufficient to cover the entirety of the width of pan 100, the flat plane brush is always in contact with the pan 100 as it passes under the brush 570. Additionally the motion imparted by the rotary frame assembly 520 provides an elliptical scrubbing action across the entire width of the pan 100. This is distinguished from typical pan cleaning sub-stations using cylindrical brushes that have defined paths that do not fit the entire width of the pans 100.

The plane brush assembly 570 has a step down brush profile, detailed in FIG. 8C, such that a row of shorter bristles 585 precedes a row of higher bristles 590 and is followed by a further row of shorter bristles 585 across the width of the brush 570. The rows of bristles in the brush 570 are also offset at an angle, as further described in relation to FIGS. 8C and 8D below, in alternating rows across the length of the brush 570. that is one row oriented to the left and the following to the right. The pan surface is engaged by the full width of the plane brush 570. The lip of the pan 40 being scrubbed by the lower row of lower bristles 585 and deflecting under greater pressure the higher row of bristles 590. The pockets or depression sections of the pan 50 being reached by the higher bristles 590 or by the lower and higher bristles 585, 590. Thus, the plane brush is in full contact with the surface of pan 100 as it is motivated across the brush 570 imparting the substantially elliptical scrubbing motion.

In prior art pan cleaners the rotating cylindrical brushes were bolted in place on fixed bearing mounts and shafts mounted in these fixed bearings so that replacement was time consuming and difficult where this work had to be typically be done only on longer periods of time when lines were out of production which meant that the brushes could get dirty a point where they would not hold what they brushed off. The plane or flat brush 570 also provides some novel aspects such as quick detaching connectors 575 which allow the flat brush 570 to be quickly and readily attached or detached for cleaning or replacement or both. This quick change aspect is not provided on prior art flat brush pan cleaners, point in fact few if any flat plane brush types have been used in pan cleaning machines. The quick attachment mechanism 575 further comprises in the exemplary embodiment, but is certainly not limited to, two quick attachment posts 577 having protruding quick attachment points 579. FIG. 8B shows a closer view of the particular attachments.

FIG. 7B shows the cut away of the quick release attachment points of the plane brush sub-component of FIG. 7A. The quick attachment posts or system 575 are shown with friction fit elements 571. These friction fit elements 571 being further protrusions, typically ball bearings, that are biased outward, in the exemplary embodiment by driven tapered pins (not shown). When an activator 572, here a plunger, is depressed this permits depression of the ball bearings into the attachment extensions 579 which extend from posts 577. The posts 577 have the attachment extensions 579 protruding from them and these fit into two matching cavities 573 in the frame 550. The cavities 573 in turn have detents 576 that match the friction fit elements 571. The attachment extensions 579 and posts 577 mount the base plate 580 of the brush 570. Brush 570 is fixedly mounted to frame 550. The attachment posts penetrate into the matching cavities 573. The brush is pushed over so that the cavities are engaging the post and extensions such that the friction fit elements 571 are briefly depressed and allowed to engage the detents 576 and the brush is thereby coupled.

Thus the planar brush subsystem 5000 provides for enhanced cleaning of the pans 100 as they pass through in their substantially inverted orientation and are scrubbed with the planar brush 470. The higher surface contact pressure in the planar brush subsystem 5000 provides a greater deflection of the bristles in the cleaning. Additionally, specific improvements over the prior art bristles shape is effectuated in the exemplary embodiment shown. In the prior art, when subject to increased bristle pressures, the conventional bristles would bend back from the loading of the bristle as well as motion of the bristle so that the best description of the brush bristle action would be of wiping where the bristle would be bent back so that the curved portion of the bristle would be first coming over the seed or area of the pan to be cleaned and as the brush moved it would come more over the area of cleaning and the last aspect of bristle movement would be a rubbing off aspect where the bristle is sweeping back over the surface. With the new bristle drive design the bristle is combining a degree of this previously indicated action as well as a forward pushing off or shearing action of movement. These are two of the brushing aspects that arc provided as well in the planar subsystem 5000 section can be lengthened so as to include additional or differing brushing units. The exemplary embodiment uses a planar brush with rows of bristles 585, 590 that have an improved bias, as opposed to perpendicular bristle planar brushes.

FIGS. 8A and 8B show a typical perpendicular brush assembly of a planar brush. The typical brush 45 of FIG. 7A can be used in the invention however it is not as effective as the improved brush of FIGS. 8C-8D. The typical brush has base 49 and bristles 48 where the bristles are mounted perpendicular to the brush base 49. The issue with this style of brush 45 is when it is contact and under pressure. the perpendicular mounted bristles 49 deflect in the direction of travel as the brush as shown in FIG. 8B. As the bristles 48 are in compression to the pan 100. the result is the bristle 48 will have a rearward flexion before being in contact with the debris 46 and as the bristle 48 goes onto the debris 46 this angle or bristle flexion will increase, as best seen in FIG. 8B. This results in the less effective removal of debris 46 that is adhering to the pan 100. The bristles 48 merely bend and swipe across the face or over the top of the debris 46. The planar brush subsystem 5000 uses the planar brush 570 of FIG. 8C with improved bristles 585, 590 that move in an advantageous eccentric orbital motion 620, imparted by the brush oscillating assembly 525 that through the motion of the pan 100 as seen in FIG. 8E. It also provides an oscillating effect to provide a substantially elliptical scrubbing motion on the pan 100 with improved removal of debris 46 due to the improved bristle 650 orientation and configuration.

FIGS. 8C and 8D show a cross section of a row of the improved bristles of an exemplary embodiment of the improved bristle brush of the planar brush subsystem of FIG. 7A. As shown, a row of improved brush bristles 585, 590 from brush 570 are embedded at an angle relative to the motion of the brush as indicated by the relative motion arrows for the rotating brush and the pan as it is conveyed. The effect of the angle at a forward incline of the bristles 585,590 to the brush base 580 as shown, the bristles 585, 590 are leaning forward and any compressive force in the brush when directed towards the pan 100 will result in a bending of the bristle so as to provide and maintain loading of the bristle tip on the pan surface. As seen in FIG. 8D, this further biases the improved bristles 585, 590 against the debris at contact and the bristle tip is to more likely to adhering to the pan surface and thereby apply a scraping or bull dozing effect on the debris. By comparison this is more likely to result in effective removal of the debris from the pan than with the conventional brush depicted in FIGS. 8A and 8B.

Turning to the Figures. the single row of improved bristles is shown. As noted above in relation to the description of FIG. 7A, the bristles are set in opposed rows as seen as along the length of the planar brush 570. The embodiment of the flat block or planar brush 570 is shown with biased brush rows 5 in two heights 585, 590 across the brush 570. By orientating the row of improved bristles 585, 590 in a non-perpendicular orientation to the pan providing greater effective cleaning of debris 2 from the pan 100. The exemplary embodiment has the row of bristles 585, 590 on a diagonal to the face of the brush in a manner of from five to about seventy degrees from perpendicular, more specifically from about ten to sixty degrees as shown. The brushes are thus biased against the relative motion shown by the directional arrow that is imparted by the movement of the pan and the direction of rotation of the brush 570. As the planar brush 570 travels along the pan 100 and is moved as described in FIG. 7A-7B and further shown in FIG. 8E, the alternating rows of improved bristles 585, 590 are alternately always biased against the motion, e.g. one row is always pointed as depicted in FIG. 8C. providing for the scraping effect previously mentioned in either relative direction of the motion of the brush 570 as it orbits. That is to say as the brush travels in its orbit, the one or the others of the alternating rows of improved bristles 585, 590 are substantially forward biased in relation to the movement of the pan in combination with the brush.

FIG. 8E shows the top down view of the planar brush of FIG. 7A in its scrubbing motion. As shown the flat or planar brush assembly 570 which is moved, as discussed above. in an orbital rotation by oscillating assembly 525. The generally elliptical motion of the rectangular shaped brush is show as an offset or eccentric circle. In addition to this motion, the pan 100 being contacted by the planar brush assembly 570 is further moving in the direction of travel of the magnetic support carriage 700 as it moves on the track members 170. The result is a combination of an eccentric orbital motion with a forward or backward motion relative to the surface of the pan 100 being cleaned. Additionally, as seen in FIG. 8E, additional bristles 695 are show mounted on the outer edges of the brush base 580. These whisker brushes provide extra reach and run against the side edges of the pan 100 during the orbit to assist with corners in the pan 100, Though shown as extending from the brush base 580, the invention may also incorporate the whisker brushes on the brush base at the tips 682. These can be oriented in the lengthwise direction 683 on the brush 570 such that alternating rows across the brush width 684 are provided with an angled profile similar to the tall brush bristles 590 at similar angles. These bristles on the tips 682 aiding in cleaning into corners on the pans 100.

FIG. 8F shows the cross section of the planar brush passing relative to the brush in FIG. 8E. The brush 570 contacts the pan 100 and proceeds over lip 30, pan surface 40, and pocket 50. The brush 570 is in constant contact under pressure on the pan 100. As the pan 100 passes over the brush 570, the linear motion is imparted on the pan 100 as the brush 570 follows the eccentric substantially elliptical scrubbing motion track shown in FIG. 8E. Again, this is from the relative motion of the brush and the pan to one another. The brush 570 reaches all sections of the pan 100 with the improved bristles 585, 590 and whisker bristles 695,682 being passed over the pan. The resulting substantially elliptical scrubbing motion provides the improved bristles 585, 590 with the aspect and angular motion shown in FIG. 8D. This has proven to be very effective in removing stuck on foodstuff materials oversprayed on the pans 100.

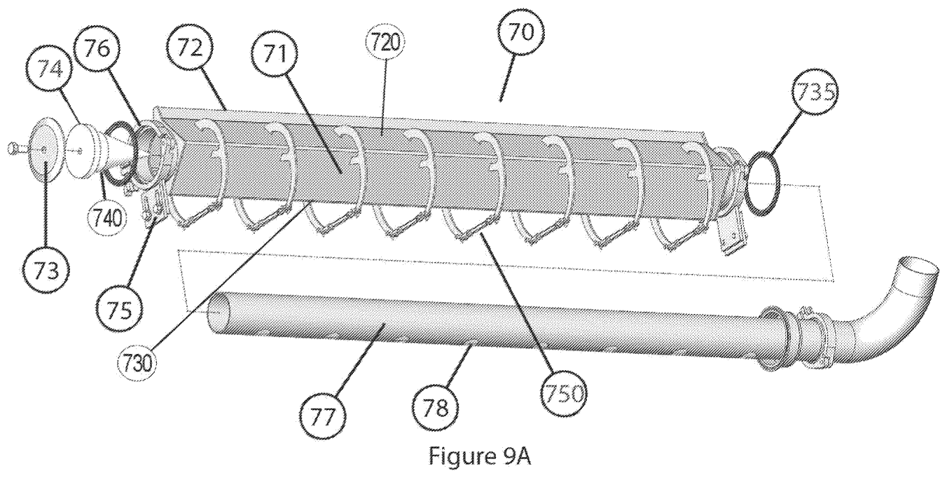

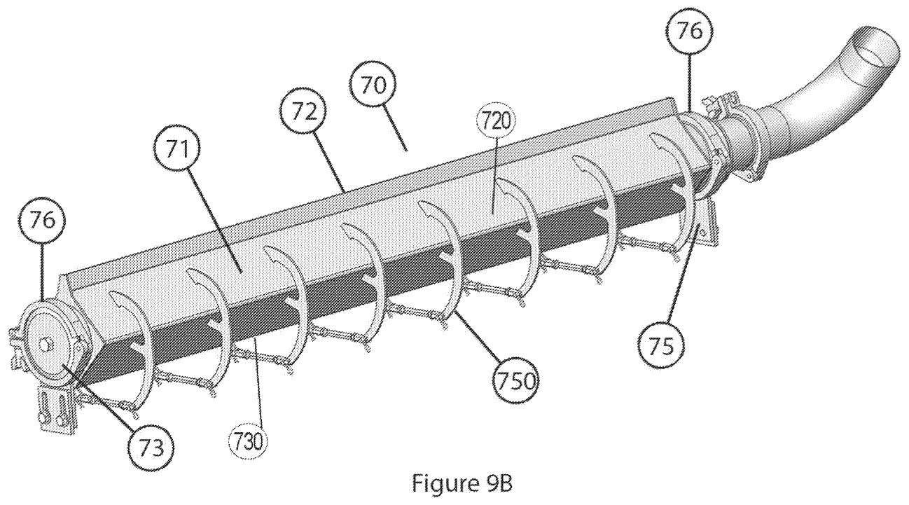

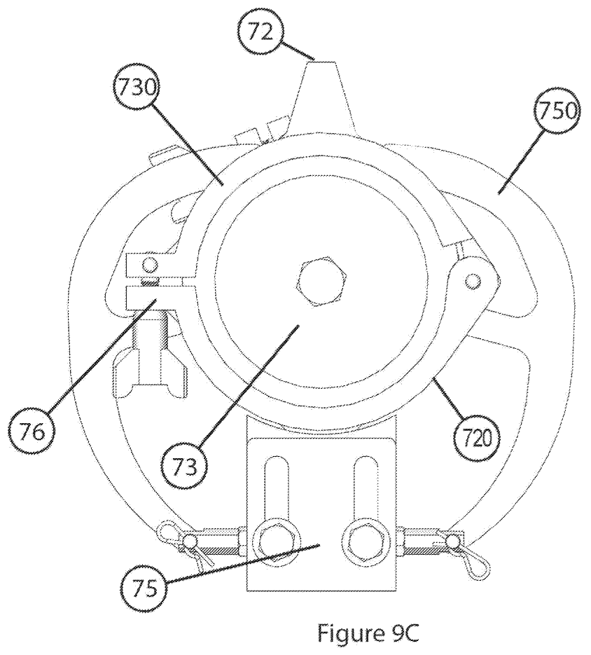

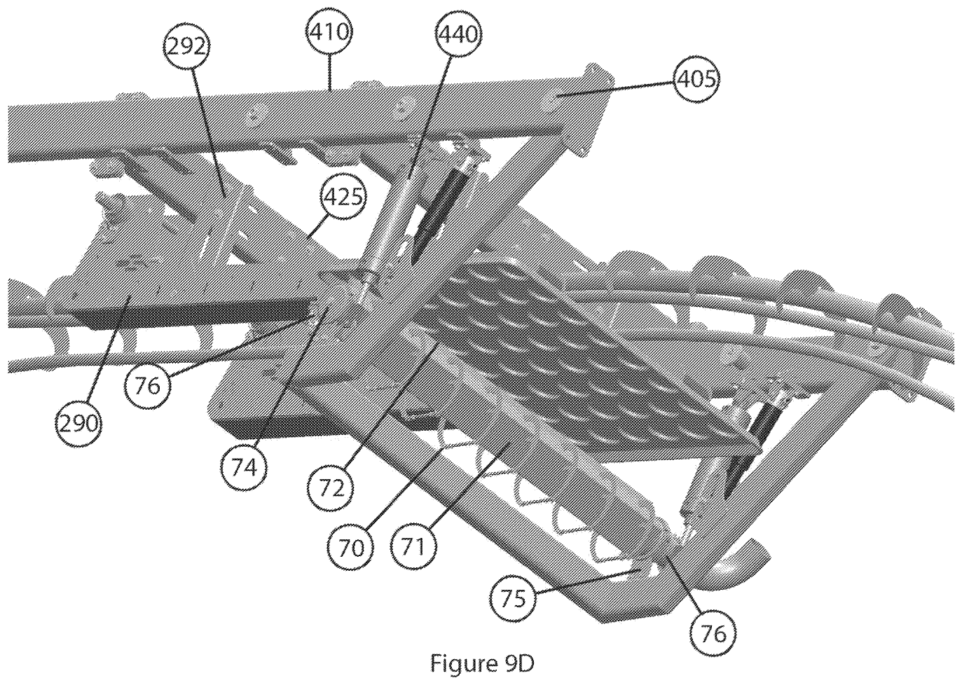

FIGS. 9A and 9B show an exemplary embodiment of an airknife used in the cleaning system of FIG. 5A. The next cleaning station or subsystem in the exemplary embodiment is commercially known as an airknife which is a device that directs air in a linear stream. In this application the airknife will be directed so as to blow air onto the pan 100 and in a direction so as to drive debris back from the pans 100 line of travel. The pans 100 are moving against the blown air so that debris does not go forward onto previously blown on pans. Though airknives are commercially available, the exemplary embodiment of the instant invention includes a uniquely adjustable and accessible foodstuff production version that can be quickly disassembled and all surfaces can be cleaned and reassembled more rapidly than heretofore known commercial designs. Consistent cleaning is a requirement for food safe certifications and the disassembly in existing commercially available airknives cannot be completed as easily as with the exemplary embodiment shown.

The airknife assembly 70 comprises an outside housing 71 which has two protruding metal sections 730. 720 converging to a significantly pointed area referred to as the knife outlet 72. Both ends of the housing 71 have end flanges 73. At the one end of the outside housing an end cap 74 is mounted which contains an aligning support block 75. The end cap 74 is tapered along section 740 to guide the diffuser tube 77 when assembled. On the other end of the airknife 70 is mounted an end flange 73 and seals 735. The mating end flange 73 is mounted such that it has attached a diffuser tube 77 that distributes the air in a uniform fashion through holes 78 drilled into the diffuser tube 77. The diffuser tube locates to the end cap aligning support bracket 75 which has an initial taper that engages the open end of the diffuser tube 77 and allows it to run to the aligning support bracket 77 where the diffuser tube 77 provides support as well as seals off the end of the diffuser tube 77. The end caps 74 and the end flange 73 with diffuser tube 77 are both affixed in place and clamped in compression through the use of the perimeter clamps 76. The perimeter clamps 76 in this operation are affixed to the swing arm 450 so as to provide mounting of the airknife 70 as well as allow for rotational adjustment of the airknife assembly 70.

FIG. 9C shows an end view of the airknife with adjusting devices for opening and closing gap of the airknife opening. The exemplary embodiment of the airknife 70 includes a shape adjustability factor for the exemplary airknife of FIGS. 9A-9C. The shape adjustability factor making all of the surfaces of the airknife more easily adjustable and cleanable for a food safe design where all of the surfaces of the airknife are accessible for cleaning. Adjustment sections elements 750 are provided as a series of U-shaped adjustable constraints or turnbuckles each adjustable with an individual tightening element. Each of the adjustment section elements 750 working to narrow or widen sections of the air flow through the airknife outlet 72. Varying adjustment section elements 750 can be provided to constrict the housing sections 730,720

FIG. 9D shows the exit of clean pans from the airknife subsystem. The cleaning section frame 410 is shown mounting the secondary magnetic conveyor 290 with conveyor sections 295 and mounting bracket 292 coupled to a cross member 425 of the frame. The cleaned pan 101 passes on the magnetic support carriage 700 on the track members 170 supported on support member 180. The airknife 70 is shown with the outside housing 71, airknife outlet 72, end flanges 73, end cap 74, aligning support blocks 75, and adjustment elements 750. The perimeter clamps 76 are affixed to the swing arm 450 so as to provide mounting of the airknife 70 as well as allow for rotational adjustment of the airknife assembly 70 using the swing arm actuator 440.

FIG. 10 shows the exemplary embodiment of the cleaning system with a discharging station for clean pans. As shown the cleaned pans 101 discharge onto a take away conveyor 1010. The take away conveyor 1010 may be a straight conveyor or similar conveyance means or may be a manual station for restacking. In this instance, the clean pans 101 are moved from the discharge to be put into circulation as clean pans.

FIGS. 10A and 10B show a side view of a further improved exemplary discharging and sorting station for clean pans. In the exemplary embodiment of the FIG. 10A a still further improvement is shown. A first takeaway conveyor 1015 in this embodiment is provided on a hinge 1025 behind the pan discharge point 1020 where the pan separates from the magnetic support carriage 700. A machine vision sensor system 2000 is shown above the pan discharge point 1020. The machine vision sensor system 2000 is in communication with the controller 2500 of the machine. The machine vision sensor system 2000 is a system that visualizes and senses pans that are not suitable for use. This system can be, for instance, but is certainly not limited to, a system for visualizing the condition of the non-stick surface of the pan, the cleanliness of the pan, or both, as disclosed in applicants co-pending provisional patent 62/894,922 filed Sep. 2. 2019 for such a system. Alternatively, it can be a system for using cameras or similar visualization devices or sensors to determine whether the cleaned pans 101 are bent or damaged significantly. Regardless, the machine vision sensor system 2000 senses whether the clean pan 101 is to be sorted out of the normal clean pan 101 stream of circulation and reports this to the controller 2500 for the instant invention.

The machine vision system 2000 scans the clean pan 101 at the discharge point 1020. If the clean pan 101 is not to be diverted, the first discharge conveyor 1015 puts the pan on a further discharge conveyor 1050 as shown in FIG. 10A. If the clean pan 101 is determined to be in need of diversion by the machine vision system 2000, the controller instructs the first conveyor 1015 to pivot at the hinge 1025 and the clean pan 101 is directed down, as shown in 10B. This allows for a drop gate discharge into a cart or further conveyor (not shown), as best seen in FIG. 10B, for pans that need to be removed from the system.

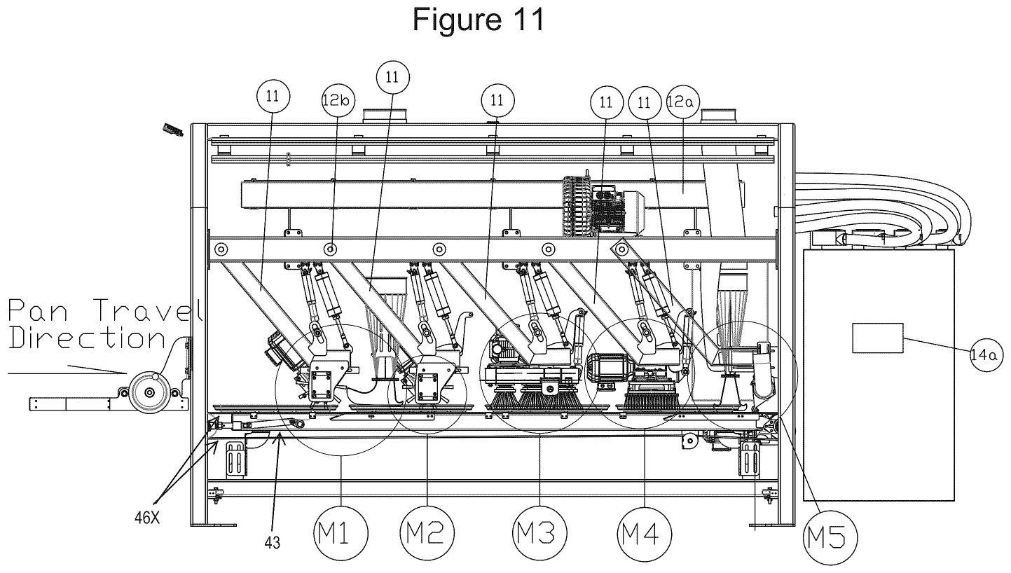

FIG. 11 shows a side view that illustrates the main structure of a further exemplary embodiment of the instant invention mounting modules one through five within the direction of pan feed. FIG. 11 illustrates a shorter embodiment of the invention with the main structure of the further exemplary embodiment of the instant invention mounting modules one through five within the direction of pan feed. FIG. 11 illustrates the main structure of an exemplary embodiment of the instant invention mounting modules one through five within the direction of the feed of pans. The figure shows the housing or frame member 12a with module hinge points 12b to engage the brushing sub-systems which are referred to herein as modules M1-M5 respectively for the non-limiting purpose of describing an exemplary embodiment of the invention having five modules. engaging the modules with the pans 3 as well as executing the various aspects of the cleaning steps of the pan cleaner 1 and control of the system.

In the exemplary embodiment shown, only modules one thru five M1-M5 are shown but it is understood that in further exemplary embodiments the machine can accommodate greater or fewer modules within the frame 12 without departing from the spirit of the invention. All modules are suspended from the frame member 12a as shown in FIG, 1 at hinge points 12b on swing arms 11 that can articulate or hinge upon or from and thereby move the modules in similar fashion. The hinge point 12b allows for the rotatable or hinging attachment of the module mount arms 11 and the ability to “float” in the space above the conveyor 430. Alternative or additional elements beyond the modules can also be added in further exemplary embodiments, these can include for instance machine sensing sub-systems, diverter conveyors and similar devices and aspects disclosed in applicants co-pending U.S. patent applications Ser. No. 17/010,260 directed to a pan visualization and scanning system and 17/009,566 and 17/009,203 directed to pan cleaning systems, as discussed herein and incorporated by reference.

In the process of cleaning pans 3, the pans 3 enter on the indicated entry side of the pan cleaning machine 1. There they encounter pan conveyor 430 having conveyor belts 46 which carry pans 3 and move along a conveyor frame 43X with support surfaces 44X, as further shown in FIGS. 32a-32d. This style of conveyor 430 accepts the pans as they are presented to the pan cleaner machine 1 and loads them on to the support surfaces 44X and thru the pan cleaner machine 1. The pans 3 do not need to be loaded and indexed onto carriers or to specific locations as in our other devices and applications. Thus, the exemplary embodiment shown operates on the pans 3 as presented in whatever random sequence and will accept the pans 3 and convey them to the entrance of the machine in a consistent manner. A consistent time delay is maintained for each pan 3 due to the time required to pass the pan 3 through the pan cleaner 1. This separation is provided by the speed of the conveyor belt 46X. which is greater than the product of the time required for a pan 3 to pass thru the pan cleaner 1 times the number of pans 3 presented to the cleaner 1 in a given amount of time. e.g., rate of flow of the pans. For example, if the pan length is three feet times thirty pans per minute. then the conveyor belt speed must be greater than ninety feet per minute, such that they will arrive at specific locations or modules for cleaning at specific times etc.

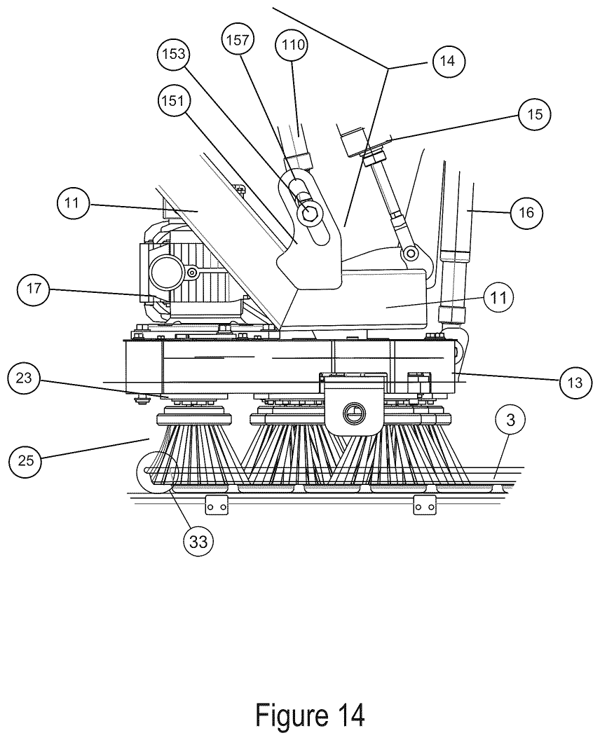

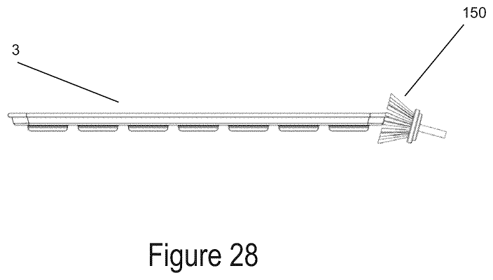

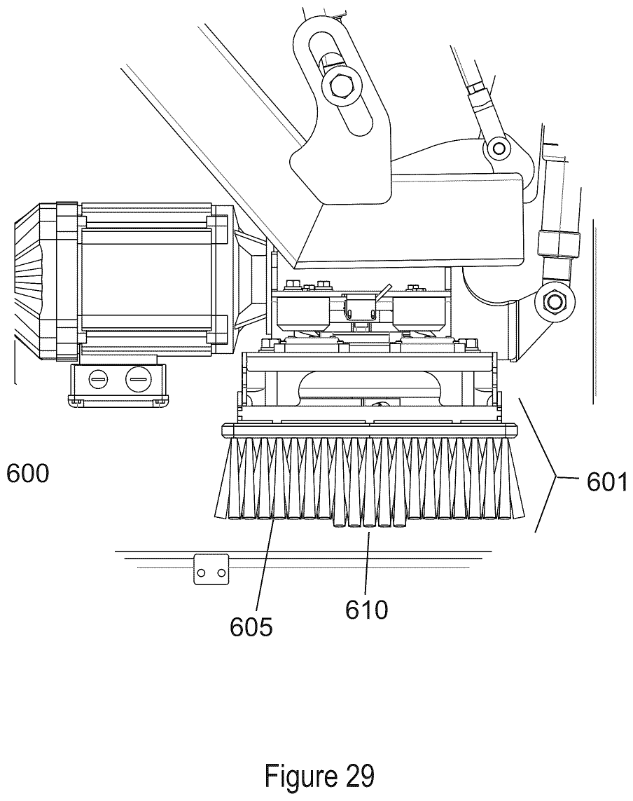

As the conveyor belts 46 move along the conveyor belt frame 43X and supports 44X they are guided by pan conveyor belt guides 45 to ensure that the conveyor belts 46 stay aligned on the conveyor frame supports 44X and do not move laterally. The pan or bun pan 3, but are certainly not limited to. engaged by a second stage of cleaning which is provided in the exemplary embodiment shown at module three, as more clearly shown and described in relation to FIGS. 14-26c, which is the rotary brush unit where vertical spindles 21 have improved rotary brushes 25 attached that will clean the top surface of the pan 3 as well as the inside pan perimeter 6 and outside pan perimeter 7 surface of the pan 3. A final cleaning follows at modules four and five (M4, M5), which are further shown in FIGS. 28-29, providing an orbital brush engaging the pan and a second vacuum hood 41, before passing the pan to the exit side of the pan cleaning machine 1.

As noted, swing arms 11 can pivot on swing arm pivot or hinge point 12b to move the cleaning mechanism or module towards or away from the pans 3 moving through the pan cleaning machine 1. In the exemplary embodiment shown the support structure of the frame 12 is designed so that the rotating brushes are lowered and engaged with the surface of the pans 3 from above the pan top surfaces 4. The mounting arms 11 are articulated by a movement actuator system 14 controlled by the controller 14A. Though the swing arms 11 generally raise and lower the modules M1-M5 in a fashion to maintain a parallel facing of the module and the pan, this is not a limitation of the system and co-pending U.S. application Ser. No. 17/009,566 describes a version whereby the conveyor and the modules are rotated relative to the horizontal of the frame.

The movement actuator system 14 has several components for each swing arm 11 and module. A movement stop actuator 15 sets or is moved electrically so as to give or provide a positive stop position to where the swing arm 11 can be lowered a minimum declination or lowered operating point. The swing arms 11, the conveyor 430, and the movement of the modules M1-M5 are controlled by a controller 14a which receives information from the modules M1-M5, the arms 11, sensors and the movement actuator system 14. There are components that are used in the raising and lowering of the elements of the individual modules as well as in assigning and causing the module to stop in its required heights and communicating same to the controller. These components are common to all modules.

The movement of swing arms 11 can be controlled by an actuator 110, which can be for example but is certainly not limited to a pneumatic cylinder as shown or any other type of actuator that provides reciprocating motion, for example, mechanical screw actuators or hydraulic actuators. For bakery applications, if a seal breaks a benefit of pneumatic cylinder actuators is that it will mainly release air so the surrounding area will not be contaminated. However, with pneumatic cylinders it can be difficult to control the movement of swing arms 11 to intermediate positions, so stroke limit controller or movement stop actuator 15 is connected to machine frame 12 and to swing arm 11 through a pin traveling in a slot in guide plate 155, and stroke limit controller 15 is operable to limit the movement of swing arm 11 by stopping the movement of swing arm 11 when the pin 153 reaches the end of the slot 157 in guide plate 155. Stroke limit controller 15 can be for instance but is not limited to a linear indexing cylinder that can retract and extend to preset or adjustable values under electric control.

For example, when cleaning flat baking pans the stroke limit controller 15 is set in a position to allow the greatest movement towards the conveyor 470 and pans 3, and when deeper baking pans are being cleaned the stroke limit controller 15 is set in a position that keeps rotating brushes in the modules M1-M5 at the correct height above the pans so that the pans 3 can pass under the cleaning modules M1-M5 without becoming jammed and without exerting excess forces and bending brush bristles beyond their clastic limits. The slot 157 in guide plate 155 allows actuator 110 to move the modules towards and away from pans 1 to engage or disengage as described above, but when the pin 153 in the slot 157 of guide plate 155 reaches the end of the slot 157, movement is stopped. As shown, for example, in FIG. 1 the support structure or frame 12 for the cleaning mechanisms have a swing arm 11 on each side and each swing arm 11 has respective actuator 110, stroke limit controller 15 and guide plate 155.

In some embodiments the swing arm assembly can be designed with some “play” so that the swing arm 11 is not held rigidly to the preset position but allowed to vary slightly. For example, springs or a pressure release valve from the actuator can be used to allow some movement from the preset position set by the actuator system 14 and limited by the limit controller 15 when a warped, bent or otherwise taller pan is fed to the pan cleaning machine 1. Once the taller pan has passed through the cleaning mechanism it can be automatically restored to its preset position by the actuator system 14 and the controller 14a. As noted, the stroke limit controller 15 can be for instance but is not limited to a linear indexing cylinder that can retract and extend to preset or adjustable values under electric control. It can also include an at least one sensor (not shown) to indicate the position of the swing arm 11. The at least one sensor (not shown) can be coupled to the controller 14a as described further herein below.

Thus. in the exemplary embodiment of FIG. 1, the controller 14a is used with and coupled to control the position of the arms 11 as described. The controller 14a allows for a set position for a relative lowest point and conversely highest point that the cleaning module can extend to is made available and programmed for the machine using the actuator system 14 and stroke limiter or stop actuator 15 described. The movement stop actuator or stroke limiter 15 reads or measures its relative position, provides output to the controller 14a. and controls the movement so as to provide the correct stop height. In this instance, the height adjustment system or movement actuator system 14 is shown as, but is certainly not limited to, an air cylinder system here shown as two air cylinders. The air cylinder is shown as actuator 110 and provides the movement to the actuator system 14 which uses it to extend and retract the module arm 11 to provide a variable degree of pressure on pans 3 by extending toward the conveyor 430. The stop limiter 15 extends the extension and retraction stop points and the actuator system 14 moves the swing arm 11 and thereby the modules M1-M5 within these limits.

The disclosed pan cleaning machine 1 in further exemplary embodiments can further comprise a plurality of sensors that collect information that the control system 14a can use to automate the operation of the pan cleaning machine 1. Additional sensors can be included to detect pan and machine variables. These would include the sensors in or output from the stroke limit controller 15. The machine can also comprise sensors for detecting the type of pan that is being cleaned and the type of debris that is on the pan. If the pan is a flat baking sheet, for instance, that does not have anything that is strongly adhered to it, the machine control system can, for example, activate only one cleaning module. such as a rotating brush assembly, and automatically take other cleaning mechanisms out of service by activating actuators on respective swing arm support frames to pivot unnecessary cleaning mechanisms away from the cleaning line. There can be different cleaning requirements for different pans. The advantage of this capability is that the cleaning mechanisms not required for some pans can be removed from service, saving brushes and unnecessary wear on components and reducing power consumption.

The machine can also comprise sensors for detecting the height of the pans in the cleaning section. Since some pans are flat and some pans can have raised perimeters and/or recessed molds, not all pans have the same depth. In addition, there can be variations in depth because some pans can become warped or bent. Similarly, pans can vary by width as well. By detecting the height of the pans, the controller 14a can adjust the distance of the cleaning modules M1-M5 from the pans 3 so that a specifically desired vertical height spacing is achieved between the pan and the cleaning mechanism. This aids in applying the proper pressure to clean the pan and assists in avoiding jamming the machine or applying too much or too little pressure on the brush bristles for cleaning. Sensors can also detect the style of pan so that the controller 14a can enable pre-programmed cleaning routines. For example, if the pan has recessed pockets, a brush plate unit can be controlled by the controller 14a to have orbital movements instead of reciprocating back and forth in a linear fashion.

Many types of sensors are known for sensing displacement and measuring components or products and the type of sensor chosen can be influenced by the application. For example, in a bakery application, where there can be a lot of dust or debris in the cleaning section, instead of an optical sensor, other types of sensors, such as magnetic or mechanical or strain-type sensors can be selected for measuring variables such as pan height, pressure on the cleaning mechanism, or weight. Alternatively, the pans 3 can be coded and the pan cleaning machine 1 can be equipped with a code reader (not shown) to determine what type of pan 3 is being cleaned so that an appropriate pre-programmed cleaning routine can be performed for that type of pan 3. The various exemplary embodiments of the pan cleaning machine of the instant invention can be fitted with sensors to perform the recited functions for the stated variables. The controller 14a can then receive the necessary information regarding the pans 3 and operating variables and execute the cleaning procedure appropriate for that pan via the logic stored in the controller or programmed via the input from a user interface (not shown). The cleaning program selected for or by the controller 14a can control, for example, which cleaning modules are activated, the distance between the cleaning modules and the pans, and the settings for the cleaning modules such as the pattern of motion and speed of motion for brushes and where the compressed air is focused and how powerful the blowing action for air knives and similar operating variables, and similar process properties.

The controller 14a of the exemplary embodiment can thus make adjustments that provide adequate downward force based on cleaning parameters and other variables. In optimizing or programming the system controller 14a, these pressures or downward forces can be dialed in or programmed so as to push down on the brushes in the module so that they can clean the pan but not so hard that the force will tend to bend or deform the bristles and instead, gently brush a surface. Or they can be applied harder to provide a different resulting cleaning actions at the pan 3. The pressure being determined by the selected cleaning parameters and programmed into the controller 14a. The goal is to provide sufficient cleaning to address concerns of removing contaminants without inherently increasing wear on the non-stick coating on the pan. Too much force often results in reduced pan life as the non-stick coating is worn by the brushes. Additionally, it is often counter intuitive, but if more aggressive cleaning and/or blowing is used it can result in blow over contamination in the pans 3 that may not have resulted from the baking process but instead from being dislodged during the aggressive cleaning. Thus, it is often times the case that a less aggressive cleaning mode is best used based on the aforementioned selectable cleaning parameters.

Thus, the exemplary embodiment of the pan cleaning system of the instant invention can adjust processing based on a desired level of cleaning, pan width, pan type, and pan shape as non-limiting examples of the improved control system. Some non-limiting examples of levels of cleaning that can be programmed can include, but are certainly not limited to, light cleaning for minimum pressure to brush the pans, medium cleaning with pockets, deep cleaning and the like and/or pass-through mode. Thus, the instant invention, in a non-limiting, exemplary embodiment, includes but is not limited to a system that provides the ability to “float” the modules and optimize the brushing to be an appropriate cleaning force to reduce wear on pans or a more aggressive brushing if heavily fouled pans or actively pass the pans without brushing if not requiring cleaning or any level in between. The pan cleaning machine 1 and controller 14a can also allow for each module to be activated or deactivated as well as raised and/or lowered to suit the needs of cleaning the pan surfaces as required. Each module can be effectively “deactivated” at any time by being raised to allow pass thru of pans that do not require cleaning by that module. Alternatively, as noted herein, a “pass through” option allows the pans to pass without cleaning. for example in instances where the pans being processed were not sprayed or topped or for a defective pan as enumerated in an alternate exemplary embodiment herein below.

These settings can be for instance, but are certainly not limited to being, programmed and stored in the controller 14a. The controller 14a can be programmed so that these parameters can be set into recipes and when the recipes are entered the movement stop actuator 15 which will move to the required location so that the mount arm 11 will only go to that point and not lower for the desired setting or recipe and force. Again, the distance and pressure applied at the pan 3 is settable a determined by engagement parameters and/or cleaning parameters programmed and read by controller 14a, these can include many parameters, a non-limiting example in the exemplary embodiment being a lowest pan position and adjustment. The engagement parameters are defined as the machine executable translation of the cleaning parameters.

Additionally, in further exemplary embodiment as an alternate implementation, the pan cleaning machine 1 can be coupled to a pan sensing system, like that disclosed in applicants co-pending U.S. Provisional Application 62/894,922, filed Sep. 2, 2019, directed to a Pan Coating Visualization Enhancement Material. Apparatus and Method incorporated herein by reference. The sensing system (not shown) can analyze the pan for anomalies indicating contaminant or foreign materials and adjust the selected setting accordingly, e.g., light for identified seeds or heavy for glaze in pan pockets. Similarly, in conjunction with a sorting conveyor, as seen in applicants co-pending U.S. Provisional Applications 62/894,923 and 62/894,915 filed on Sep. 2, 2019, which is also incorporated herein by reference, a pan which has been deemed unserviceable due to wear on its non-stick coating can simply be passed through to the sorting conveyor and removed from service.

In addition to the variable types of cleaning available with the novel arm mount system and controller system, these systems also allow for quicker, easier error correction, e.g., unjamming, when the pans 3 are not properly aligned. Typically, in the prior art, when the conveyor 470 moves the pan under fixed brush systems or systems that do not lift and then engage there is a possibility of a jam. The pans 3 can overlap or stack on the conveyor, referred to as “shingling” in the art. This overlap gets caught under a fixed height system and a wedging force is applied to the incoming pans being conveyed by the conveyor which is moving at high speed such that the line must be stopped to fix the jam-often with a crowbar. The instant invention overcomes this issue.

In the instant invention, as shown in FIGS. 14 and 20-21, when the lip of the bun pan 3 comes in, the cleaning head or module can float over the bun pan perimeter top surface 4 then come down to clean the lower main surface of the pan 4. It provides a “float” over aspect where if pans have been pushed together or have partially or fully shingled over top of one another the shingled pans will go into the pan cleaner 1 and the head will float over them. The cleaning brush heads will not jam and the pans will not wedge into the pan cleaner brushes but rather the module will just float over the top of the pans. This is because unlike conventional prior art pan cleaners which are raised and lowered on threaded rods or as may be described as positive positioning means, the instant invention instead utilizes a floating arm which has a setting for the module as a lowest position stop and then provides a targeted downward force on the module so as to clean the pan upper surface. If the pressure rises, it rises. Similarly, if there is a jam for other reasons, the system can easily rectify it by raising the arms to a much higher point which provides a much quicker ability to clear for instance a misaligned pan, e.g. crooked or cockeyed, that can be misfed on the conveyor.

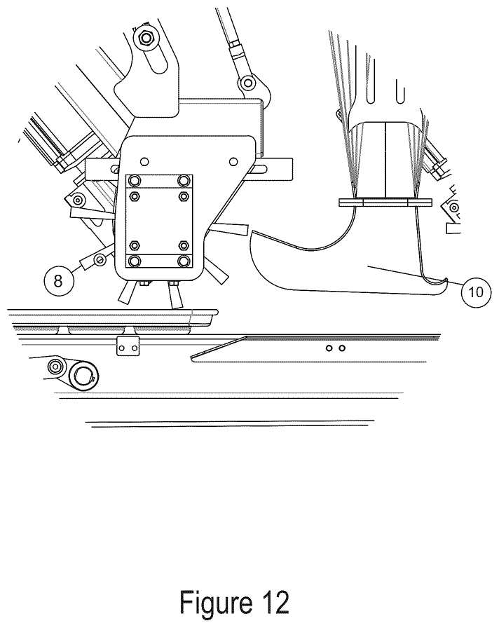

Thus, in relation to the overall exemplary embodiment of the pan cleaning machine 1 shown in FIG. 11, there are significant advances providing for improved operations, maintenance and efficiency in the instant invention. Each of the modules discussed herein can also be quickly mounted or demounted on swing mount arms 11 and the swing mount arms 11 elevation and active contact with the pans 3 can be controlled by a controller 14a which can raise and lower the module for height or applied cleaning force to the pan 3 and or raises or lowers modules to engage and or disengage the selected module. As mentioned, the exemplary embodiment shows five modules, a greater or lesser number of modules can be implemented by mounting on available module mount swing arms 11. Additional module mount swing arms 11 can be incorporated in extended pan cleaning machine frame members 12a to suit, providing flexibility and expandability in the pan cleaning machine 1. Turning now to the description of the first module or cleaning subsystem as shown in FIG. 12 of the exemplary embodiment which initially removes adhered product.

FIG. 12 shows a side view of module one of the exemplary embodiment of FIG. 11. Module one (M1) is a cleaning brush which is also shown in Applicant's co-pending U.S. application Ser. No. 17/009,566 and previous U.S. Provisional Application 62/894,915 filed on Sep. 2, 2019, and whose description is incorporated herein by reference. The principal task of module one (M1) in the pan cleaning machine 1 is to give the pan 3 an initial sweep from a counter clockwise rotating cylindrical brush 8 and dislodge any remaining product such as but not confined to buns 2 or partial remnants of buns that may not have been completely removed or are still adhered within the pan pocket 5 upon entry into the pan cleaner 1.

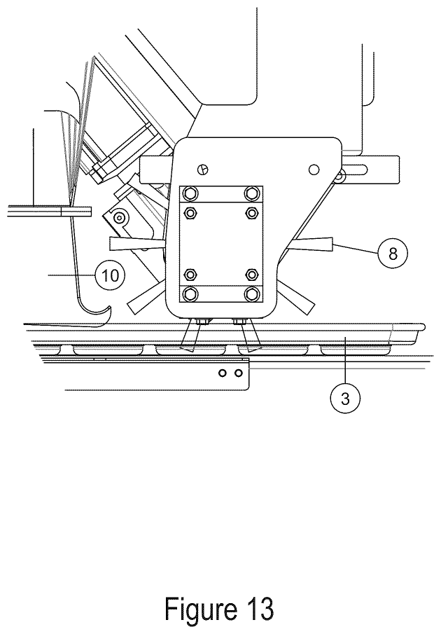

FIG. 13 shows a side view of module two of the exemplary embodiment of FIG. 11. Module two (M2) as shown is a combination of a reverse or mirror image of module one (M1) shown in FIG. 12 which includes an oppositely rotating cylindrical brush 8 to that shown in FIG. 12. in this case clockwise, which again aids in the task of taking off or removing buns 2 that may be adhering to bun pans 3. Module two (M2) includes a first vacuum hood 10. The first vacuum hood 10 is coupled to a vacuum source and can collect the removed residual buns 2 or partial remnants that are dislodged from the pans 3 from the actions of modules one and two. It should also be noted that the cylindrical brushes 8 of module two (M2) are typically rotating in a clockwise fashion to direct or motivate the residuals to the first vacuum head 10 for vacuum removal. Thus, as seen in FIGS. 12-13 these modules will remove and motivate the adhering and or residual materials or buns into the vacuum heads and away from the pan cleaning machine 1.

FIG. 14 shows a side view of module three of the exemplary embodiment of FIG. 11. Module three (M3) is an exemplary embodiment of a further cleaning brush head configuration which is improved over existing configurations and provides more optimal contact with all surfaces of the pans 3 and superior cleaning of both the main and side surfaces of the pans 3 in the instant invention. Module three (M3) utilizes a plurality of rotary brushes in a unique manner to provide improved contact of both the primary flat surface of the pan and the lip or perimeter surfaces, both inside and outside of the pans 3.

Initially it was observed that for a standard brush to strike the required surfaces it would not principally do what is required due to angle of brush bristle contact and ability of the brushes to contact all surfaces efficiently. The relative movement of the pan 3 into the brushes and the height changes at the perimeter or lip cause compression and contact issues as well. The third module (M3) and the corresponding brushes 80 are designed to address these issues. As the pan 3 passes to the third module (M3) the pan 3 approaches the rotary brushes 25 in the configuration shown and an initial deformation of the bristles occurs.

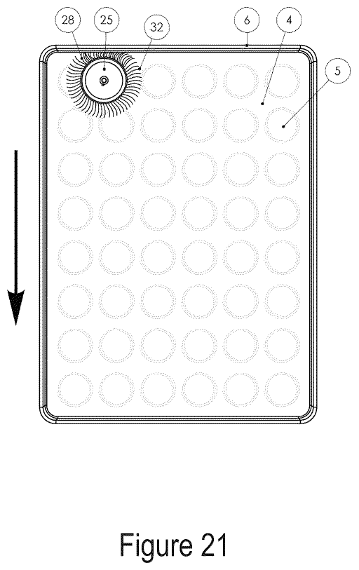

As seen in FIG. 14, as the pan 3 moves under the bristles 27, 28 as the lip of the pan 3 passes a compression of the bristles tends to reduce the effectiveness of the bristles due to the compression that occurs from the height of the lip at the inner perimeter 6 of pan 3, highlighted in the callout circle at 33 in FIG. 14. A further example of this can be more explicitly seen in FIG. 21 showing the effect on a single conventional brush head. This contact creates a reduction in efficiency at this contact point. To overcome this inefficiency the instant invention in module three (M3) provides a minimum overlap within the configuration of the brushes in module three and a more efficient brush head bristle configuration as described herein.

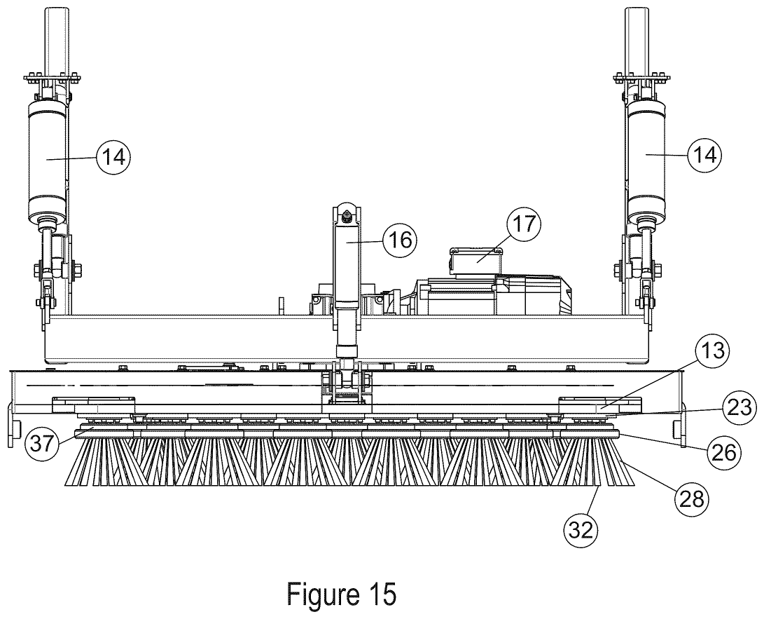

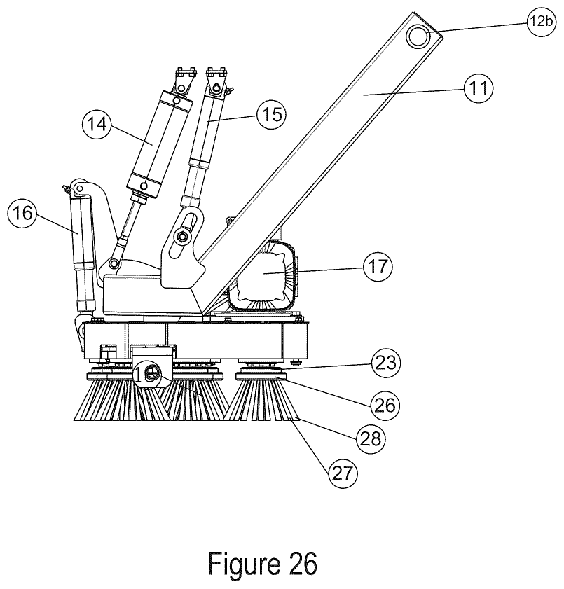

FIG. 15 shows a rear view of the exemplary embodiment of brush module three and FIG. 16 shows a side view of FIG. 15. FIG. 15 shows the rear view of the exemplary embodiment of the brush module showing the dense configuration of the plurality of brushes with overlap in the first and second rows of brushes. The exemplary embodiment of module three (M3) shown in FIGS. 5 and 6 comprises a main mount arm 11, which is coupled to a frame element 12a through a hinge point 12b as described above in relation to FIG. 11. As noted above, the controller 14a is used with and coupled to control the position of the arms 11 as described. The controller 14a allows for a set position for a relative lowest point and conversely highest point that the cleaning module can extend to is made available and programmed for the machine using the actuator system 14 and a stop limiter 15 as described. The pin 153 is shown traveling in the slot 157 in guide plate 155. The pin 153 is coupled to the stop limiter 15. The stop limiter 15 reads or measures its relative position, provides output to the controller 14a, and controls the swing arm 11 so as to provide the correct stop height. In this instance, the height adjustment system or movement actuator system 14 is shown as, but is certainly not limited to, an air cylinder system here shown as two air cylinders. The air cylinder is shown as actuator 110 and provides the movement actuator system 14 uses to extend and retract the module arm 11 to provide a variable degree of pressure on pans 3 by extending toward the conveyor 430. A further stop limiter or actuator is shown in the tilt leveling actuator 16, which permits the module to be tilted relative to the conveyor 430 surface and operates in a manner similar to that of the stop limiter 15 and is likewise a linear indexing cylinder in communication with the controller 14a and acting as or having sensors therein.

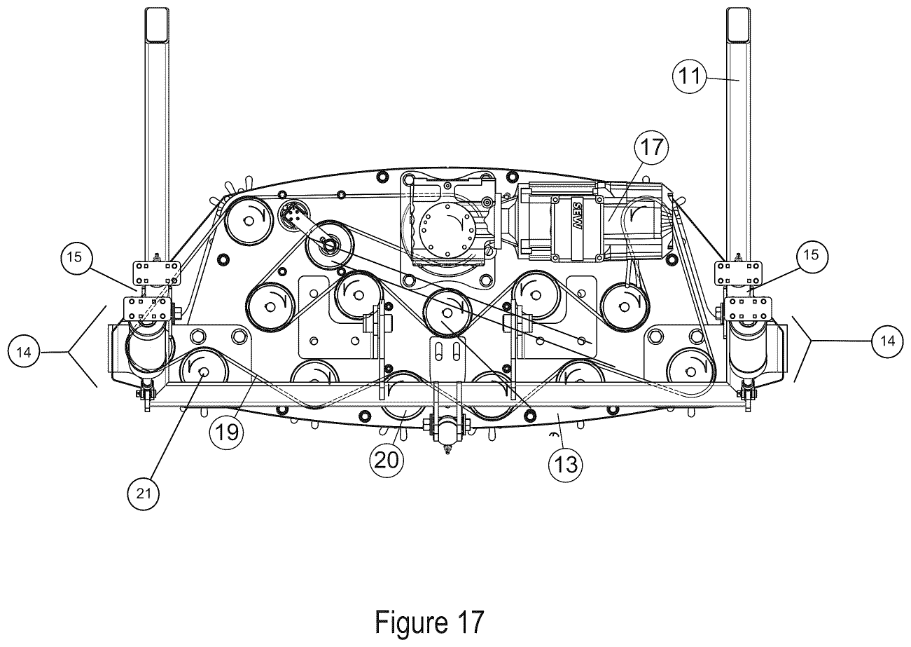

A drive device 17. which is shown as but is not limited to a combination electric motor and gear reducer, is mounted on a module plate 13 and drives the brushes of the module. This is done through a drive transmission system as best described in relation to FIG. 17 below. The brush heads, as seen in FIG. 15, extend from the module mount plate 13 with the lower cartridge member 23 extending below the module support frame or plate 13, a brush mounting plate 37 for each brush is coupled thereto. And coupled to the mounting plate 37 is the brush body 26 which has brush bristles 27, 28 extending to the tips 32 therefrom. As can be seen in FIGS. 15, 17, 18 and 20, there is significant overlap in the rows and arrangement of the brushes. The overlap improves the cleaning efficiency and effectiveness as described in greater detail herein below with regards to FIGS. 17, 18, 20 and 21.

FIG. 17 shows a bottom view of module three of the exemplary embodiment of FIG. 11, showing the drive motor and power transmission unit. Though reference is made to the exemplary embodiment of the third module (M3) brush head assembly shown in FIGS. 14-26c which shows a set of brushes configured to overlap and angled in the arrangement in three rows, it would be understood by one of ordinary skill in the art that increased numbers of brush heads and rows can be added without departing from the spirit of the invention. The third module (M3) assembly provides for significant advantages based on its overlapping brush head configuration, taper, counter rotational forces, and bristle configuration on the brush heads themselves.

As seen in the top view, the drive device 17, which is shown as but is not limited to a combination electric motor and gear reducer, which is mounted on a module plate 13 and drives the brushes of the module. This is done through a drive transmission system or power transmission device 19, shown in the exemplary embodiment as but certainly not limited to a power transmission driver or drive pulley 18, timing belt or transmission device 19, and brush pulley system 20. The motor 17 transmits power and the transmission converts the power to a driving rotational movement via power transmission driver or drive pulley 18 which turns the power transmission device 19, shown here as the timing belt. The timing belt 19 is coupled to transmission pulley 20 on each shaft 21. The transmission pulley 20 on shaft 21 extends above the module mounting plate 13 from the upper cartridge 22 as shown. The brush shaft is put into rotational motion by the transmission pulley 20 into the rotary brush 25 that is attached to the distal end or bottom of the shaft 21.

The rotary brushes 25 operate while being supported on the mount plate 13 which spans the pan conveyor 430. The mount plate 13 also allows for and provides a mounting means for the vertical brush shafts 21, pulleys 20, transmission system and drive device 17. The vertical brush shafts 21 are contained within the upper cartridge 22 and lower cartridge 23 where they are rotatably supported and extend upward or downward respectively. The pulley 20 engages the top input section of the brush shaft 21. The brush shafts 21 are put in rotation thru the driving action of the power transmission system but are driven in the exemplary embodiment shown in alternating and opposite rotations. That is, the brushes are counter rotating as to the brushes immediately next to the brushes in the layout of the exemplary embodiment of FIG. 17 as shown by the rotational notating arrows.

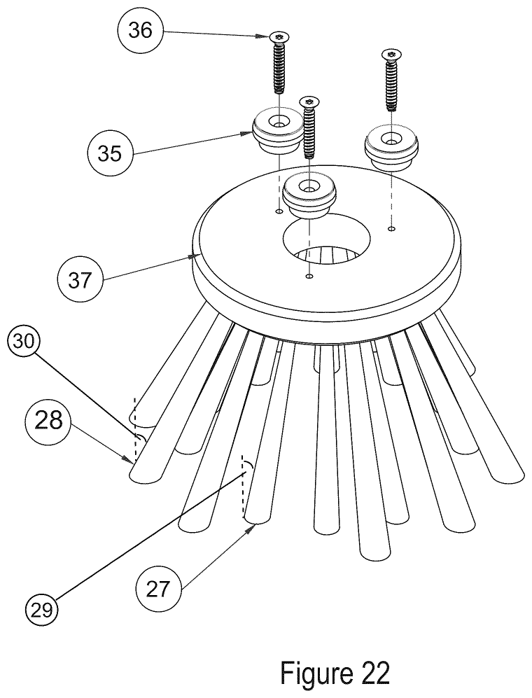

Again, as seen in FIG. 17 by the directional arrows, the brush shafts 21 are put in rotation thru the driving action of a power transmission system but are driven in the exemplary embodiment shown in alternating and opposite rotations. This enhancement provides multiple advantages. First the overlap improves cleaning, as discussed herein. Further, this layout provides counter rotational momentum within the assembly. In an alternate exemplary embodiment, the shafts and thereby the brush heads can be configured in equal pairs to the left and right of the center of the module and the equal pairs can be similarly spun in opposed directions. The counter rotation of the brush heads needs be equal and opposite relative to the center of the module to achieve the needed counter rotational balance. Additionally, each brush 25 is specifically configured in its brush layout on the rotary brush module with each rotary brush 25 detachably coupled to the brush shaft 21 through the brush mounting plate 37 via a tool less installation, as described further herein with respect to FIGS. 22-26c below, which further contributes to the improved performance of the brush head assembly as the third module (M3).

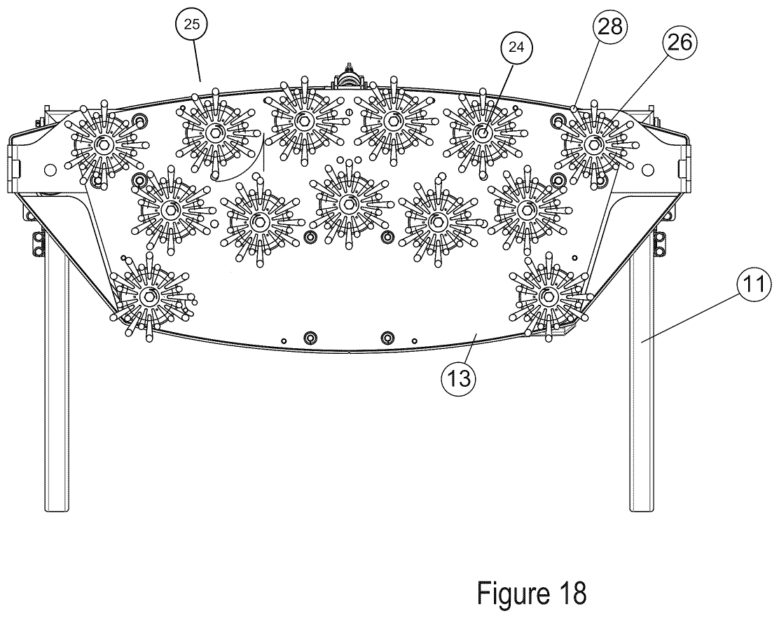

FIG. 18 shows a bottom view of the exemplary embodiment of brush module three shown in FIG. 17. Again, module mounting plate 13 is shown with the rotary brush heads 25 coupled to and driven by shafts 21 which extend from the lower cartridge 23. Arrows show the corresponding counter rotational drive of each rotary brush 25. The cartridge fasteners 24 are shown coupling the rotary brushes 25 to the shafts 21, as further seen in FIG. 14 below. The outer and inner brush head bristles 27, 28 are shown in the configuration discussed herein below in relation to FIGS. 22-26c. The overlap configuration is further shown here. as evidenced by the arc showing a portion of the permitter of rotation of a rotary brush 25 in one row relative to the on-center location of shaft 21 of the rotary brush 25 in the following row.

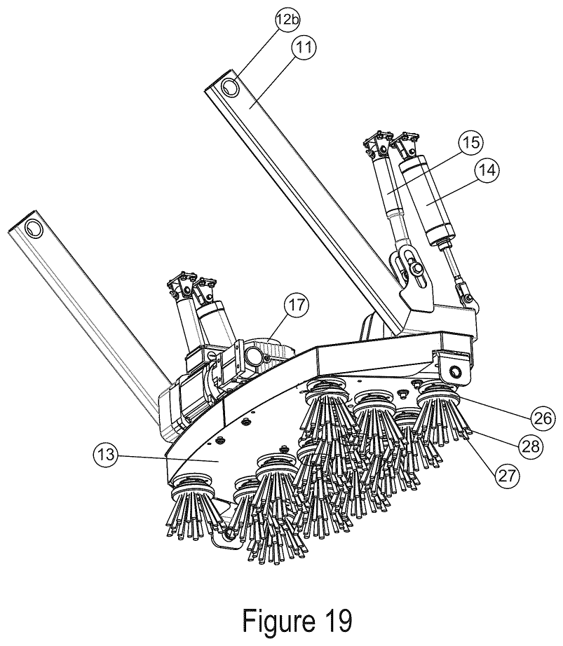

FIG. 19 shows an isometric front view of the exemplary embodiment of brush module three shown in FIG. 17. Swing mount arms 11 are shown with pivot points 12b. which couple the third module (M3) to the conveyor frame 43 and frame element 12a. as discussed herein in relation to FIG. 11 above. Limiter 15 and actuator system 14 are shown. The additional leveler clement the tilt leveling actuator 16 is shown, this allows the module the ability to tilt and is similar in function to the limit actuator 15 as discussed above but with respect to tilting the module. It similarly reports information to and is controlled by the controller 14a. The module drive 17 is show on mounting plate or deck 13 with rotary brushes 25 extending therefrom. The rotary brushes 25 having a brush plate 26 with outer and inner bristles 27,28, thereon.

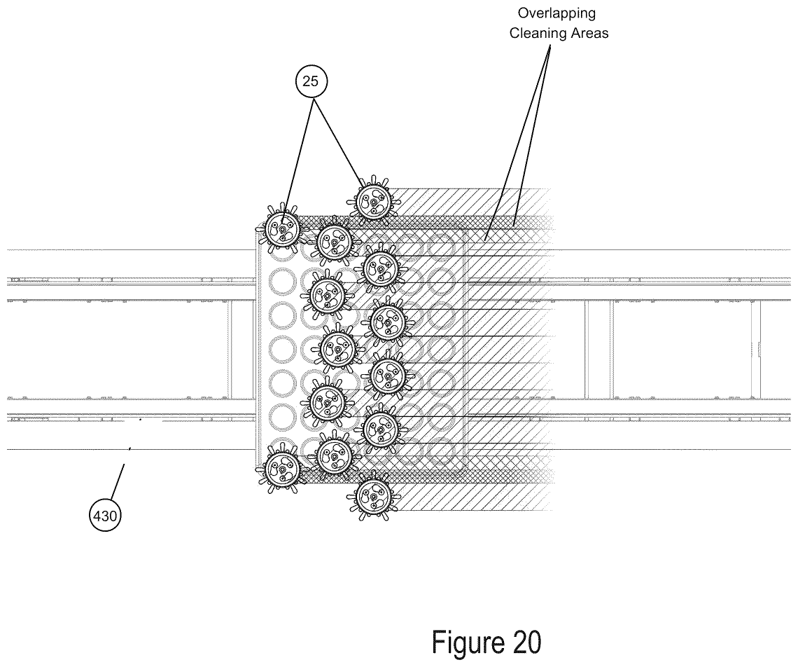

FIG. 20 shows a top-down view of the embodiment of the brush assembly of module 3 shown in FIG. 16 with grey hatching representing the areas of coverage for the brush heads as the tray passes underneath. The path of each brush is shown such that the area of coverage and redundancy in the spacing is evident. A first improved aspect in the brush head assembly of module three (M3) is overlap coverage shown in FIG. 20. As best seen in relation to FIGS. 18-20, there is overlap of width for all the brush heads in the configuration of the third module (M3) such that the area cleaned by each brush overlaps the effective cleaning area in compression for the brush, e.g., the minimum effective area of the brush in cleaning. So that the compression on both the inside and outside surfaces of the lip of the pan, where the efficiency of the brush is reduced to only a portion of the bristles due to these compressive forces reducing the contact area, is covered by the overlap of the next additional brush. Another aspect of module three (M3) is to ensure the correct path of the inner brush bristle 27 and outer brush bristle 28 and have the brushes 25 spaced out to provide overlap as well as agitation at the locations needed to do its cleaning operation. That is the spacing of the inner and outer bristles 27, 28 on the brush plate 26 is configured to work in conjunction with the overlap and the deflection that occurs on the pan.

As an example, when the brushes 25 are cleaning the top surface 4 of the pan 3 and approach the leading and/or trailing pan perimeter inside surfaces 6, the rotating brushes 25 are approaching the leading and trailing areas of the inner pan perimeter 6 or outer pan perimeter 7. The brush head and bristles are most efficient when the path of brush bristle tips 32 can sweep across the pan surfaces 4,5,6 rather than be compressed as when it contacts the inner pan perimeter surface 6 and it is on such an angle that the bristle will bend back to a point. During this compression, the brush bristles effectively stop brushing with the bristle tips 32 and instead tend to wipe across the surface and performs a less effective brushing action.

This typically occurs when the brush 25 starts to go over and enter/exit the approaching or leading edge of inner perimeter 6 which is typically an inclined or rounded edge within the pan 3 going around the entirety of the inner perimeter 6 as shown. Similarly, a compression occurs at the trailing edge of inner pan perimeter 6 of the bun pan 3 or as the brushes go along the side edges of the pan along the inside perimeter 6. In these cases where the brush is approaching the inner part of the edges of the inner perimeter the bristle tips 32 will contact and brush the inner pan perimeter surface 6 and at first the line of contact between the brush bristle tips 32 and the inner pan perimeter edge 6 may be from 11 o'clock to 1 o'clock. the beginning of the aforementioned compression. As the pan 3 continues to approach the rotary brush 25 the contact width of bristle tips 32 that will contact the pan inner perimeter surface 6 will increase to a wider amount up till the time when the center line of the brush rotating shaft 21 is at or very close to the peak of the upper edge of pan 3 at which point the contact width will be approaching the full width of the brush 25 less any bending curvature of the bristle.

Once the contact angle goes beyond the sweep angle of between about 10 till about 2 o'clock of on the rotary brush 25 the brushing and or cleaning effect of the brush inner bristles 27 and brush outer bristles 28 in motion will be reduced as the bristles will tend to bend backwards and go from a brushing effect to a wiping action where the wiping has far lower ability to dislodge debris and adhering materials as previously stated. An improved configuration of the brush heads is needed so that through the overlap of the brush heads, there is at any given time along the permitter properly oriented bristles on the single pass of the pan. An example of this compression issue can be best seen in FIG. 21.

FIG. 21 shows compression of the bristles of a single brush head due to the height of the lip of the pan. A single brush head 25 is shown with the outer brush bristles 28 extending and being deflected by the pan 3 during operation of module three (M3). The pan 3 is traveling in the direction of the arrow noted. The brush head 25 is engaging the inner permitter 6 of the pan 3 at its “lip” and the outer bristles 28 and the respective tips 32 are shown. The deflection of bristles in this fashion is one of the issues faced in maximizing the cleaning efficiency of brush head assembly of module three (M3). Though brush module and cleaning machines exist that attempt to clean pans, the prior art devices had numerous significant shortfalls. A principal shortfall has to do with the aforementioned compression of the bristles as they are passed over the pans. The instant invention addresses this with the brush head configuration and brush heads which provide overlap and the indicated bristle orientations that address many of these shortfalls.

To provide enhanced cleaning action on the improved brush head assembly of the instant invention the instant invention uses sufficient numbers of brushes in an overlapping configuration so that there is overlap of the areas where effective cleaning can be provided throughout the travel of pan 3. In the exemplary embodiment shown, as a non-limiting example, the brush heads have a staggered overlap with about two hundred percent coverage where the shaft centers in the path of pan travel would be at 3.5 inch centers or one-half of the center to center distance of the brush shafts 21 offset in counter rotation and rows as noted above. In terms of angles and swept area the sweeping angle of between about 30 to 60 degrees and more specifically a sweep angle of 30 degrees off center in both directions to provides a total of 60 degrees of swept area in the non-limiting exemplary embodiment. The resulting lateral swept area with the on center configuration measurements would therefore be about one and three quarter inches to each side of the center line of the rotary brush 25 in the non-limiting exemplary embodiment. When combined in such a configuration, each rotary brush 25 has a swept width of three and a half inches and the adjacent brushes would have the same area to generate the full width of optimal cleaning/brushing area and this is where the brush bristle tips 32 are contacting the approaching leading/trailing inner pan perimeter surface 6 edges. This is staggered from the next row such that the overlap covers the previous area with two additional brush heads passing off set from and passing across the same area as the row directly ahead of the following row relative to the direction of travel of the rotary brushes 25 over the pan 3 as seen in FIG. 20.

In addition. the spacing of the bristles in the brush head 25 itself of the instant invention is such that it reduces this inefficiency as that brush head is passed into contact with the lip and deflection occurs. This is due in part to the spacing and angle of the bristles, as more clearly shown in relation to FIGS. 22-26c. With a brush where the outer brush bristles 28 and inner brush bristle 29 emanate out from the brush body 26 which holds the brush bristles at non-sequential or “uneven” angles relative to one another. The angles 29, 30, respectively, that the inner brush bristles 27 and the outer brush bristles 28 are affixed to the brush body 26 can vary so that they are suited or are able to brush against the sides of the pan perimeter both inside and outside pan perimeter surface 33 and outside pan perimeter surfaces 34.

Thus, referring again to FIGS. 20 and 21, the brush bristles in the exemplary embodiment shown will flair outwards as in a skirt fashion as one views the bristles from top to bottom. Where outer brush bristle 28 with tips 32 are in contact with the inner perimeter pan sides 6 at an angle of between about 15 to 45 degrees where about typically a 25 degree angle is presented. The inner bristles 27 can be flared or in a skirt manner also at angles of between about 15 to 45 degrees but are about typically 30 degrees. This cleaning operation requires that the bristles 27, 28 also are able to go into corners where converging surfaces meet such as but not limited to where the inside pan perimeter surface 6 and the top of the pan top surface 4 converge.

It was also realized that the entire leading and trailing sides of the inner perimeter 6, as opposed to side perimeter edges which were previously discussed, of the bun pan 3 would need to be brushed and that the rotary brushes 25 used would clean in the most optimal way when the inner brush bristles 27 and outer brush bristles 28 contact the inner bun pan perimeter surface 6 at an inner brush bristle angle 29 and outer brush bristle angle 30 that allowed the inner brush bristle 27 and outer brush bristle 28 to brush the inside pan perimeter surface 6 with the tip of the brush bristle 32 rather than have the inner brush bristle 27 and outer brush bristle 28 bend and then all brush bristles behind it would also bend and lay on each other so that in effect they would only be wiping or glance stroking the inclined inside edge of the inside perimeter surface 6 of pan 3.

To address this the inside brush bristles 27 and outside brush bristles 28 are a combination that are offset in their rotational path so as to not be able to have leading brush bristles lay back on top of one another in a layer. Additionally, to prevent or reduce the layering effect the instant invention provides brush bristle gaps 31 in between clusters of brush bristles and to have a more open disbursement of brush bristles within the brush plate 26 and to avoid having them laying over and having them layer to where the other following brush bristles layer onto earlier brush bristles. The design of the brush can be best seen in FIG. 22-26c.

In the central area of the bun pan 3 the brushes 25 are rotating freely and are not subjected to the same high bending forces as compared to the leading and trailing edges of the pan. In the central area of the bun pan 4 the brush 25 is not contacting pan perimeter inside surfaces 6 edges so that the brush bristle tips 32 can freely rotate and just be in contact with the pan top surface 4. So, for that operation the brush bristle tips 32 would be operating or cleaning for the entire diameter or face width of the brush 25 in which case when the brushes 25 are located at 3.5 inch centers the pan will have 200 percent cleaning coverage to the pan surface. It can also be understood that bristles of other and or combinations of angles in a single brush could be used without departing from the spirit of the invention.

The brushes 25 would also be brushing the top pan surface 4 and if too much brushing action was taking place there then it may compromise the lifespan of the release coating used on the pan 3. The instant invention utilizes an optimization calculation of brush heads in the configuration sufficient to clean the pan perimeter inside edges in very little time. To do this, more brushes are employed to get the job done. In the center of the pan the brushes 25 have more effective working area and efficiency as the pan brushes 25 can use the entire path circle area as its proper cleaning area. As an example, when the back/trailing pan perimeter inner surface 6 approaches the brushes the brush will do an effective job of cleaning when the brushes 25 begin to engage the pan perimeter inner surface 6. This way the brush bristle tips 32 strike and sweep against the pan perimeter inside surface 6 but as the pan continues to approach the inside perimeter surface 6. Even when the pan 3 travels further and the lip is more deeply engaged at the pan perimeter inside surface 6 even though the brush bristles will start to bend and lean back to where the sweeping effect of the bristle tips 32 reduces and the wiping effect of the brush bristles increases the following row of brushes will begin engagement with the inside perimeter surface 6. This aids in ensuring sufficient cleaning of all surfaces of the pan 3.

Even with the enhanced bristle layout, the cleaning of the inside perimeter 6 of the pan 3 the brush 25 layout can have other complicating factors where the brushes are not in an optimal location as the pans would vary in width depending on the products to be made and sizes of the products. So, the third module (M3) is further designed provide improved cleaning of the pan inside perimeter and outside side perimeter edges 6, 7 with the overlap of the multiple brush heads as shown by the highlighted areas of FIG. 20. The overlap can be for example, one hundred to four hundred percent, and in a further non-limiting exemplary embodiment an overlap of two to three times or three hundred percent can be used where the center to center locations of the shafts 21 would be at two and three-eighths inches equally spaced across the travel path of the pan 3 and the brush diameter would be at about seven inches based on the selected overlap.

As noted above, the staggered, counter rotation of the individual rotary brushes 25 is a further improvement. The direction of rotation of the brushes is also improved in that the various rotational moments are cancelled in the layout indicated in FIGS. 15-20. In the brush head where each brush that is across the travel path of the pan in the exemplary embodiment alternates in rotational direction as an example, but would certainly not be limited to, when going from left to right such that the first brush would rotate in a clockwise direction and the second would be counter clockwise, the next again being clockwise and alternating in this manner across the width of the pan. The reason being it gives a balanced side loading of force placed on the pan 3 as it goes thru the pan cleaner and is held to and by the conveyor belts. As an example of why this is important, if all the brushes were to be rotating in the same direction, then when a bun pan 3 approaches and contacts the rotary brushes 25 then the rotation of the rotary brush 25 would be forcing or driving the bun pan 3 to go to the side or off of the pan conveyor 430. And since the device is brushing the outside edges of the pans this cleaning and brush operating area would of be interfering with the utilization or placement of guides in this area. It would also impart additional vibration and lateral forces on the pan cleaning machine 1.

The rotary brushes operate by being supported on a mount plate 13 which spans the pan conveyor 430. The mount plate 37 also allows for and provides a mounting means for the vertical brush shafts 21 and drive device 17. The vertical brush shafts 21 are contained within the upper cartridge 22 and lower cartridge 23 where they are rotatably supported. There is also a power transmission device (timing belt pulley) mounted on the output shaft of the drive means 17 as well as the top input section of the brush shaft 21 as noted in relation to FIG. 17-19 above. When the drive means 17 operates it generates rotational force/energy which it further transmits and delivers thru the power transmission device, but this could also be done using other power transmission materials without departing from the novelty of this invention.

This driving rotational movement is then absorbed in a power transmission conducting device 19 and applied to the power transmission pulley 20 which is then set into rotational motion while being affixed to the top of the brush shaft 21. The brush shaft then putting the rotational motion into the brush 25 that is attached to the distal end or bottom of the shaft 21.

The connection of the brush to the shaft is done so that the brushes 25 can be installed and removed from the brush mount plate 37 in a tool less fashion whereby the brush body 26 has one or more connection buttons 35 which are held in connection to the brush base 26 by the utilization of button attachment fasteners 36. These connection buttons 35 will pass thru a clearance hole 38 in the brush mounting plate 37 and can be rotated in relationship to the slots 39 in the brush mounting plate 37 to where they will lock in place and allow for the rotation of the brush shaft 21 to rotate or drive the brush 25. It should be noted the brushes 25 with mounting buttons 35 can be affixed in either clockwise or counter clockwise fashion provided they are rotated and affixed in the brush attachment plate that permits connection or attachment in that said rotational direction. These elements of the invention can best be seen in the exemplary embodiment shown in FIGS. 22-26c.

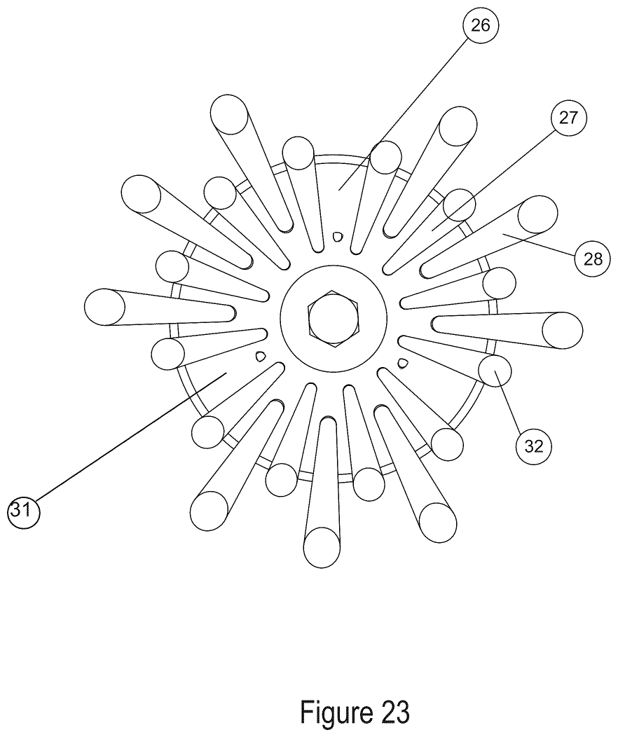

FIG. 22 shows an isometric assembly view of an exemplary embodiment of the brush head of module 3. The assembly view shows brush button attachment fasters 36, connection buttons 35. brush base 26, with inner bristles 27 and outer bristles 28 extending from the brush base 26. The inner brush bristles 27 are mounted at an inner brush bristle angle 29. Similarly, the outer brush bristles 28 are mounted at an outer brush bristle angle 30. FIGS. 23-26c show various additional views of the exemplary embodiment of the brush head shown.

FIG. 23 shows a bottom view of the exemplary embodiment of the brush head of FIG. 22. From this view. the brush base 26 can be clearly seen. The distribution of outer brush bristles 28 and inner brush bristle 27 each with tips 32 can be more clearly seen. The bristles 27, 28 being mounted at their respective angles 29, 30. These are distributed with a gap spacing 31 as previously discussed. The distribution with the various angles and gaps providing a non-linear layout relative to the rotational movement.

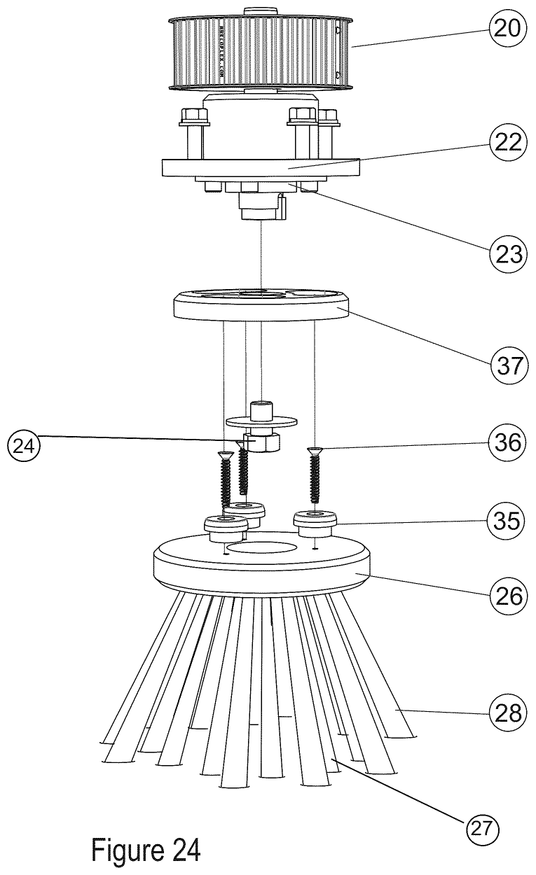

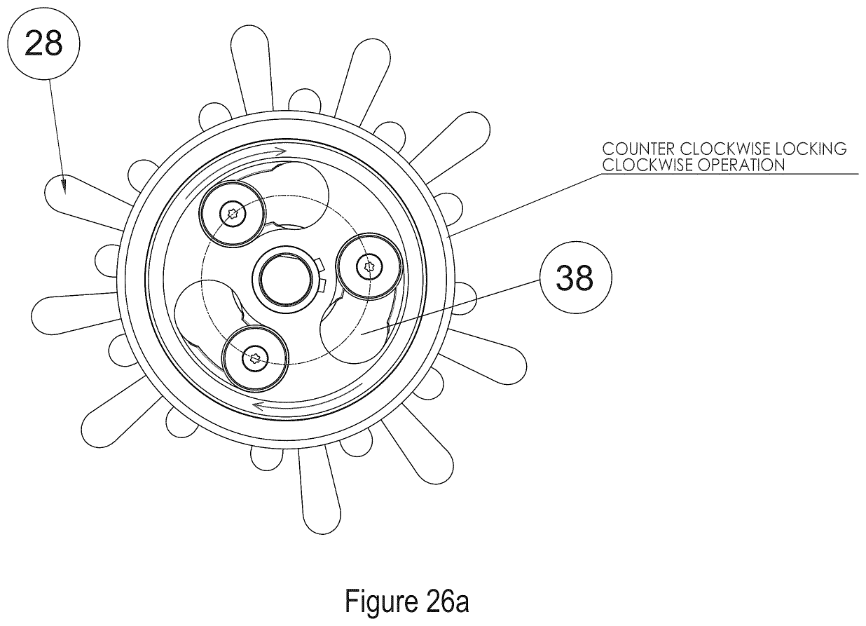

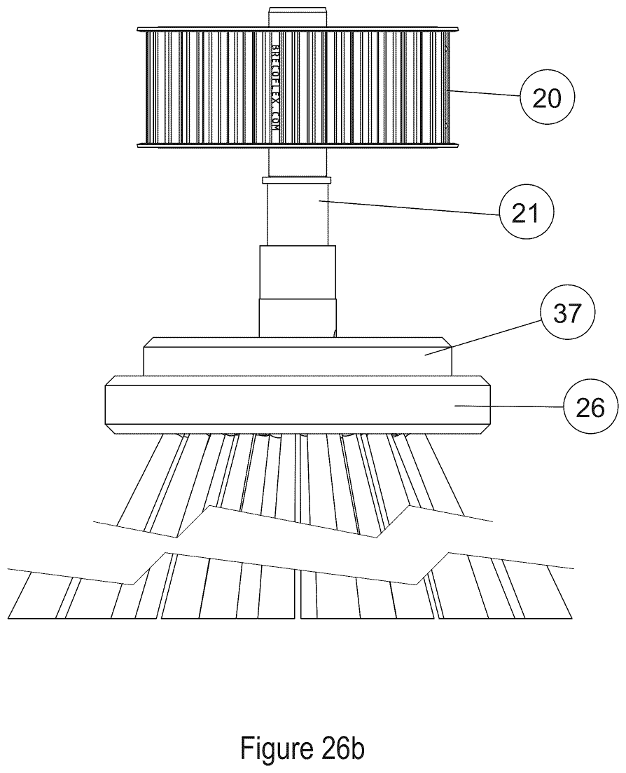

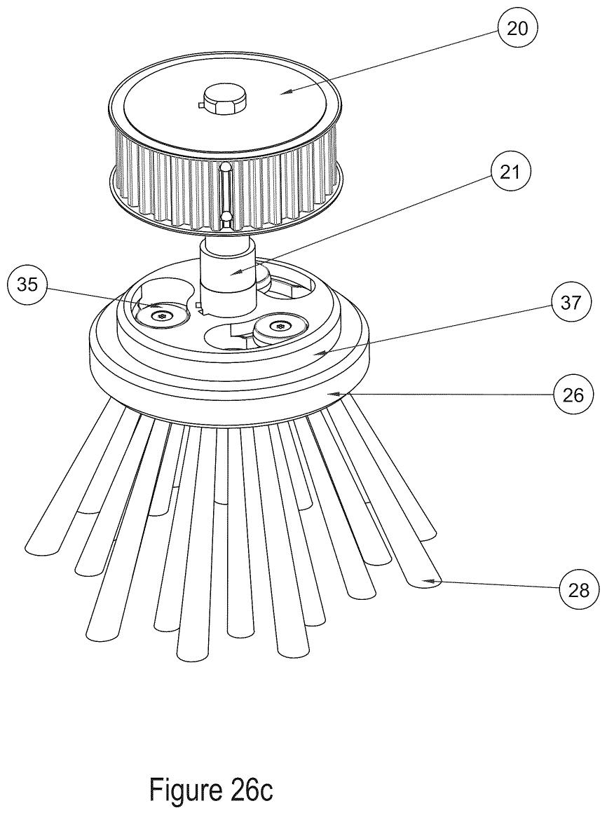

FIG. 24 shows an exploded view of an exemplary embodiment of the brush head, brush plate and pulley assembly of FIG. 17. The lower cartridge 23 and cartridge fastener 24 are shown. These couple the brush mounting plate 37 to the upper cartridge 22 and the rotating shaft 21 driven by transmission pulley 20. As seen in the figure, the outer bristles 28 and inner bristles 27 extend from the brush base 26. Buttons 35 are coupled to the brush base 26 with fasteners 36. Brush mounting plate 37 is shown. As described herein and particularly in relation to FIGS. 26a-26c. the brush mounting plate 37 has a slot 39 and a through hole 38 which allows for quick mounting and release of the brush head 25. As noted herein below with respect to FIG. 26a. the brush heads can have a directional configuration based on the direction of the slot 39 facing relative to the rotation of the rotary brush 25 in the assembly. in this instance a counter clockwise locking. clockwise operating configuration is shown. The slots 38 are reversed but the remainder of the brush is identical in the clockwise locking, counter-clockwise operating configuration, not shown for brevity.

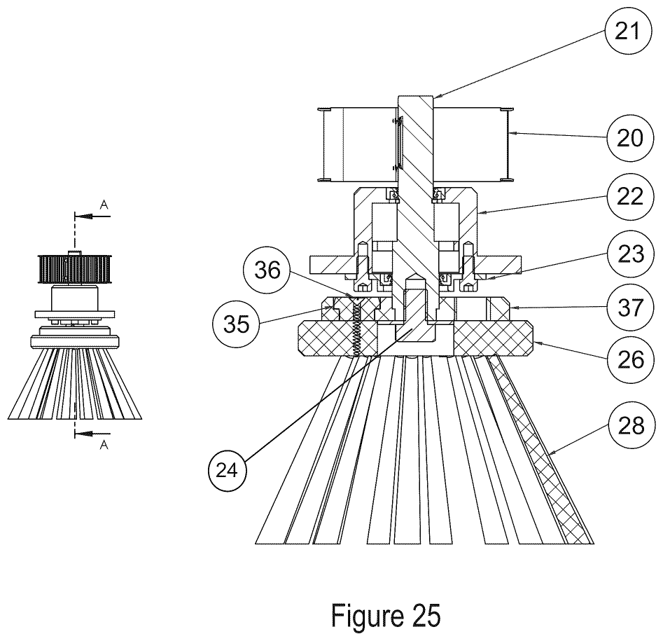

FIG. 25 shows a cross sectional view of an exemplary embodiment of the brush head, plate and pulley assembly from FIG. 24. FIG. 25 shows the brush head of FIG. 24 fully assembled and coupled to the transmission pulley 20, which is part of the pulley system shown more clearly in FIG. 17. Note that the cartridge fastener 24 is shown coupling the cartridge to the mounting plate 37. The brush base 26 engages the buttons 35 with the through hole 38 and the slot 39. The brush plate 26 is thereby affixed to the brush mounting plate 37 and to the lower cartridge 23 with shaft 21 passing through the upper cartridge 24 into the lower cartridge 22 and extending down to separately couple with the cartridge fastener 24. This permits the brush head 26 to be removed by a clockwise or counter clockwise twisting motion as noted in FIGS. 16a and 17a by the arrows.

FIGS. 26a-26c show top, side, and isometric views of the left turn and right turn installation methods of the brush heads on the spindle in an exemplary embodiment of the brush head assembly of FIG. 22. As noted above, the rotational direction of the brush heads can be staged so that the rotational moment of each brush is offset and the driving moment of the third module (M3) is balanced. Thus, each brush head shown in the exemplary embodiment of FIG. 4 has a direction of rotation. The quick release, toolless installation provided in the embodiment shown in FIG. 22 with button 35, slot 39, and through hole 38 must therefore be oriented to this direction of rotation so that the brush head is not spun off the mounting plate 37 during operation. Thus, as best seen in FIGS. 26a, the slots are oriented for either clockwise or counter clockwise twisting motions for installation and as noted, are nearly identical save for the slot 38 orientation.

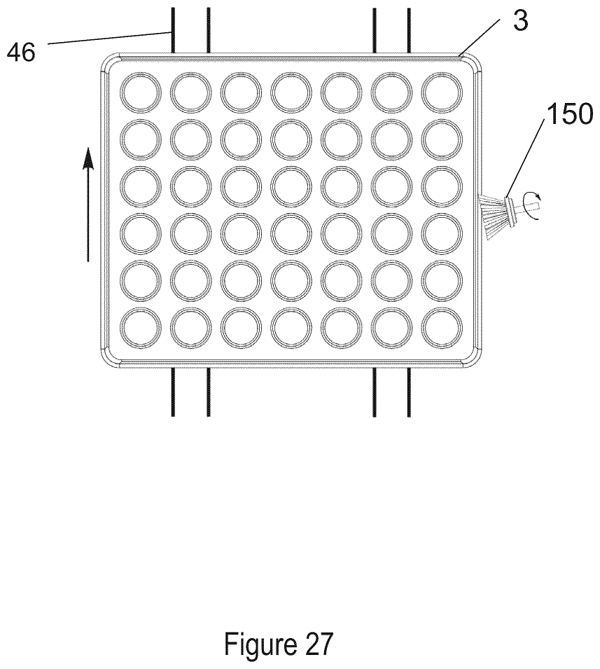

FIGS. 27 and 28 show an additional side sweeping brush of an alternate exemplary embodiment of module three. An alternate inside pan perimeter 6 and outside pan perimeter 7 cleaning method shown in FIGS. 28 and 29, the alternate exemplary embodiment adds a further side sweeping brush 150. In the further exemplary embodiment, via a separate module or incorporated as a component of the existing module three (M3). the alternate side sweeping brush can be added. In the alternative exemplary embodiment of the brush system, as shown in FIG. 28, the added side brushes 150 are specifically employed and extend from the deck of module three (M3) to clean the pan 3 outer sides. In this alternate method of the exemplary embodiment, a side sweep brush 150 that would be held and rotated about a substantially horizontal axis to brush the outer edge of the pan 7. The axis of this brush would not be perpendicular to the pan perimeter but instead the brush rotational axis would be inclined so that the brush would be used to only present the brush 150 to one side of the outer pan perimeter 7.

As a non-limiting example of orientation of the side sweep brush 150, the axis could be perpendicular to the up down inclined surface of the pan perimeter surface but in the horizontal axis of the pan the axis of rotation would be either leaning back or forwards depending on the directional rotation of the brush relative to the direction of pan travel. The driving end of the spindle would be leaning back as compared to the travel direction of the pan in the horizontal direction of the conveyor 430. The lean of the rotational axis of the brush is dependent on the rotational direction of the brush and brush spindle to preferentially and predominantly brush the debris that may be adhering to the pan outer perimeter down and away from the pan perimeter. While it is possible to brush the debris upwards from the pan perimeter it is typically not a preferred direction as there is a high probability for the debris to fall onto the top product producing surface of the pan.

FIG. 29 shows a side view of module four of the exemplary embodiment of FIG. 1. Module four (M4) is an orbital planetary brush that has been described in previously filed U.S. Provisional Application 62/894,923 and co-pending U.S. Utility application Ser. No. 17/009,203, shown in FIGS. 7A through 8F of those Applications and described in the specification therein each of which has been incorporated herein by reference. A horizontal cylindrical brush subsystem 600 is shown in an exemplary configuration as shown in an exemplary embodiment of the invention, is directed to an orbital, or oscillating, or orbital and oscillating flat or planar brush 601 having a flat brush assembly that has bristles arranged and entered into a slab of brush base 605, 610. The planar brush 601 subjects the pan 3 to additional cleaning using higher, longer, taller bristles 605, 610 to scrub the pan surface with sufficient contact pressure and a compound elliptical, planetary scrubbing motion.

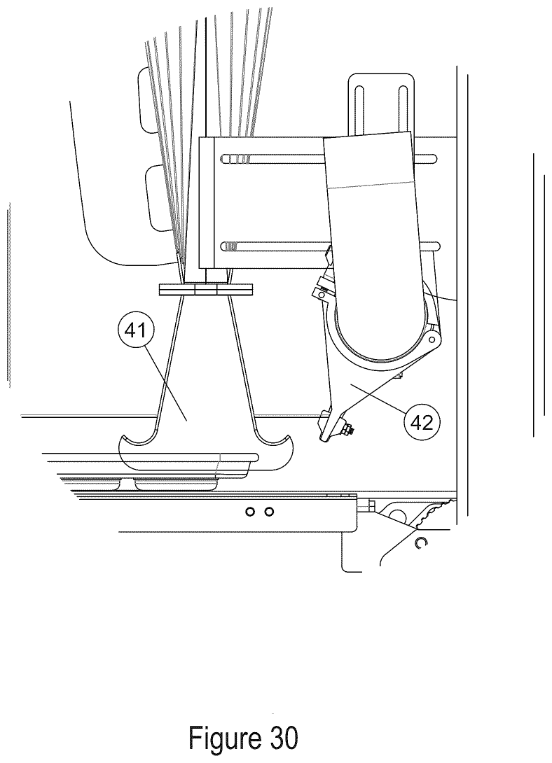

FIG. 30 shows a side view of module five of the exemplary embodiment of FIG. 1. Module five (M5) is a second vacuum hood at the exit of the pans from the pan cleaning machine 1. The module is shown as a second vacuum hood 41 with a proceeding air knife 42. The air knife 42 takes any or all loose debris that may be sitting on the pan surface 4 or in any of the pan pockets 5 and agitates it so that it becomes airborne and toward the vacuum so it may be removed by the vacuum head.

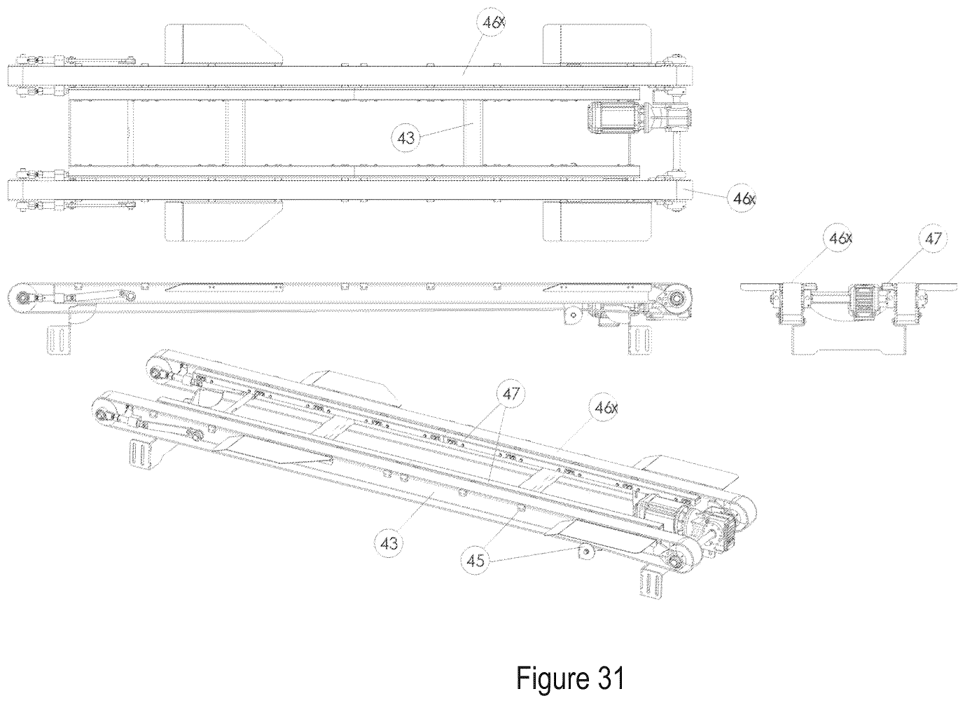

FIG. 31 shows views of an exemplary embodiment of the conveyor system of the pan cleaning system of FIG. 1. FIG. 31 includes the isometric view of the magnetic conveyor where said bun pans 3 are placed for carriage thru the pan cleaner I for the purpose of cleaning said bun pans 3. The conveyor 430 provides two parallel paths of tractive magnetic elements 47 for said bun pans 3. On the sides of the conveyor paths are mounted pan conveyor magnets 47 to attract and create the magnetization of the ferrous bun pans 3. The generated strong attractive forces being able to hold the bun pans 3 in position while they are moved along the conveyor 430 on a conveyor belt surfaces 46 and thru the forces and loadings imparted on them as they pass thru and are exposed to the various forces subjected upon them by the various cleaning stations or sub-system or modules.

The conveyor 430 can also take bun pans 3 as they are presented to the pan cleaner 1 and load them on and thru the pan cleaner 1. They do not need to be loaded and indexed onto carriers or to specific locations such that they will arrive at specific locations or modules for cleaning at specific times and the like. This reduces feed complexity of the stream of contaminated pans 3 to the machine 1. To ensure that the bun pans 3 are held to or adhere to the pan conveyor belts 46 to not be motivated by any or the entire pan cleaning devices the pan conveyor magnets 47 located adjacent to the conveyor belts 46 are attached to the sides of the belt support surface 44. The bun pans 3 then travel towards and approach the first cleaning section comprising modules 1 and 2 (M1, M2), as further described herein in relation to FIGS. 22 and 23 above. The pans 3 will get an initial sweep by the cylindrical, rotational brushes 8 so that any buns 2 that may be sitting atop of a bun pan 3 or in a pan pocket 5 due to incomplete removal at the de-panning device (not shown) can be removed before cleaning and drawn up the first vacuum hood 10.

Though strictly lateral conveyance via nonlinear belts is possible, in the exemplary embodiments shown the belts that provide transport of the pans are held and constrained in a lateral, fixed linear direction, so as to maintain the pan in direct passage thru the pan cleaner device 1. This orientation minimizes the possibility of lateral slippage of the pan which could cause incomplete cleaning of the pan surface as well as possible jamming of the pan upon passage and emergence of the pan from the pan cleaner. The magnets 47 are installed to attract the pan to the magnet thereby pull the pans to the belt 46 and providing for greater security in passage. The belts 46 are in turn guided in the direction of travel by travel guides 45 on the frame 43. After passing along the length of the conveyor 430 the pans 3 exit the pan cleaning machine 1.

The method of the invention is directed to a method to remove possible sources of pan and/or product contamination from a commercial baking process. To accomplish this a method for removal or alleviation of these materials from a pan by providing a system or method of operating or means of improved cleaning of these pan perimeter surfaces is provided herein.

In the method a source of pans 3 needing cleaning or removal of contaminants is provided on a transport medium. The transport medium, including but not limited to a conveyor 430 having magnetic coupling devices, herein magnets 47, and at least one conveyor belt 46. The conveyor belt 46 is arranged to pass the pans 3 into a pan cleaning machine 1 having at least one cleaning module. In the exemplary embodiment shown, the process includes a first cleaning section incorporating first and second modules having horizontal brushes 8 and a first vacuum hood 10, as described in greater detail in relation to the description of FIGS. 1 and 2 above. The first and second modules (M1, M2) providing a first light brushing of the pan 3 to remove loose contaminants and buns/bun remnants 2 that have not been depanned and some contaminants.

The exemplary embodiment of the process passes the pans 3 to a second cleaning section, providing a novel cleaning sub-system or module four (M4) as shown and described in FIGS. 14-26c above. This processes the pan and cleans the perimeter and top surface of the pan 3 and can also be adjusted to provide a thorough cleaning extending into the pockets 5 of the pans 3 based on cleaning parameters. In contacting pan 3, it was thought that a uniform brush as exists in the prior art if used to try and strike the required surfaces would not fully do what is required due to angle of brush bristle contact and ability of the brushes to contact all surfaces. The process of the instant invention provides a brush where the bristles would emanate out from the brush bristle holding body 26 so that they clean or brush against the perimeter surfaces 6, 7 of the pan and if the angles were held, e.g., not significantly deflected, that these brushes could contact both the inside pan perimeter surface 7 as well as the outside surfaces of the pan perimeter 5 more effectively.

The method of the invention also realizes the need for brushing of the entire leading as well as trailing perimeter of the pan. The brushes used clean in the most optimal way when, as the bristles contact the main pan surface, they do so at an angle that allows the bristle to brush the surfaces with the tip of the bristle rather than have the bristle bend and then all bristles behind it would also bend and lay on each other so that in effect they would only be wiping or glance stroking the pan surface. Thus, the method of the invention uses a process whereby the brushes are consistently striking at angles to provide optimal contact to the perimeter of the surface at angles that allow the brush tips to remain in contact and at pressures that allow for the brushes to clean at their tips with minimal deflection and little or no lay up upon each other.

To achieve this, the bristles are presented in an offset in the rotational path of the brush head to not be able to contact leading bristles so as to sympathetically lay on top of one another in a layer. Instead, the bristle tips are maintained in contact and the deflection that transitions from a brushing to a sweeping motion avoided in a first method. The exemplary method of the invention also provides a controlled pressure via the module mounting mechanism, as seen in FIGS. 14-26c, to realize the tip contact of the process. It is of note that the system, by its modular and adjustable nature, can override the desired pressure and angle to keep the tips in contact and effectively “push harder” on the brushes to create the bending if a wiping action is desire for a different cleaning parameter as described herein.

A further aspect of the method of cleaning is to provide sufficient over lap of the brush heads during cleaning so that when the brush tips are going into contact during compression and the sweeping process begins with the lip and the compression of the bristles does occur due to the change in the height of the pan lip. that the brushes present a minimum sweeping angle of about 30 to 60 degrees even in compression where it can also be understood the overall effective width of the brush is reduced but the brushes in the third module M3 are arranged such that they present significant overlap and even with the reduced contact area at a single brush, the entirety of the lip of the pan is cleaned by at least one of the brushes at any given time while in the area.

For the front and rear surfaces, in an exemplary embodiment of the process of the invention, the instant invention uses one hundred percent overlap of the brush heads in the cleaning path, which provides sufficient overlap and cleaning around the entire perimeter. A non-limiting example of such an overlap is shown, but it is certainly not the limit of the process or device, where the brush centers in a travel path would be three and a half inches apart and the diameter of the brushes would be on seven inch centers, thereby allowing brushes to also be brushing the top pan surface.

For cleaning of the sides of the pans where the brushes were not in an optimal location, as the pans often vary in width depending on the products to be made and sizes of the products, to clean the side perimeter edges of the pans the non-limiting, further exemplary process and the further non-limiting exemplary device for carrying out the process provides an overlap of three times or three hundred percent, which is used in the exemplary embodiment for example where the center to center locations of the shafts would be at two and three eighths inches across the travel path of the pan and the brush diameter would be at seven inches.

The process of the instant invention also provides remediation of spinning moments of the pan. The direction of rotation of the brushes is improved in the exemplary embodiment of the process and device executing the process in that the various rotational moments of the individual brushes are cancelled by one another in the layout indicated. In the brush head where each brush that is across the travel path of the pan in the exemplary embodiment alternates in rotational direction as an example, but would certainly not be limited to, when going from left to right such that the first brush would rotate in a clockwise direction and the second would be counter clockwise, the next again being clockwise and alternating in this manner across the width of the pan.

This provides balanced side loading of force placed on the pan as it goes thru the pan cleaner and is held to and by the conveyor belts. If all of the brushes were to be rotating in the same direction, then when a pan approaches and contacts the brushes then the brush would be forcing or driving the pan to go to the side or off of the conveyor. And since the device is brushing the outside edges of the pans this cleaning and brush operating area would be interfering with the utilization or placement of guides in this area.

The exemplary process of the invention then passes the pan to a third cleaning section, comprising modules four and five, whereby a final brush utilizing a wide planar brush is applied and a corresponding second vacuum hood 41 is provided. The remaining contaminants being removed from the pan 3 and the pan 3 being cleaned and passed along from the cleaning machine 1.

In addition to the novel cleaning process of the instant invention as enumerated above. additional aspects of further exemplary embodiments of the instant invention can provide for a programmable controller to execute movement of the aforementioned modules on arms. The movement, as enumerated above, can be used to engage or disengage the modules as desired. The movement can also provide greater or lesser pressure to be exerted at the given interface of each module with the pan 3 as determined by cleaning parameters and engagement parameters as previously discussed. This controls the arms and thereby the modules in the cleaning process being implemented by the controller 14a.

Similarly, the process can incorporate sensors as described herein above in relation to FIG. 1 in an alternate embodiment of the process of operation of the instant invention. These sensors can, for example but are certainly not limited to, providing a further step in the process of scanning and analyzing the condition of the pan with respect to the contaminants on the pan or the condition of the non-stick glaze and the controller 14a and the further exemplary embodiment of the process of the invention can provide additional steps based on the output from the sensor. These steps an include but are not limited to adjusting the cleaning parameters to suit the detected contaminants or passing the pan to a sorting conveyor to be removed from service.

The embodiments and examples discussed herein are non-limiting examples. The invention is described in detail with respect to preferred embodiments, and it will now be apparent from the foregoing to those skilled in the art that changes, and modifications may be made without departing from the invention in its broader aspects, and the invention, therefore, as defined in the claims is intended to cover all such changes and modifications as fall within the true spirit of the invention.

What is claimed is:

1. An at least one modular swing arm in a dry commercial baking tray cleaning system, comprising:
an at least one swing arm mounting point in the commercial baking tray cleaning system, the at least one modular swing arm coupled to the at least one swing arm mounting point such that the at least one modular swing arm rotates freely on a pivot element coupled to the at least one pivot point and an at least one frame element of the dry commercial baking tray cleaning system;
an at least one swing arm actuator;
an at least one swing arm limiter; and
an at least one controller coupled to and controlling the at least one swing arm actuator, wherein the at least one modular swing arm is positioned by the at least one controller in a swinging motion by activating the at least one swing arm actuator to position and engage an at least one pan in the baking tray cleaning system with an at least one cleaning sub-system at a pressure exerted by the at least one swing arm actuator through the at least one modular swing arm such that the at least one pan is engaged by the commercial backing tray cleaning system and cleaned by the at least one cleaning sub-system.

2. The at least one modular swing arm of claim 1, wherein the at least one controller is further adapted to sense and maintain a specified pressure range for the pressure exerted on the pan by the at least one modular swing arm.

3. The modular swing arm of claim 2, wherein the pressure exerted by the at least one swing arm actuator is sensed through the at least one swing arm limiter.

3. The modular swing arm of claim 2, wherein the pressure exerted by the at least one swing arm actuator is sensed through a further at least one pressure sensor communicating with the controller.

4. The modular swing arm of claim 3, wherein as part of the sensed pressure range, a down force relative to the movement of the at least one modular swing arm is measured by the at least one controller.

5. The modular swing arm of claim 1, wherein the controller is further adapted to extend the swing arm about its pivot element to apply the down force within the pressure range and sense a jam condition where the pressure range exceeds a pre-set limit in the at least one controller.

6. The modular swing arm of claim 5, wherein the controller retracts the at least one modular swing arm when the preset limit is exceeded as an indicator of a jam condition error.

7. The modular swing arm of claim 1, controller is further adapted to provide a pressure overload condition to activate the actuator to exert increased pressure on the pan through the at least one modular swing arm for a period of time and then release pressure in set increments to provide high pressure and accommodate variations in the pan within the pressure range of the controller.

8. The modular swing arm of claim 6, wherein the controller is further adapted to sense when the pressure range is exceeded beyond the overload condition, indicate an error, and disengage the at least one modular swing arm from engaging the pan.

9. The modular swing arm of claim 8, wherein the controller is further adapted as a part of disengaging the at least one modular swing arm to engage the at least one swing arm actuator and lift the at least one modular swing arm from engagement with the pan and pass the pan out of the commercial baking cleaning system.

10. The modular swing arm of claim 1, wherein the at least one swing arm actuator is an air cylinder and the controller is further adapted to pressurize the at least one air cylinder and move the modular swing arm in the swinging motion and thereby locate an at least one operating position of a cleaning subsystem mounted on the at least one modular swing arm.

11. The modular swing arm of claim 1, wherein the position limiter sets a height for operating the cleaning subsystem attached to the swing arm above a secondary conveyor.

12. The modular swing arm of claim 11, wherein a distal end of the position limiter is fixed to the at least one frame element and the opposed distal end is coupled to and rides in a slot in a position limiter coupling which is coupled to the at least one modular swing arm.

13. The modular swing arm of claim 12, wherin the position limiter coupling allows for adjustment of the travel of the end of the position limiter and fixing the limit of travel within the slot in the position limiter setting the minimum height the swing arm can close to the conveyor system for the cleaning subsystem.

14. The modular swing arm of claim 1, wherein the at least one pan cleaning subsystem mounted on the at least one modular swing arm is also coupled to and communicates with the controller.

15. The modular swing arm of claim 14, wherein the at least one modular swing arm supports the at least one cleaning subsystem at an operating distance set by the at least one position limiter and data is communicated from the controller to the at least one actuator and the at least one position limiter to adjust for the particular subsystem and an operational variable.

16. The modular swing arm of claim 15, wherein the operational value is at least one of a pan size, a pan shape, and a product type.

17. The modular swing arm of claim 15, further comprising a sensor on the at least on position limiter to provide feedback information to the controller on the at least one position limiter.

18. The modular swing arm of claim 1, wherein the controller is further adapted to adjust while monitoring pressures and determine when the pressure exceeds the pressure range, the controller interrogates data to determine the nature of the excess pressure or overload condition and can differentiate an indicator of a jammed pan or of a misconfigured or bent pan.

19. The modular swing arm of claim 1, further comprising an at least one frame assembly having the frame element, an at least one pan conveyor, an at least one track support; and an at least one track guide, wherein the at least one modular swing arm is releasably coupled to the frame assembly.

20. The modular swing arm of claim 19, wherein the at least one cleaning subsystem is releasably coupled to the at least one modular swing arm and oriented to engage the pan on the at least one conveyor.
